(19) United States
(12) Patent Application Publication
(10) Pub. No.: US 2016/0217423 A1
(43) Pub. Date: Jul. 28, 2016

(54) SYSTEMS AND METHODS FOR AUTOMATICALLY GENERATING APPLICATION SOFTWARE

(71) Applicant: Magnan Technologies, LLC, Woburn, MA (US)

(72) Inventors: David Magnan, Andover, MA (US); Justin Magnan, Chestnut Hill, MA (US)

(73) Assignee: Magnan Technologies, LLC, Woburn, MA (US)

(21) Appl. No.: 15/004,921

(22) Filed: Jan. 23, 2016

Related U.S. Application Data
(60) Provisional application No. 62/106,878, filed on Jan. 23, 2015.

(51) Int. Cl. G06Q 10/10; G06F 17/30; G06F 3/0484

(52) U.S. Cl. CPC G06Q 10/103; G06F 3/04842; G06F 17/30312; G06F 3/0484

(57) ABSTRACT

A method is provided for generating a software application. In some embodiments, a user may be prompted to provide organizational arrangement data relating to a contract and/or process data relating to a contract operation to be performed pursuant to the contract. At least one database may be automatically generated to store the organizational arrangement data, and code for software may be automatically generated to facilitate performance of the contract operation. The software may be adapted to present a user interface for a case workflow specified by a case definition for a case under the contract.

### RELATED APPLICATION

This application claims the benefit under 35 U.S.C. §119(e) of U.S. Provisional Application Ser. No. 62/106,878, filed on Jan. 23, 2015, entitled “SYSTEMS AND METHODS FOR AUTOMATICALLY GENERATING APPLICATION SOFTWARE,” which is hereby incorporated by reference in its entirety.

### BACKGROUND OF INVENTION

Both public and private organizations rely on software applications to deliver services to customers and to support internal operations. For example, organizations use software applications to manage customer relationships, process payrolls, allocate resources, issue purchase orders, track invoices, etc. New functionalities are constantly in demand as organizations grow and/or their activities become more complex. Additionally, significant resources are required to maintain and support existing software applications.

The challenging economic conditions of recent years prevented many organizations from spending more on information technology (IT). In some instances, organizations even reduced IT budgets. To ensure delivery of high priority new applications, some IT departments are forced to defer maintenance activities that are necessary to keep existing applications up-to-date and fully supported, and to decline requests for new applications and/or functionality enhancements that are of lower priority. By some estimates, the cost for clearing this maintenance backlog (also referred to as the “IT debt”) could rise to $1 trillion globally by 2015.¹ As a result of the growing backlog, even critical software applications are at risk of becoming unreliable and obsolete. Gartner Estimates Global ‘IT Debt’ to Be $500 Billion This Year, with Potential to Grow to $1 Trillion by 2015, Sep. 23, 2010. Available at http://www.gartner.com/newsroom/id/1439513.

### SUMMARY OF INVENTION

In some embodiments, a method for generating a software application is provided, the method comprising: prompting a first user to provide contract data relating to a contract, wherein the contract data comprises at least one contract term attribute for a contract term associated with the contract; prompting the first user to provide process data relating to a contract operation to be performed pursuant to the contract, wherein the process data comprises: a case definition specifying a case workflow for a case under the contract, the case workflow comprising at least one work item to be completed; and a work item definition for the at least one work item to be completed, the work item definition specifying a manner in which a value is to be captured for the at least one contract term attribute; automatically generating at least one database configured to store the contract data provided by the first user and a value to be captured for the at least one contract term attribute; and automatically generating code for software to facilitate performance of the contract operation, the software being adapted to: present a user interface for the case workflow specified by the case definition, wherein the user interface is adapted to prompt a second user to provide a value for the at least one contract term attribute; receive, via the user interface, a value for the at least one contract term attribute; and store the value for the at least one contract term attribute in the at least one database.

In some embodiments, a method for generating a software application is provided, the method comprising: automatically generating at least one database configured to store contract data relating to a contract, wherein the contract data comprises at least one contract term attribute for a contract term associated with the contract, and wherein the at least one database is further configured to store a value to be obtained for the at least one contract term attribute; and automatically generating code for software to facilitate performance of a contract operation pursuant to the contract, the software being adapted to: present an application programming interface (API) for a case workflow, wherein: the case workflow is specified by a case definition for a case under the contract; the case workflow comprises at least one work item to be completed; and engage in at least one transaction to obtain a value for the at least one contract term attribute, the at least one transaction being specified by a work item definition for the at least one work item; receive, via the API, a value for the at least one contract term attribute; and store the value for the at least one contract term attribute in the at least one database.

In some embodiments, at least one computer-readable medium is provided, having encoded thereon executable instructions that, when executed by at least one processor, cause the at least one processor to perform any of the above-described methods.

In some embodiments, a system comprising at least one processor and at least one computer-readable medium having encoded thereon executable instructions that, when executed by the at least one processor, cause the at least one processor to perform any of the above-described methods.

### BRIEF DESCRIPTION OF DRAWINGS

FIGS. 1A-B show an illustrative application management system (AMS), in accordance with some embodiments.

FIG. 2 shows an illustrative structure 200 that may be used to model different types of organizational arrangements, in accordance with some embodiments.

FIG. 3A shows an illustrative contract definition 300 based on the organizational arrangement data structure 210 and process data structure 220 of FIG. 2, in accordance with some embodiments.

FIG. 3B shows an illustrative database schema 350 that may be generated by an AMS based on the organizational arrangement data structure 210 and process data structure 220 of FIG. 2, in accordance with some embodiments.

FIG. 3C shows an illustrative database schema 375 that may be generated by an AMS based on a contract definition provided by an application designer, in accordance with some embodiments.

FIG. 4 shows an illustrative environment library editor 400, in accordance with some embodiments.

FIG. 5 shows an illustrative display 500 that may be used to prompt an application designer to provide information regarding a new application, in accordance with some embodiments.

FIG. 6 shows an illustrative application library editor 600, in accordance with some embodiments.

FIG. 7 shows an illustrative display 700 that may be used to prompt an application designer to provide information regarding a new deployment, in accordance with some embodiments.

FIG. 8 shows an illustrative deployment library editor 800, in accordance with some embodiments.

FIG. 9 shows an illustrative systems tab 900 of the deployment library editor 800 shown in FIG. 8, in accordance with some embodiments.

FIG. 10 shows an illustrative display 1000 that may be used to prompt an application designer to provide information regarding a new contract definition, in accordance with some embodiments.

FIG. 11 shows an illustrative display 1100 that may be used to prompt an application designer to provide information regarding a new contract term, in accordance with some embodiments.

FIG. 12 shows an illustrative display 1200 that may be used to prompt an application designer to provide information regarding an attribute for a contract term, in accordance with some embodiments.

FIG. 13 shows an illustrative menu 1305 of the display 1200 shown in FIG. 12, in accordance with some embodiments.

FIG. 14A shows an illustrative display formatting section 1405 of the display 1200 shown in FIG. 12, in accordance with some embodiments.

FIG. 14B shows an illustrative impact analysis display 1450, in accordance with some embodiments.

FIG. 15 shows an illustrative display 1500 that may be used to prompt an application designer to provide information regarding a custom-defined data type, in accordance with some embodiments.

FIG. 16 shows an illustrative display 1600 that may be used to prompt an application designer to define a valid value for a custom-defined data type, in accordance with some embodiments.

FIG. 17 shows an illustrative display 1700 of a contract definition tree, in accordance with some embodiments.

FIG. 18 shows an illustrative rule editing interface 1800, in accordance with some embodiments.

FIG. 19 shows an illustrative menu 1900 for defining and/or modifying a program element, in accordance with some embodiments.

FIG. 20 shows an illustrative menu 2000 of routines that may be made available to an application designer, in accordance with some embodiments.

FIG. 21 shows an illustrative menu 2100 for use by an application designer to configure access rights for a case in a case queue, in accordance with some embodiments.

FIG. 22 shows an illustrative menu 2200 for use by an application designer to create a work item, in accordance with some embodiments.

FIG. 23 shows an illustrative interface 2300 for defining a program element, in accordance with some embodiments.

FIG. 24A shows an illustrative program element 2400A, in accordance with some embodiments.

FIG. 24B shows an illustrative program element 2400B, in accordance with some embodiments.

FIG. 24C shows an illustrative program element 2400C, in accordance with some embodiments.

FIG. 25 shows an illustrative display 2500 of software code that may be generated by a configuration system based on a rule defined by an application designer, in accordance with some embodiments.

FIG. 26 shows an illustrative display 2600 that may be used to prompt an application designer to provide information regarding a new screen definition, in accordance with some embodiments.

FIG. 27 shows an illustrative interface 2700 that may be used by an application designer to configure the visual layout of a screen, in accordance with some embodiments.

FIG. 28 shows an illustrative screen 2800 that may be presented to an application user by a user interface of a runtime system, in accordance with some embodiments.

FIGS. 29-32 together show an illustrative database schema, in accordance with some embodiments.

FIG. 33 shows an illustrative process 3300 that may be performed by a runtime system, in accordance with some embodiments.

FIG. 34 shows an illustrative architecture 3400 for an application management system (AMS), in accordance with some embodiments.

FIG. 35 shows an illustrative database 3500 having a data table for reference contracts, in accordance with some embodiments.

FIG. 36 shows an illustrative process 3600 that may be performed by a configuration system, in accordance with some embodiments.

FIGS. 37A-D together show an illustrative process 3700 that may be performed by a configuration system, in accordance with some embodiments.

FIG. 38A shows an illustrative contract definition 3800, in accordance with some embodiments.

FIG. 38B shows an illustrative database schema 3810 that may be generated based on the illustrative contract definition 3800 of FIG. 2, in accordance with some embodiments.

FIG. 38C shows an illustrative display 3820 that may be used by an application designer to configure an access path for a screen, in accordance with some embodiments.

FIG. 38D shows an illustrative screen 3830 that may be generated based on input provided by an application designer via the illustrative display 3820 of FIG. 38C, in accordance with some embodiments.

FIG. 39 shows, schematically, an illustrative computer 10000 on which any aspect of the present disclosure may be implemented.

### DETAILED DESCRIPTION OF INVENTION

The inventors have recognized and appreciated various disadvantages of conventional approaches for developing and maintaining software applications. For instance, the inventors have recognized and appreciated that organizations have been designing and developing software applications as if each application is entirely unique. Typically, a project manager would assemble a team that includes at least one expert who understands the organizational process for which an application is commissioned (e.g., customer registration, purchase or sales transaction, payroll processing, or any other external or internal process). The expert would work with an analyst who would be tasked with designing one or more workflows for that process and identifying one or more pieces of data to be collected and/or stored in connection with the workflows. The analyst would then communicate the application requirements to one or more software developers, for example, via meetings and/or by creating a specification for the application.

The inventors have recognized and appreciated that such a design process is highly subjective and may result in poor design choices (e.g., inconsistent and/or unreliable data models), which may complicate subsequent development, maintenance, and/or integration with other applications. Such subjective processes continue to be followed by development teams despite the use of the Software Development Life Cycle (SDLC) methodology since the 1950s.

The inventors have further recognized and appreciated that the above-described design process requires collaboration between multiple disparate teams—the designers (e.g., experts and analysts) who understand the organizational process and the software developers who write software code for an application that supports the organizational process. The transfer of domain-specific knowledge from the designers to the software developers can be time consuming and error prone. In addition, many organizations rely on outside technology consultants to meet the needs of specific projects, instead of maintaining a large team of software developers on staff. These consultants are typically compensated based on the number of hours worked and therefore may not be incentivized to look for opportunities to simplify or standardize application design. Furthermore, because of pricing and/or timing pressures, the consultants may be encouraged to take shortcuts that may make future upgrades more difficult.

In sum, application software often costs too much to develop and maintain, takes too long to deliver, and represents a high risk of failure. Such outcomes may lead to diminished return on investment for an organization's IT spending, which may in turn discourage future IT spending and exacerbate the IT debt. Accordingly, there is a need for improved systems and methods for generating application software for organizational processes.

In some embodiments, systems and methods are provided for automatically generating application software. Rather than employing or engaging a large team of software developers to build a software application to facilitate a certain organizational process, an application management system (AMS) may be provided that receives input from an application designer and automatically generates the software application based on the input received from the application designer. This may significantly reduce the number of man-hours required to build the software application.

The AMS may generate code for the software application in any suitable programming language. For example, in some embodiments, the AMS may generate code in a high-level language such as Java, C, C++, Python, etc. Additionally, or alternatively, the AMS may generate code in a low-level language such as an assembly language or even a machine language.

As discussed above, the inventors have recognized and appreciated that software development has been plagued by high cost, slow delivery, and low quality in part because each project is treated as a unique problem and as a result the solution is developed in a subjective and ad hoc manner. By contrast, in some embodiments, a unified framework is provided for modeling various types of organizational processes.

For instance, the inventors have recognized and appreciated that an organizational process is often governed by some organizational arrangement. In one example, a process for filing an insurance claim may be governed by an insurance policy. In another example, a process for allocating resources to a project may be governed by an internal procedure (e.g., a standard operating procedure, or SOP) that specifies which resources are needed to complete various tasks.

Furthermore, the inventors have recognized and appreciated that different organizational arrangements can be represented in a similar fashion, even though each organizational arrangement may be of an entirely different nature (e.g., a contract with an external entity such as a customer or a vendor, versus an internal operating procedure to be followed by an employee). For example, the inventors have recognized and appreciated that many organizational arrangements share a similar structure. In some instances, the shared structure may account for 85%-90% of the complexity of an organizational arrangement. The remaining 10%-15% may include contextual information that gives meaning to various elements of the shared structure in the context of a particular organization arrangement. For example, a cellphone plan and an auto insurance policy may share a common structure (e.g., each having a customer and a number of contract provisions such as effective date and duration), but the elements of the common structure may have different semantics (e.g., the customer in the cellphone plan may be a cellular service subscriber, whereas the customer in the auto insurance policy may be an insured vehicle owner or driver).

The inventors have recognized and appreciated that the structural similarity of organization arrangements can be exploited by providing a data model template that can be used to create data models for vastly different organizational arrangements. Thus, in some embodiments, rather than designing a different data model for each organizational arrangement from scratch, as done conventionally, an application designer may simply be prompted to fill out a data template with contextual information pertinent to the particular organizational arrangement being modeled. An AMS may then automatically generate a database according to a data model that is an instance of the data template. The inventors have recognized and appreciated that data models created in this manner may be more consistent and reliable, because the data template may reduce the freedom afforded to the designer, which may prevent the designer from making poor design choices.

The inventors have also appreciated that different organizational processes can be represented in a similar fashion, even though each process may be of an entirely different nature (e.g., renewing a cellphone plan versus filing an claim under an auto insurance policy). For example, the inventors have recognized and appreciated that many organizational processes share a similar structure, and that the similarity can be exploited by providing a workflow template that can be used to create workflows for vastly different organizational processes. Thus, in some embodiments, rather than designing a different workflow for each organizational process from scratch, as done conventionally, an application designer may simply be prompted to fill out a workflow template with contextual information pertinent to the particular organizational process being modeled. The AMS may then automatically generate software code that, when executed, present to an application user a workflow that is an instance of the workflow template.

The inventors have further recognized and appreciated that a complex organizational arrangement may be decomposed into simpler constituent parts, and that each such constituent part may itself be an organizational arrangement and may be structurally similar to the more complex original arrangement. This pattern, sometimes called “self-similarity,” may repeat any suitable number of times (e.g., a simpler constituent part may be decomposed into even simpler constituent parts, and so on). Thus, an organizational arrangement may resemble a mathematical fractal, which is an object that exhibits self-similarity on all scales.

The inventors have recognized and appreciated that this fractal-like structure of organizational arrangements may be used to facilitate automatic generation of software applications for supporting organizational processes governed by the organizational arrangements. For example, in some embodiments, recursive definitions may be used to build more complex arrangements from simpler arrangements. However, it should be appreciated that a fractal structure is not required, as some of the inventive concepts described herein may be used to generate application software for organizational arrangements that do not exhibit self-similarity.

It should be appreciated that the concepts introduced above and discussed in greater detail below may be implemented in any of numerous ways, as the disclosed concepts are not limited to any particular manner of implementation. The examples shown in the figures and described herein are provided solely for illustrative purposes.

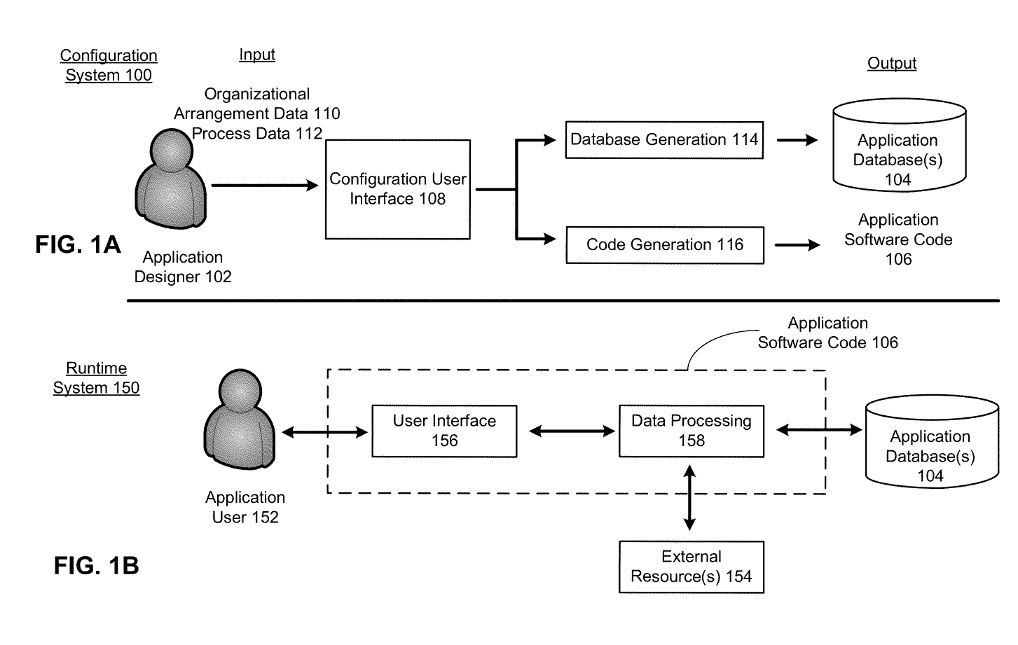

FIGS. 1A-B show an illustrative application management system (AMS), in accordance with some embodiments. In this example, the AMS includes a configuration system 100, shown in FIG. 1A, and a runtime system 150, shown in FIG. 1B. The configuration system 100 may be programmed to receive input from an application designer 102 and use the input to generate a software application, which may include one or more databases 104 and/or software code 106. The runtime system 150 may include the software application generated by the configuration system 100, interacting with an application user 152 and/or one or more external resources 154.

In the example shown in FIG. 1A, the configuration system 100 includes a configuration user interface (UI) 108 programmed to prompt the application designer 102 to provide data regarding an organizational arrangement that the software application is built to support. For instance, the organizational arrangement may be a customer contract, a vendor contract, an internal operating procedure, etc. However, it should be appreciated that these examples are merely illustrative, as the inventive concepts described herein may be used to generate application software for any type of organizational arrangement.

In some embodiments, the configuration UI 108 may be programmed to prompt the application designer 102 to provide organizational arrangement data 110 and/or process data 112. The organizational arrangement data 110 may describe one or more aspects of the organizational arrangement being modeled, and the process data 112 may describe one or more aspects of an organizational process (e.g., creation, maintenance, fulfillment, etc.) pursuant to the organizational arrangement. As discussed in greater detail below, the configuration UI 108 may, in some embodiments, be programmed to prompt for the organizational arrangement data 110 and/or process data 112 according to a common structure shared by different types of organizational arrangements.

It should be appreciated that the terms “contract,” “agreement,” and “commitment” are used herein to refer generically to any organizational arrangement and is not limited to a legally binding contract, agreement, or commitment. For example, an operating procedure established internally by an organization, an industry best practice guideline, or a government regulation may be referred to as a contract, agreement, or commitment.

In the example shown in FIG. 1A, the configuration system 100 further includes a database generation component 114 and a code generation component 116. In some embodiments, the database generation component 114 may be programmed to use at least some of the data received from the application designer 102 to generate one or more database tables (e.g., tables in a relational database) according to a common organizational arrangement data structure, and the code generation component 116 may be programmed to use at least some of the data received from the application designer 102 to generate software code according to a common process data structure.

As illustrated in FIG. 1B, the software code 106 generated by the code generation component 116 may, in some embodiments, include a UI 156 and a data processing component 158. The UI 156 may be programmed to interact with the application user 152, for example, to display data to the application user 152 and/or prompt the application user 152 to provide input data. The data processing component 158 may be programmed to interface with the one or more external resources 154, for example, to output data to, or receive input data from, an external resource. The data processing component 158 may be programmed to access the one or more databases 104, for example, to retrieve data for display to the application user 152 or for output to an external resource, or to store data provided by the application user 152 or an external resource.

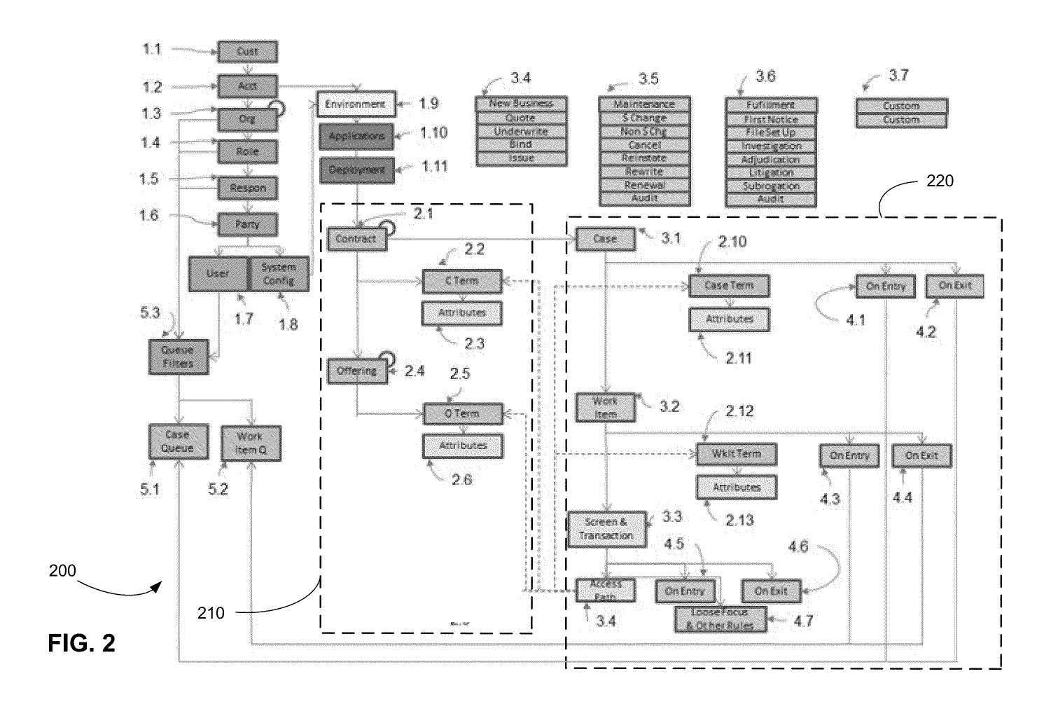

FIG. 2 shows an illustrative structure 200 that may be used to model different types of organizational arrangements, in accordance with some embodiments. The illustrative structure 200 may be referred to herein as a “fractal structure,” because the structure 200 may be repeated to build complex organizational arrangements from simpler ones. However, it should be appreciated that some of the inventive concepts described herein may be implemented without repeating the fractal structure 200, or any self-similar pattern at all.

As discussed above, the inventors have recognized and appreciated that many organizational processes are designed to support the creation, maintenance, and fulfillment of organizational arrangements, which may be commercial (e.g., a legally binding contract between an organization and a customer or supplier) or non-commercial (e.g., an operating procedure that an organization holds one or more employees accountable to perform). Accordingly, in the example shown in FIG. 2, the fractal structure 200 includes an organizational arrangement data structure 210 and a process data structure 220.

In some embodiments, the organizational arrangement data structure 210 may be based on a common structure shared by different types of organizational arrangements and may be used as a data model template to capture data that specializes the common structure to a particular context (e.g., cellphone plan, auto insurance policy, internal procedure for resource allocation, etc.). For example, the inventors have recognized and appreciated that a contract may include provisions that apply to the entire contract (e.g., an address at which all deliveries are to be made), as well as provisions that apply only to a grouping of one or more sub-commitments within the overall contract (e.g., a delivery date for an installment in a series of installments). Such a grouping is referred to herein as an “offering,” and a contract may have any number of offerings, including just one offering, or no offering at all. The inventors have further recognized and appreciated that the provisions that apply only to an offering may have one or more exceptions.

Accordingly, in the example shown in FIG. 2, the organizational arrangement data structure 210 includes two levels of data entity types: Contract 2.1 and Offering 2.4. A contract may be modeled as a data entity having the type Contract. Such a data entity may include one or more contract terms (e.g., C Term 2.2 shown in FIG. 2). Each contract term may represent one or more provisions that apply to the entire contract and may have a corresponding database table for storing attributes (e.g., Attributes 2.3 shown in FIG. 2) that are individual data elements of the contract term. Examples of contract term attributes include, but are not limited to, contract effective date, contract duration, etc.

In some embodiments, an offering within a contract may be modeled as a data entity having the type Offering. Such a data entity may include one or more offering terms (e.g., O Term 2.5 shown in FIG. 2). Each offering term may represent one or more provisions that apply only to the offering and may have a corresponding database table for storing attributes (e.g., Attributes 2.6 shown in FIG. 2) that are individual data elements of the offering term.

As a non-limiting example, a contract to construct a power plant may include three offerings: construction, engineering, and manufacturing. Database tables storing attributes that relate only to the construction aspects of the project may be grouped under the construction offering, whereas database tables storing attributes that relate only to the engineering aspects of the project may be grouped under the engineering offering, and database tables storing attributes that relate only to the manufacturing aspects of the project may be grouped under the manufacturing offering.

Thus, the data entity type Offering allows database tables to be grouped semantically. The inventors have recognized and appreciated that having a rationalized and generalized data framework capable of semantic grouping may allow consistent normalization of underlying databases (e.g., to the third normal form). For example, in some embodiments, data for an application may be transformed to first normal form to resolve all homonyms and synonyms, Additionally, or alternatively, the data may be grouped into data entities, and each data entity may have a data entity key that uniquely identifies an occurrence of that data entity. For instance, each data entity of the type Contract may have a root data table having one occurrence that applies to an entire contract or offering with in a contract. In some embodiments, second normal form for a relational database structure may be achieved by identifying and creating new data entities for any related data groups that may occur multiple times (where the data is already in the first normal form). For example, a related data group that may occur multiple times may be called an offering within a contract. In some embodiments, third normal form may be achieved by identifying and resolving all relationships between data entities. The inventors have recognized and appreciated that using normalization principals to design a relational database may allow a relational DBMS to store and retrieve data with integrity and performance. Relationships between database tables, as well as referential integrity for the database tables, may be readily maintained over the lifetime of a software application. However, it should be appreciated that some of the inventive concepts described herein may be implemented without semantic grouping of database tables.

In some embodiments, an application designer may be able to fit the contextual data for a particular organizational arrangement into a data framework provided by an AMS. In this manner, it may not be necessary for the application designer to explicitly design a database structure, which may reduce the likelihood of suboptimal design decisions. However, it should be appreciated that in some embodiments one or more manually designed database tables may be used in conjunction with, or in place of, automatically generated database tables.

In some embodiments, a contract may be defined recursively to include one or more sub-contracts. Similarly, in some embodiments, an offering may be defined recursively to include one or more sub-offerings. Such a recursive definition may be repeated any number of times (e.g., a sub-contract may itself be defined recursively, and so on). The inventors have recognized and appreciated that recursive definitions may be used to build more complex contracts from simpler contracts, and likewise for offerings. Thus, even if an organization's arrangements and/or processes become more complex over time, the same AMS may still be used to support such arrangements and/or processes. However, it should be appreciated that some of the inventive concepts described herein may be implemented without recursive definitions for contracts or offerings.

In some embodiments, a grouping of one or more exceptions to one or more provisions that apply only to an offering may be modeled as a sub-offering. The sub-offering may be a data entity having the type Offering and may be defined as a child of the offering. Thus, like an offering, a sub-offering may include one or more offering terms, each of which may have a corresponding database table for storing attributes. For instance, a travel insurance contract may include multiple offerings corresponding, respectively, to different groups of employees within an organization who are insured under different packages (e.g., frequent traveler vs. occasional traveler). Such an offering may in turn include multiple sub-offerings corresponding, respectively, to different types of travel (e.g., domestic within the US, between US and Europe, between US and Asia, etc.).

The inventors have recognized and appreciated that the ability to group exceptions into a sub-offering may allow normalization (e.g., to second normal form) of database tables that are multiple occurring, which may in turn allow data integrity to be maintained and/or improve database access performance (e.g., by reducing redundancy of data). However, it should be appreciated that aspects of the present disclosure are not limited to the use of a sub-offering to model exception grouping. For example, in some embodiments, a grouping of one or more exceptions may be modeled using a separate data entity type, rather than as a sub-offering.

Additionally, or alternatively, two contracts may be related to each other as siblings (e.g., a home-owner's insurance policy and an auto insurance policy issued to the same customer). Other types of relationships may also be created, as aspects of the present disclosure are not limited to the creation of any particular type of relationship. Similarly, in some embodiments, an offering may be related to one or more other offerings in any suitable way.

In some embodiments, a relationship between two contracts may be implemented by linking the database tables corresponding respectively to the contracts, and likewise for a relationship between offerings. Such a relationship may be created, for example, by defining a foreign key in one database table to refer to a primary key in another database table.

In some embodiments, a many-to-many relationship between two data entities (e.g., auto insurance policy holders and types of vehicles owned by the policy holders) may be implemented using a join table. For example, an entry in the join table may include a pair of keys, where the first key may identify an auto insurance policy holder and the second key may identify a type of vehicle owned by the policy holder identified by the first key. There may be multiple pairs with the same first key, as a policy holder may own multiple types of cars.

The inventors have recognized and appreciated that the ability to create relationships between different database tables may enable and/or expedite access to related data. Furthermore, a complex organization arrangement or process may be modeled by first creating models for simpler components of the arrangement or process, and then appropriate creating relationships between the simpler components. In this manner, an AMS may be used to support an organization's activities (e.g., external contracts and/or internal operating procedures) over time, even as the activities become more complex. However, it should be appreciated that some of the inventive concepts described herein may be implemented without creating relationships.

Returning to the example of FIG. 2, the process data structure 220 may be based on a common structure shared by different types of organizational processes and may be used as a workflow template to capture data that specializes the common structure to a particular context. For example, the inventors have recognized and appreciated that an organizational process may include cases, which may be units of work to be tracked over time, and each case may include one or more work items to be completed. Furthermore, each work item may include one or more screens for interacting with an application user and/or one or more transactions for interfacing with one or more computer programs (e.g., a batch program and/or web service).

Accordingly, in the example shown in FIG. 2, the process data structure 220 includes three levels of data entity types: Case 3.1, Work Item 3.2, and Screen and Transaction 3.3. A case may be modeled as a data entity having the type Case. Such a data entity may include one or more case terms (e.g., Case Term 2.10 shown in FIG. 2). Each case term may represent data to be retrieved and/or recorded in connection with the case, including, but not limited to, data to be recorded for monitoring, measuring, and/or auditing purposes. Furthermore, each case term may have a corresponding database table for storing attributes (e.g., Attributes 2.11 shown in FIG. 2) that are individual data elements of the case term.

In some embodiments, a case may orchestrate the creation, execution, and/or completion of one or more work items. A work item may be modeled as a data entity having the type Work Item. Such a data entity may include one or more work item terms (e.g., WkIt Term 2.12 shown in FIG. 2). Each work item term may represent data to be retrieved and/or recorded in connection with the work item, including, but not limited to, data to be recorded for monitoring, measuring, and/or auditing purposes. Furthermore, each work item term may have a corresponding database table for storing attributes (e.g., Attributes 2.13 shown in FIG. 2) that are individual data elements of the work item term.

In some embodiments, a work item may orchestrate one or more screens for interacting with an application user. A screen may be modeled as a data entity having the type Screen. Such a data entity may represent one or more entry points into the organizational arrangement data structure 210 and/or the process data structure 220 (e.g., to retrieve, update, and/or delete data). In some embodiments, a screen may be associated with one or more access paths (e.g., Access Path 3.4 shown in FIG. 2), where each access path may specify a list of one or more data entities to be traversed to reach certain target data. For instance, in the example shown in FIG. 2, an access path may be an entry point into a contract term, offering term, case term, or work item term.

Additionally, or alternatively, a work item may orchestrate one or more transactions for interfacing with one or more computer programs. A transaction may be modeled as a data entity having the type Transaction Like a screen, a transaction may represent one or more entry points into the organizational arrangement data structure 210 and/or the process data structure 220 (e.g., to retrieve, update, and/or delete data), and may be associated with one or more access paths. Furthermore, a transaction may be an input transaction, which receives data from an external resource for use by the work item, or an output transaction, which sends data populated by the work item to an external resource.

In some embodiments, a case may be defined recursively to include one or more child cases and/or sibling cases, and likewise for work items. For example, a case may be defined as an orchestration case that spawns multiple child cases to be executed in parallel. Additionally, or alternatively, the orchestration case may control a sequence in which some child cases are executed. Similarly, in some embodiments, a work item may be defined as an orchestration work item to execute child work items in parallel and/or in some statically or dynamically selected sequence.

In some embodiments, screens may be presented to an application user one at a time (e.g., to avoid confusion as to what the application user is expected to do next). The sequence in which the screens are presented may be chosen statically or dynamically. For instance, in some embodiments, a work item may include logic for determining which screen to present to the application user at a certain point in a workflow based on data provided by the application user and/or any other suitable data. However, it should be appreciated that aspects of the present disclosure are not limited to serial presentation of screens, as in some embodiments multiple screens may be presented to an application user at the same time (e.g., to provide flexibility and allow the application user to choose how to proceed).

In some embodiments, an access path of a screen or transaction may be required to abide by one or more referential integrity rules. As one example, an insert referential integrity rule may require that a certain contract term (e.g., a database table storing the name and address of a policy holder of an auto insurance policy) must exist before a certain offering term (e.g., a database table storing the make and model of an insured vehicle) can be inserted. As another example, a delete referential integrity rule may require that when a certain contract term (e.g., a database table storing the name and address of the policy holder) is deleted, all corresponding offering terms (e.g., all database tables for that policy holder's vehicles) must also be deleted. An AMS may not allow an application designer to define an access path that would violate a referential integrity rule. In some embodiments, a referential integrity rule may be implied by the data structure defined by an application designer. Thus, even though the application designer may not override the referential integrity rule directly, the application designer may be able to influence the referential integrity rule by changing one or more data table relationships.

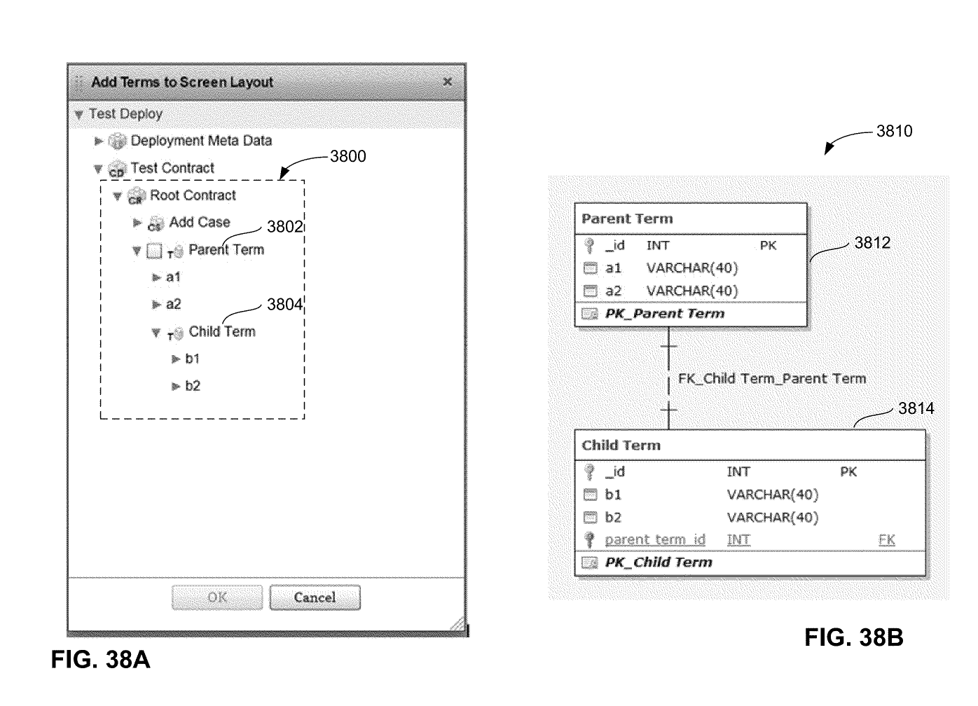

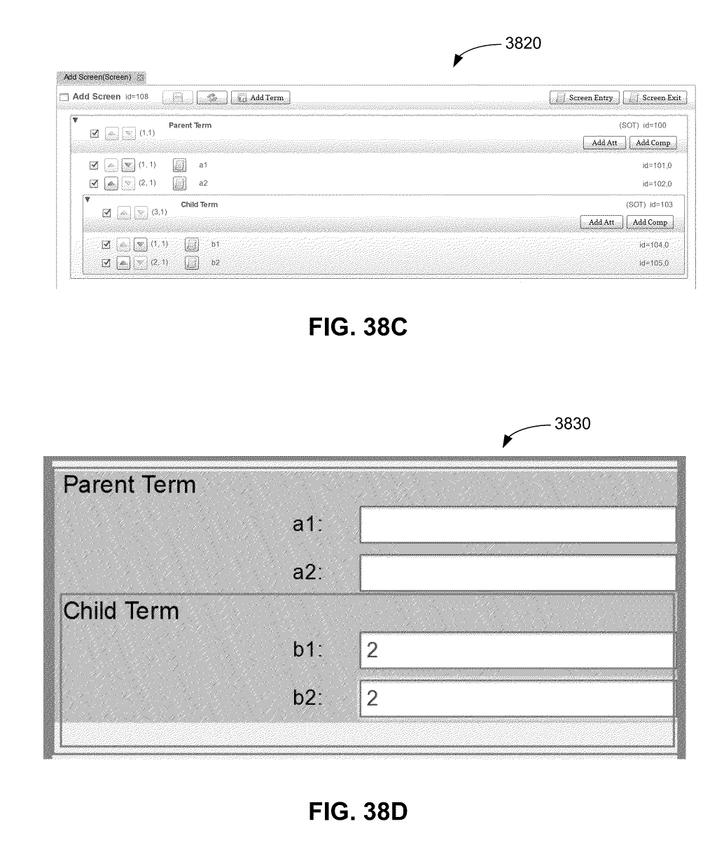

FIG. 38A shows an illustrative contract definition 3800, in accordance with some embodiments. In this example, the contract definition includes a root contract and an add case under the root contract. The add case may in turn include two contract terms, a parent term 3802 and a child term 3804. The parent term 3802 may have two attributes, a1 and a2. The child term 3804 may have two attributes, b1 and b2. For instance, the parent term 3802 may be a term for customer name, where the attributes a1 and a2 may be first and last names, respectively. The child term 3804 may be a term for customer contact information, where the attributes b1 and b2 may be phone number and email address, respectively.

FIG. 38B shows an illustrative database schema 3810 that may be generated based on the illustrative contract definition 3800 of FIG. 38A, in accordance with some embodiments. In this example, the parent term 3802 may have a corresponding data table 3812, and the child term 3804 may have a corresponding data table 3814. A cardinality of a relationship between the data table 3812 and the data table 3814 may be one-to-one.

FIG. 38C shows an illustrative display 3820 that may be used by an application designer to configure an access path for a screen, in accordance with some embodiments. In this example, the display 3820 may allow an application designer to select one or more terms and/or attributes to show on a screen, such as the illustrative parent term 3802 and child term 3804 of FIG. 38. For a selected attribute, the display 3820 may allow the application designer to select one or more user interface components (e.g., a text box) for interacting with the attribute (e.g., entering a value for the attribute).

In some embodiments, a configuration system may check whether an application designer is attempting to define an access path that may violate a referential integrity rule. For instance, because there is a one-to-one relationship between the parent term and the child term, an attempt to create an entry in the child term without creating a corresponding entry in the parent term may violate a referential integrity rule. Accordingly, if the application designer selects the child term, the configuration system may require that the parent term also be selected,

FIG. 38D shows an illustrative screen 3830 that may be generated based on input provided by an application designer via the illustrative display 3820 of FIG. 38C, in accordance with some embodiments. In this example, both the parent term and the child term are shown, with text boxes for the attributes a1, a2, b1, and b2, respectively. If an application user attempts to submit values for the attributes b1 and b2 without submitting values for the attributes a1 and a2, a runtime system may automatically detect an error, because there should be a one-to-one relationship between the parent term and the child term, The runtime system may persist the values for the attributes b1 and b2 only if values are also provided for the attributes a1 and a2 (e.g., storing contact information only if corresponding customer name is provided). In this manner, referential integrity may be maintained without the application designer explicitly writing logic to check referential integrity.

The inventors have recognized and appreciated that a contract may be administered through a life cycle that includes three phases: creation, maintenance, and fulfillment. Accordingly, in some embodiments, a case template may be provided for each of these phases. A creation case template (e.g., New Business 3.4 shown in FIG. 2) may include a quote work item, risk assessment work item, legal binding work item, and/or contract issuing work item. A maintenance case template (e.g., Maintenance 3.5 shown in FIG. 2) may include a monetary change work item, non-monetary change work item, cancellation work item, reinstatement work item, rewrite work item, renewal work item, and/or audit work item. A fulfillment case template (e.g., Fulfillment 3.6 shown in FIG. 2) may include a first notification work item, file setup work item, investigation work item, adjudication work item, dispute management work item, subrogation work item, and audit work item.

In some embodiments, all of the above described work items may share one or more common attributes, but each work item may include one or more additional attributes that are specific to that work item. However, it should be appreciated that the sharing of common attributes is not required. It should also be appreciated that the examples of cases and work items described above and shown in FIG. 2 are merely illustrative, as aspects of the present disclosure are not limited to the use of any particular combination of cases and/or work items. For instance, in some embodiments, a custom case (e.g., Custom 3.7 shown in FIG. 2) may be defined to represent a non-commercial contract, such as an SOP to be followed by an employee of an organization.

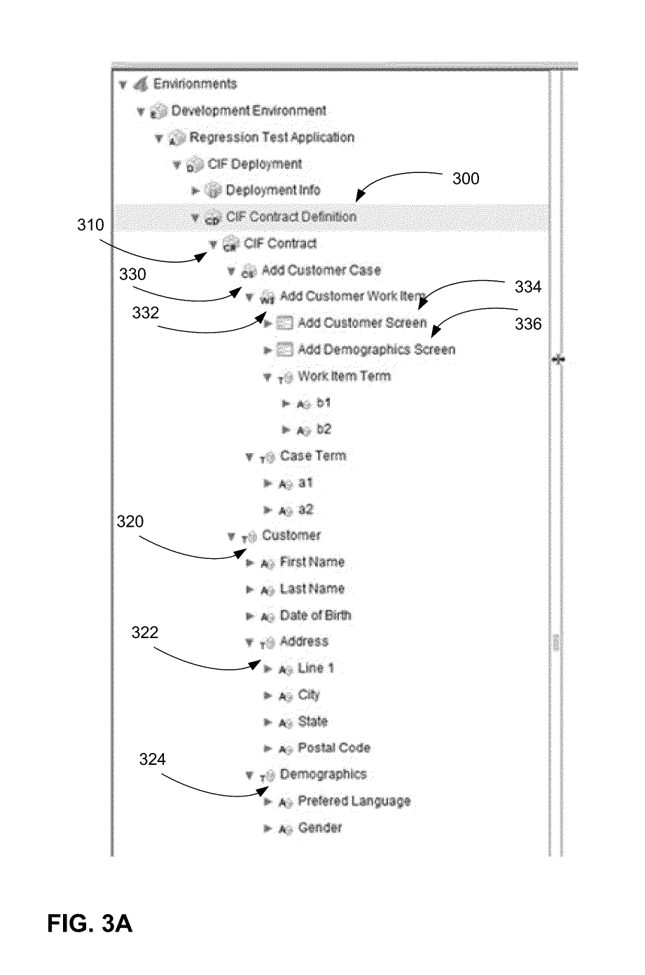

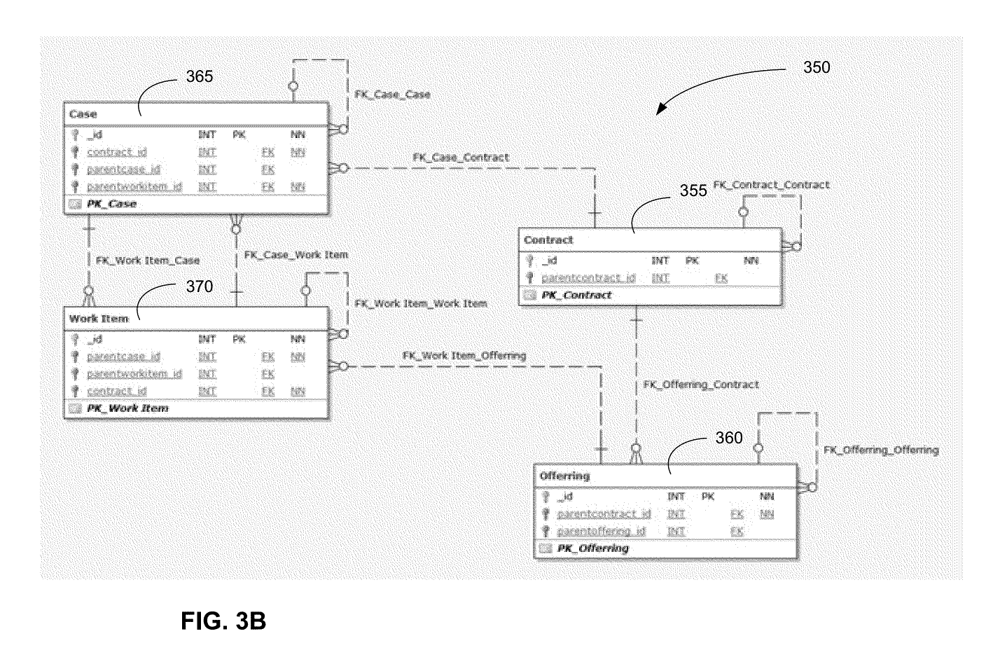

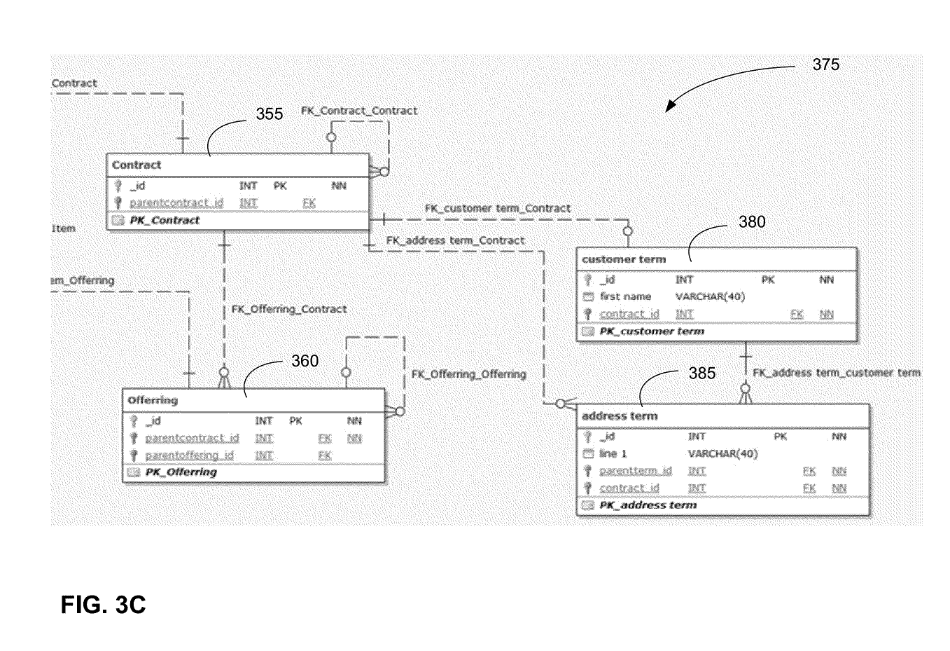

FIG. 3A shows an illustrative contract definition 300 based on the organizational arrangement data structure 210 and process data structure 220 of FIG. 2, in accordance with some embodiments. In this example, the data entity 310 (labeled “CIF Contract”) has the type Contract and includes a contract term 320 (labeled “Customer”). The contract term 320 may include three attributes: “First Name,” “Last Name,” and “Data of Birth.”

In some embodiments, a contract term may be defined recursively to include one or more other contract terms. For instance, in the example of FIG. 3A, the contract term 320 may include contract terms 322 and 324 (labeled “Address” and “Demographics,” respectively). The contract term 322 may include four attributes: “Line 1,” “City,” “State,” and “Postal Code.” The contract term 324 may include two attributes: “Preferred Language” and “Gender.” In some embodiments, the relationship between the contract terms 320 and 322 (e.g., that the contract term 322 is part of the contract term 320) may be implemented by linking the database tables corresponding respectively to the contract terms 320 and 322 (e.g., as shown in FIG. 3C and discussed below). In some embodiments, the relationship between the contract terms 320 and 324 may be implemented by joining the database tables corresponding respectively to the contract terms 320 and 322.

In the example of FIG. 3A, the contract 310 further includes a data entity 330 (labeled “Add Customer Case”) having the type Case. The data entity 330 may include a work item 332 (labeled “Add Customer Work Item”), which may in turn include a screen 334 (labeled “Add Customer Screen”) and a screen 336 (labeled “Add Demographics Screen”). The screen 334 may include one or more access paths to the contract terms 320 and 322 to update the contract terms 320 and 322 with new customer information (e.g., name, date of birth, address, etc.) provided by an application user via the screen 334. The screen 336 may include one or more access paths to the contract term 324 to update the contract term 324 with demographic information regarding the new customer (e.g., preferred language, gender, etc.) provided by an application user via the screen 336.

FIG. 3B shows an illustrative database schema 350 that may be generated by an AMS based on the organizational arrangement data structure 210 and process data structure 220 of FIG. 2, in accordance with some embodiments. In this example, the database schema 350 includes a contract table 355, to which an offering table 360 and a case table 365 are linked. The database schema 350 may also include a work item table 370, which may be linked to the offering table 360 and/or case table 365. In some embodiments, any one of these tables may be linked to itself, which may allow recursive definitions (e.g., child contract of a parent contract, child offering of a parent offering, child case of a parent case, and/or child work item of a work item).

FIG. 3C shows an illustrative database schema 375 that may be generated by an AMS based on a contract definition provided by an application designer, in accordance with some embodiments. For example, the illustrative database schema 375 may be generated based on the illustrative contract definition shown in FIG. 3A and discussed above. In some embodiments, the illustrative database schema 375 may be generated by creating one or more additional database tables (e.g., based on data provided by the application designer) and linking the one or more additional database tables to one or more database tables in the illustrative database schema 350. For example, the illustrative database schema 375 may include a customer term 380 (e.g., corresponding to the contract term 320 shown in FIG. 3A) and an address term 385 (e.g., corresponding to the contract term 322 shown in FIG. 3A). The customer term 380 and/or address term 385 may be linked to the contract table 355. Furthermore, the address term 385 may be linked to the customer term 380 (e.g., as a child of the customer term 380).

Returning to FIG. 2, the illustrative structure 200 may include the organizational arrangement data structure 210 and the process data structure 220 for modeling any suitable organizational arrangements and processes. Additionally, or alternatively, the illustrative structure 200 may include one or more structures that can be used to facilitate the development and/or maintenance of a software application generated using the organizational arrangement data structure 210 and the process data structure 220. For example, in some embodiments, the structure 200 may include a customer (e.g., Cust 1.1 shown in FIG. 2), which may be an organization that makes use of an AMS to develop and/or maintain one or more software applications to support the organization's arrangements and processes (e.g., external contracts and/or internal operating procedures). In some embodiments, an AMS may execute on one or more cloud servers, and may be provided to a customer organization under a software-as-a-service (SaaS) model. The customer organization may be able to log on to the AMS remotely to establish one or more software execution environments, configure one or more security layers, etc.

In some embodiments, each customer organization may have one or more accounts (e.g., Acct 1.2 shown in FIG. 2), which may correspond respectively to different portions of the customer organization (e.g., different units or divisions) that engage in different types of activities (e.g., different lines of businesses). Each account may include an organizational structure (e.g., Org 1.3 shown in FIG. 2) comprising one or more roles (e.g., Role 1.4 shown in FIG. 2), where each role may have one or more responsibilities (e.g., Respon 1.5 shown in FIG. 2). Moreover, each role may be played by one or more persons (e.g., Party 1.6 shown in FIG. 2), and each person may be an application user (e.g., User 1.7 shown in FIG. 2) or an application designer (also referred to as a system configurator, e.g., System Config 1.8 shown in FIG. 2).

In some embodiments, an organizational structure may be defined recursively to include one or more sub-structures. For example, in a large organization, a division may be divided into multiple departments having different responsibilities, where each department may be further divided into multiple groups having different responsibilities, and so on. In this manner, an AMS may be readily adapted to accommodate the growth and/or restructuring of an organization over time. As one example, a new department may be added simply as a child of a division and sibling of existing departments under that division. As another example, a group may be moved from a first department to a second department simply by deleting a parent-child link to the first department and adding a parent-child link to the second department, and there may be no need to re-configure the group. The inventors have recognized and appreciated that recursive definitions for organizational structures may provide flexibility, thereby extending the useful life of an AMS. However, it should be appreciated that some of the inventive concepts described herein may be implemented without recursive definitions for organizational structures.

The inventors have further recognized and appreciated that information regarding a customer's organizational structure, such as various employees' roles and responsibilities, may be used advantageously by an AMS to track and/or control access to configuration systems, runtime systems, environments in which runtime systems are deployed, etc. For example, in some embodiments, an application designer, but not an application user, may be permitted to configure an environment (e.g., Environment 1.9 shown in FIG. 2), one or more applications (e.g., Applications 1.10 shown in FIG. 2) executing in that environment, and/or one or more instances (also referred to as deployments, e.g., Deployment 1.11 shown in FIG. 2) of an application. On the other hand, an application user may have access to one or more cases in a case queue (e.g., Case Queue 5.1 shown in FIG. 2) and/or one or more work items in a work item queue (e.g., Work Item Q 5.2 shown in FIG. 2), where the case queue and work item queue may store, respectively, cases and work items that exist in one or more runtime systems. One or more queue filters (e.g., Queue Filters 5.3 shown in FIG. 2) may be used to implement access control at any suitable granularity, e.g., based on the application user's organizational affiliation, role, and/or responsibility.

In some embodiments, an environment may include computing hardware, operating system, third party software, and/or any other suitable resources that may be used by an AMS to develop, test, and/or maintain a software application. For example, an environment may include one or more servers, databases, load balancers, etc. Different environments may be established for different phases in an application's life cycle. For example, in some embodiments, there may be a development environment, integration testing environment, quality assurance environment, performance tuning environment, user acceptance testing environment, pre-production testing environment, and/or production environment. An application may be developed in and/or migrated through one or more of these environments.

In some embodiments, an organization or a portion thereof (e.g., a department within the organization) may need multiple applications to support various activities and/or various stages through a life cycle of an activity. For instance, a finance department may need a suite of applications, such as accounts payable, accounts receivable, general ledger, billing, etc. Each application may include a logical grouping of data structures and/or rules that may be used to automate the collection, processing, and/or storage of data (e.g., to improve the accuracy, consistency, and/or efficiency of these processes).

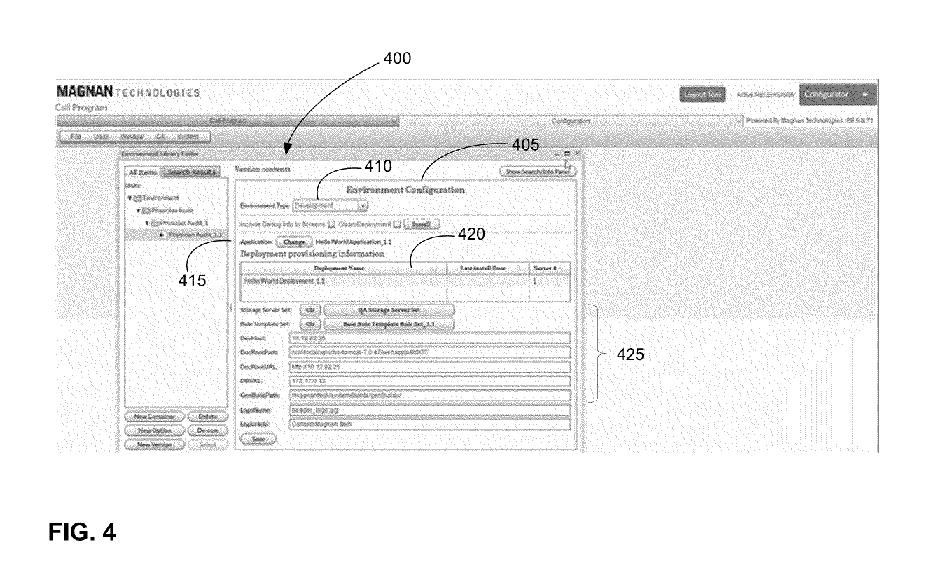

FIGS. 4-27 show illustrative user interface displays for interacting with an application designer, in accordance with some embodiments. For example, the illustrative displays shown in FIGS. 4-27 may be presented by the illustrative configuration user interface 108 shown in FIG. 1 to prompt the application designer 102 to provide organizational arrangement and/or process data that may be used to generate a software application that supports the organizational arrangement and/or process.

It should be appreciated that the examples of user interface displays shown in FIGS. 4-27 and described below are provided solely for purposes of illustration. Aspects of the present disclosure are not limited to the particular arrangement of user interface elements, nor to the particular combination of information that is displayed.

FIG. 4 shows an illustrative environment library editor 400, in accordance with some embodiments. The environment library editor 400 may be used to define new environments and/or search for existing environments stored in an environment library. As shown in FIG. 4, the illustrative environment library editor 400 may include an environment configuration panel 405, which may include one or more user interface elements for displaying information to an application designer, and/or prompting the application designer to enter information, about a particular environment. For example, the environment configuration panel 405 may include a menu 410 for selecting an environment type (e.g., development, integration testing, quality assurance, performance tuning, user acceptance testing, pre-production testing, and/or production). Additionally, or alternatively, the environment configuration panel 405 may include a display 415 of a name of an application (e.g., Hello World Application 1.1) that resides in the particular environment. The application designer may switch from working on one application to another application, for example, by clicking a Change button on the display 415, and then browsing through a list of existing applications or creating a new application.

In some embodiments, the environment configuration panel 405 may also include a list 420 of one or more deployments of the application identified in the display 415. When the application designer selects a deployment, a display area 425 may show one or more configuration parameters for the selected deployment. In some embodiments, the display area 425 may also be used by the application designer to specify one or more configuration parameters, including, but not limited to, one or more storage server sets and/or one or more rule template sets available to the deployment, a host on which the deployment is to execute, a uniform resource locator (URL) and/or path for the documentation for the deployment, a database URL for one or more databases associated with the deployment, and/or a path for the executable code for the deployment. Any suitable combination of these parameters and/or other parameters may be displayed to and/or configurable by the application designer.

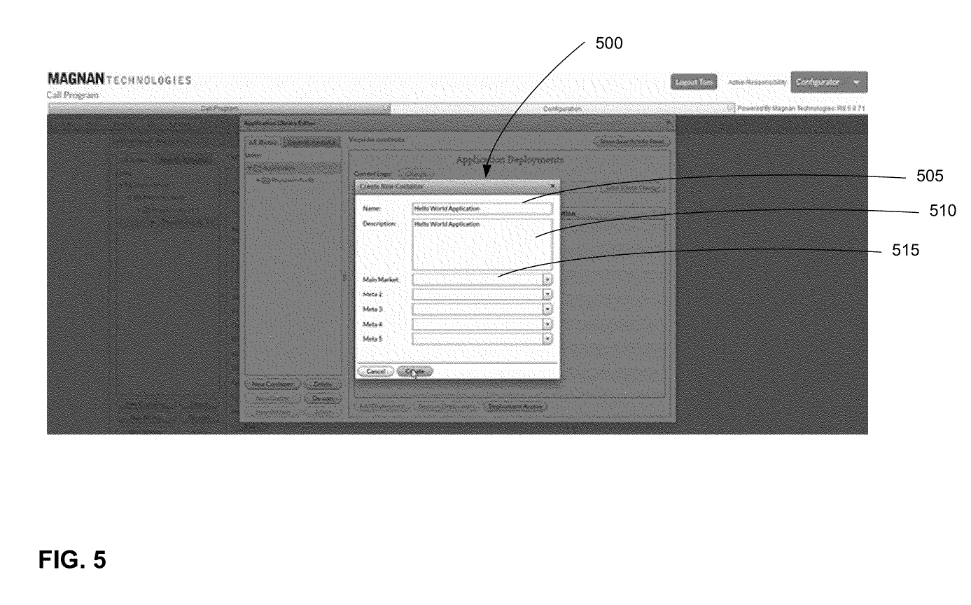

FIG. 5 shows an illustrative display 500 that may be used to prompt an application designer to provide information regarding a new application, in accordance with some embodiments. For example, the display 500 may include prompts 505 and 510 to prompt the application designer to enter a name and description for the new application, respectively. In some embodiments, the display 500 may additionally include one or more menus 515 to allow the application designer to select one or more tags to be associated with the new application. These tags may facilitate searching of existing applications, for example, when an application designer wishes to find an existing application that can be used as a baseline for developing a new, but similar application. For example, the new application may have data and/or process structures that are identical or nearly identical to the existing application, so that only relatively minor changes (e.g., changes in contextual data) may be needed to build the new application.

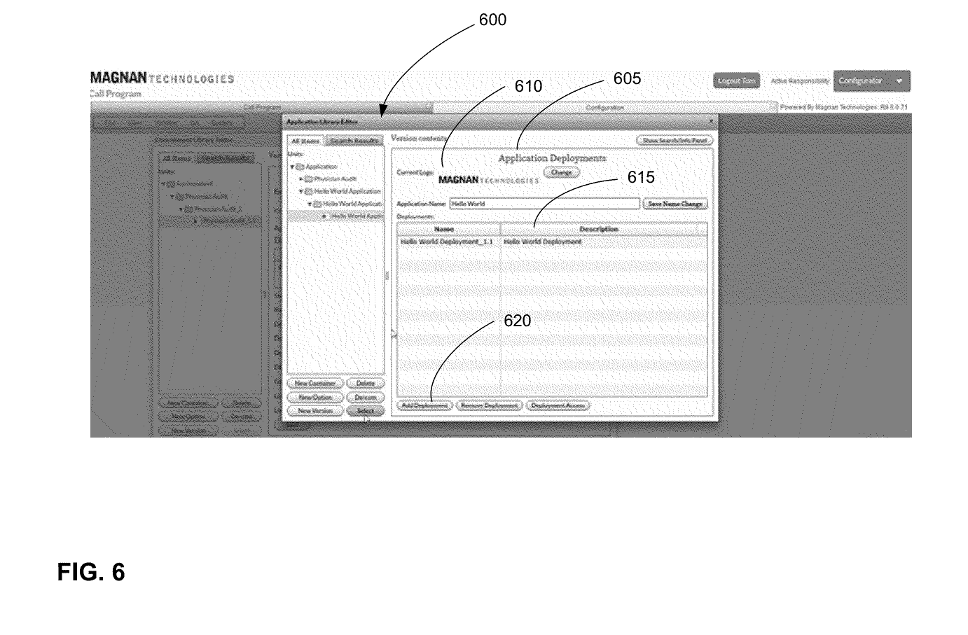

FIG. 6 shows an illustrative application library editor 600, in accordance with some embodiments. The application library editor 600 may be used to define new applications and/or search for existing applications stored in an application library. As shown in FIG. 6, the illustrative application library editor 600 may include an application deployments panel 605, which may include one or more user interface elements for displaying information to an application designer, and/or prompting the application designer to enter information, about a particular application. For example, the application deployments panel 605 may include a display 610 of a logo for the application. The application designer may change the logo, for example, by clicking a Change button on the display 610, and then browsing through a list of available images. In some embodiments, the application deployments panel 605 may also include a list 615 of one or more deployments of the application and/or a button 620 for adding a new deployment.

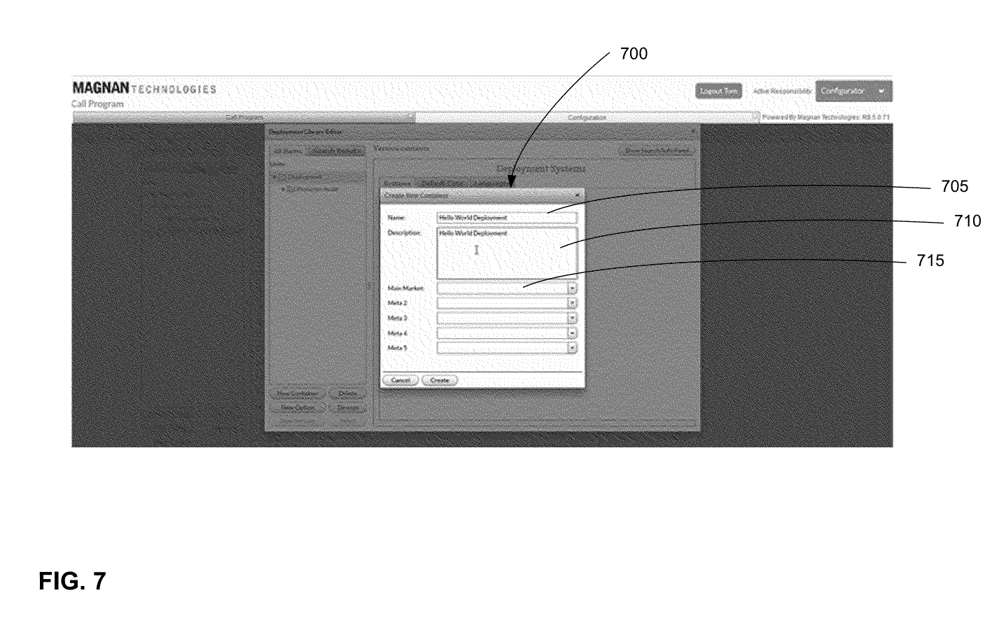

FIG. 7 shows an illustrative display 700 that may be used to prompt an application designer to provide information regarding a new deployment, in accordance with some embodiments. For example, the display 700 may include prompts 705 and 710 to prompt the application designer to enter a name and description for the new deployment, respectively. In some embodiments, the display 700 may additionally include one or more menus 715 to allow the application designer to select one or more tags to be associated with the new deployment. These tags may facilitate searching of existing deployments, for example, when an application designer wishes to find an existing deployment that can be readily repurposed for deployment in a different context.

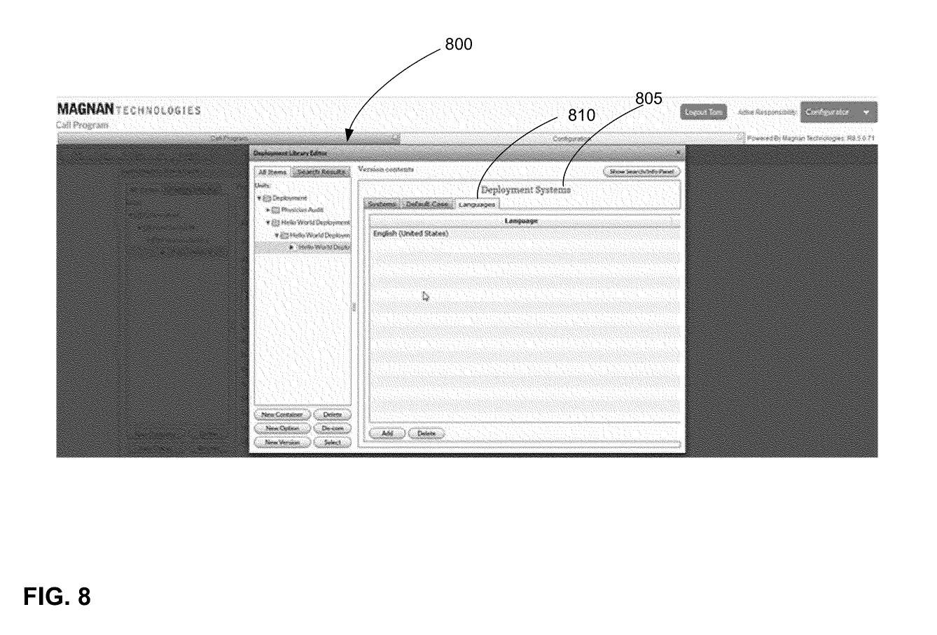

FIG. 8 shows an illustrative deployment library editor 800, in accordance with some embodiments. The deployment library editor 800 may be used to define new deployments and/or search for existing deployments stored in a deployment library. As shown in FIG. 8, the illustrative deployment library editor 800 may include a deployment systems panel 805, which may include one or more user interface elements for displaying information to an application designer, and/or prompting the application designer to enter information, about a particular deployment. For example, the deployment systems panel 805 may include a languages tab 810, which may in turn include a list of one or more languages, a button for adding a new language, and/or a button for deleting a selected language. In this manner, an application may be deployed in multiple languages. For example, an auto insurance application may be deployed in English, Spanish, Chinese, and/or any other language. The screens presented by a runtime system to an application user may have instructions in different languages, but the underlying workflow may be the same, and the underlying data may be stored and processed in the same manner.

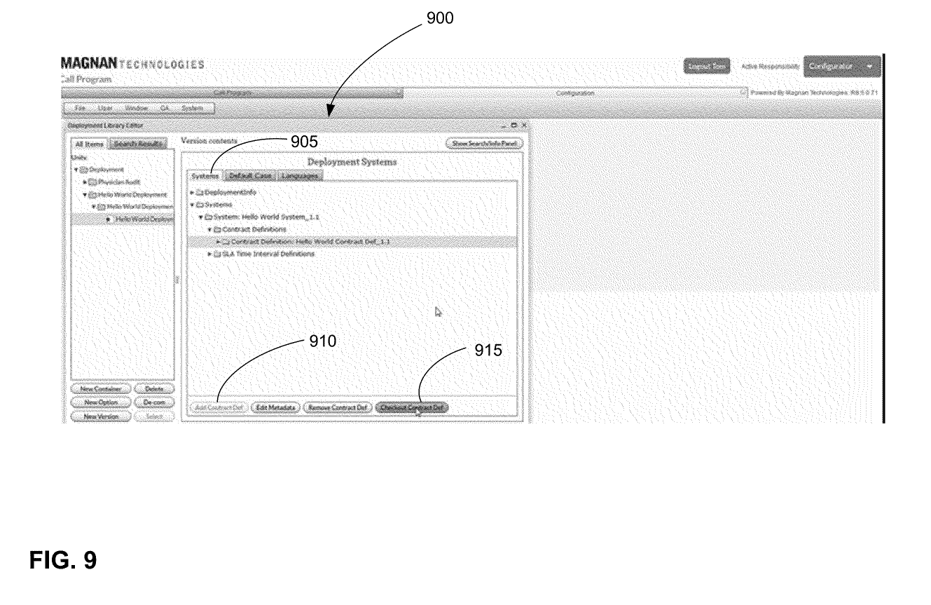

FIG. 9 shows an illustrative systems tab 900 of the deployment library editor 800 shown in FIG. 8, in accordance with some embodiments. The systems tab 900 may allow an application designer to view one or more systems that have been defined in a particular deployment, and/or create a new system. Each system may include one or more contract definitions, which may describe one or more aspects of an organizational arrangement being modeled (e.g., a contract with an external entity such as a customer or a vendor, an internal operating procedure to be followed by an employee, etc.). A new contract definition may be provided by the application designer, for example, by clicking an Add button 910.

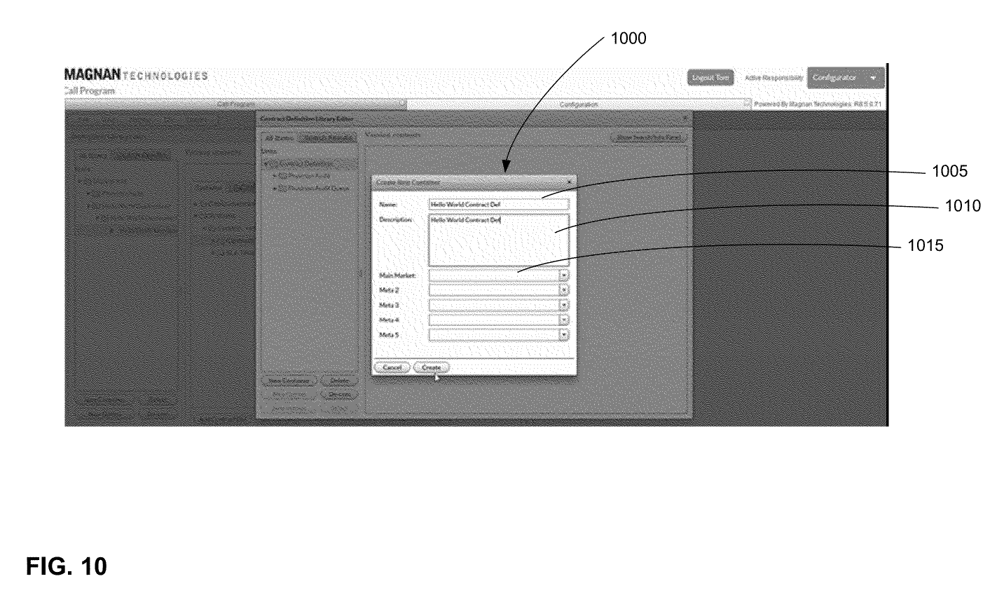

FIG. 10 shows an illustrative display 1000 that may be used to prompt an application designer to provide information regarding a new contract definition, in accordance with some embodiments. For example, the display 1000 may include prompts 1005 and 1010 to prompt the application designer to enter a name and description for the new contract definition, respectively. In some embodiments, the display 1000 may additionally include one or more menus 1015 to allow the application designer to select one or more tags to be associated with the new contract definition. These tags may facilitate searching of existing contract definitions, for example, when an application designer wishes to find an existing contract definition that can be readily repurposed for use as a different contract definition in the same deployment or application, or in a different deployment or application.

In some embodiments, a contract definition, once created, may be listed under the illustrative systems tab 905 shown in FIG. 9. An application designer may select and check out a contract definition from the systems tab 905 for viewing and/or editing, for example, by clicking a Checkout button 915. In some embodiments, a configuration system of an AMS may provide one or more version control functionalities. As one example, once an object under version control (e.g., contract definition) is checked out by one application designer for editing, all other application designers may be prohibited from editing that object, but may still view the last version of the object that was checked in. As another example, a log may be maintained regarding all changes made by an application designer each time an object is checked in, so that a complete history of modifications may be available. As yet another example, a branch may be created by duplicating an object and allowing the original object and the duplicate to be modified at the same time. Changes made in such a branch may, although need not, be later merged back onto the original object.

It should be appreciated that version control may be applied to any suitable object, in addition to, or instead of, a contract definition. For example, version control may be applied to process definitions, configuration settings, and/or an entire deployment. Furthermore, although version control may be desirable, aspects of the present disclosure are not limited to the use of any version control functionality.

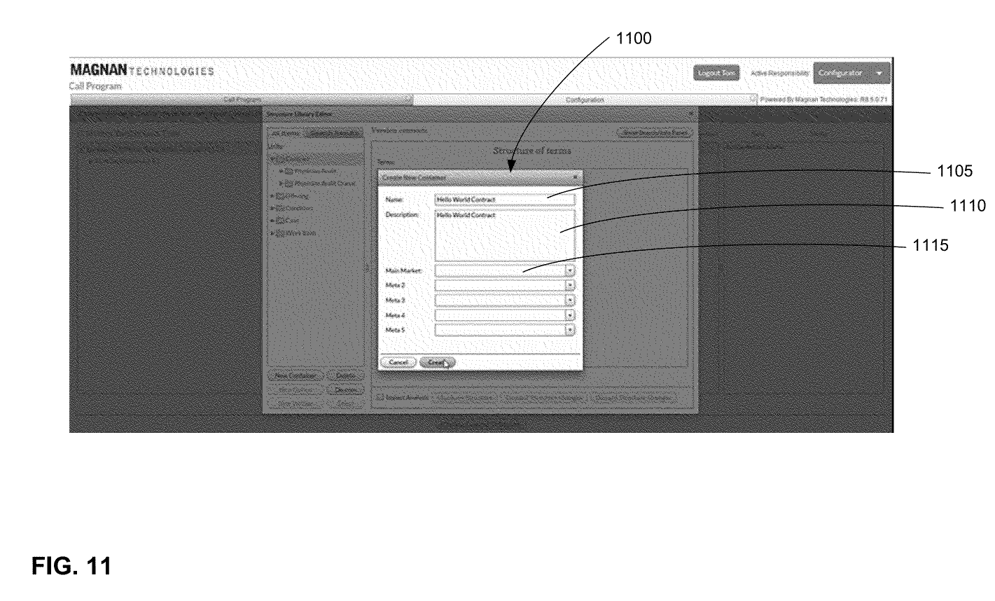

FIG. 11 shows an illustrative display 1100 that may be used to prompt an application designer to provide information regarding a new contract term, in accordance with some embodiments. As discussed above in connection with FIG. 2, a contract term may represent one or more provisions that apply to an organizational arrangement and may have a corresponding database table for storing attributes that are individual data elements of the contract term. In the example shown in FIG. 11, the display 1100 includes prompts 1105 and 1110 to prompt the application designer to enter a name and description for the new contract term, respectively. In some embodiments, the display 1100 may additionally include one or more menus 1115 to allow the application designer to select one or more tags to be associated with the new contract term. These tags may facilitate searching of existing contract terms, for example, when an application designer wishes to find an existing contract term that can be readily repurposed for use as a different contract term in the same or a different contract definition.

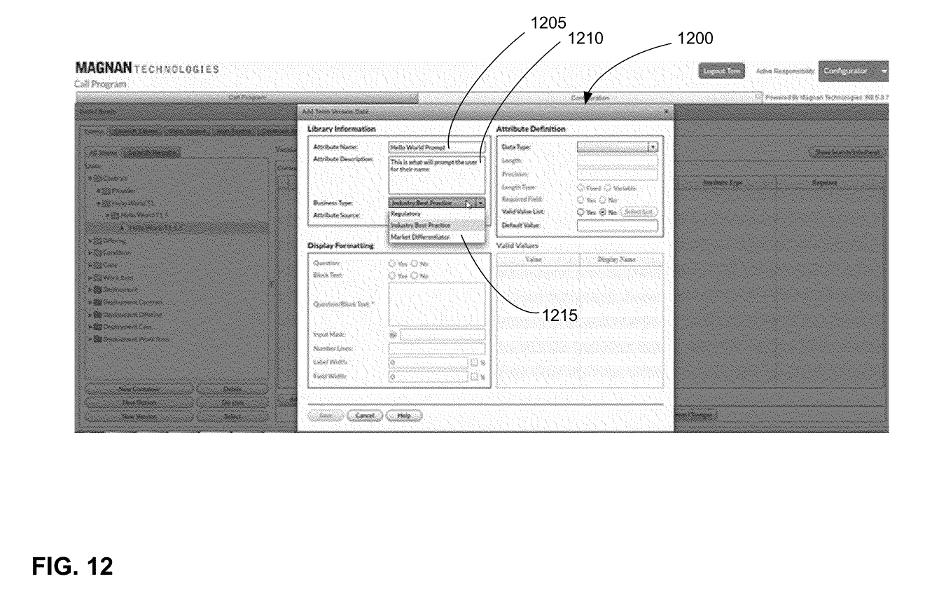

FIG. 12 shows an illustrative display 1200 that may be used to prompt an application designer to provide information regarding an attribute for a contract term, in accordance with some embodiments. For example, the display 1200 may include prompts 1205 and 1210 to prompt the application designer to enter a name and description for the new attribute, respectively. In some embodiments, the display 1200 may additionally include a menu 1215 to allow the application designer to select one or more tags to be associated with the new attribute. In the example shown in FIG. 12, the menu 1215 includes three tags: regulatory, industry best practice, and market differentiator. Associating an attribute with a regulatory tag may indicate that the attribute relates to a regulatory requirement applicable to an organizational arrangement being modeled. Associating an attribute with an industry best practice tag may indicate that the attribute relates to an industry best practice applicable to the organizational arrangement being modeled. Associating an attribute with a market differentiator tag may indicate that the attribute relates to an internally preferred practice, which may provide an organization with an advantage over competitors.

The inventors have recognized and appreciated that associating an attribute with a market differentiator tag (or another similar tag) may allow a vendor of an AMS to readily identify propriety information belonging to a customer. For example, the vendor may use attributes tagged as regulatory or industry best practice when delivering software applications to different customers, but may use attributes tagged as market differentiator only in software applications delivered to the customer that owns the proprietary information. However, it should be appreciated that other tags may be used in addition to, or instead of, one or more of the three illustrative tags shown in FIG. 12, or no tag may be used at all.

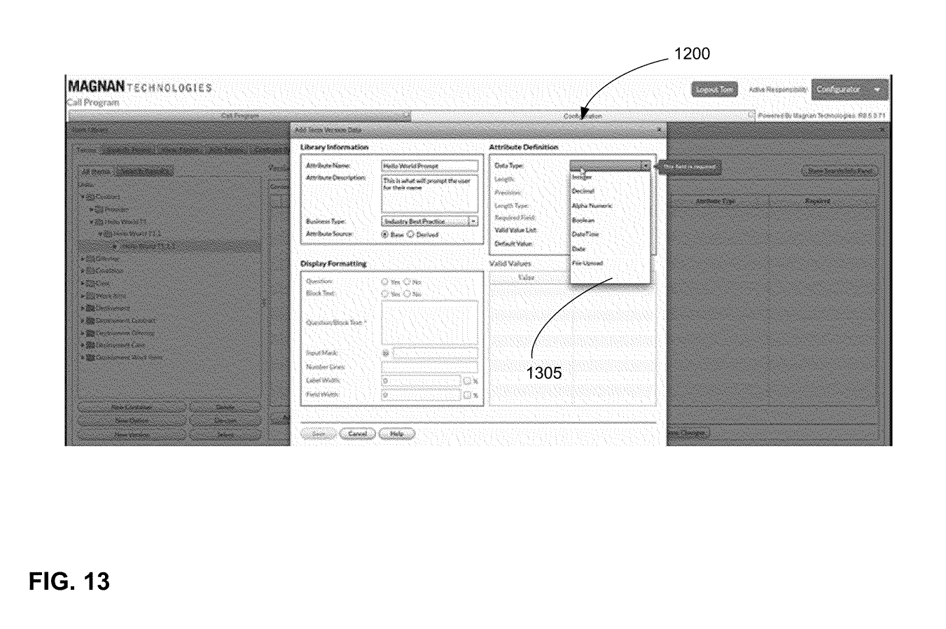

FIG. 13 shows an illustrative menu 1305 of the display 1200 shown in FIG. 12, in accordance with some embodiments. The menu 1305 may allow an application designer to specify a data type for the attribute being defined (e.g., Integer, Decimal, Alphanumeric, Boolean, DateTime, Date, FileUpload, etc.). In some embodiments, one or more visual indications may be provided on the display 1200 to indicate to the application designer that a piece of information is required. For example, a red flag and/or a highlight around the menu 1305 may be used to indicate that the application designer must specify a data type for the attribute. However, it should be appreciated that in some embodiments a data type may not be required, nor is the use of any visual cue to indicate a required data type.

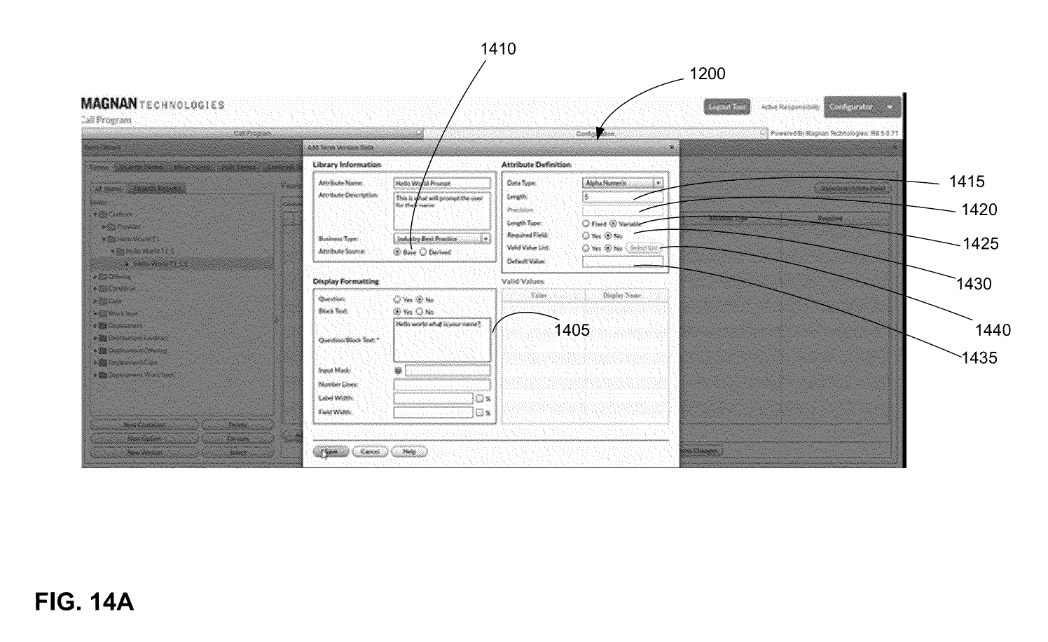

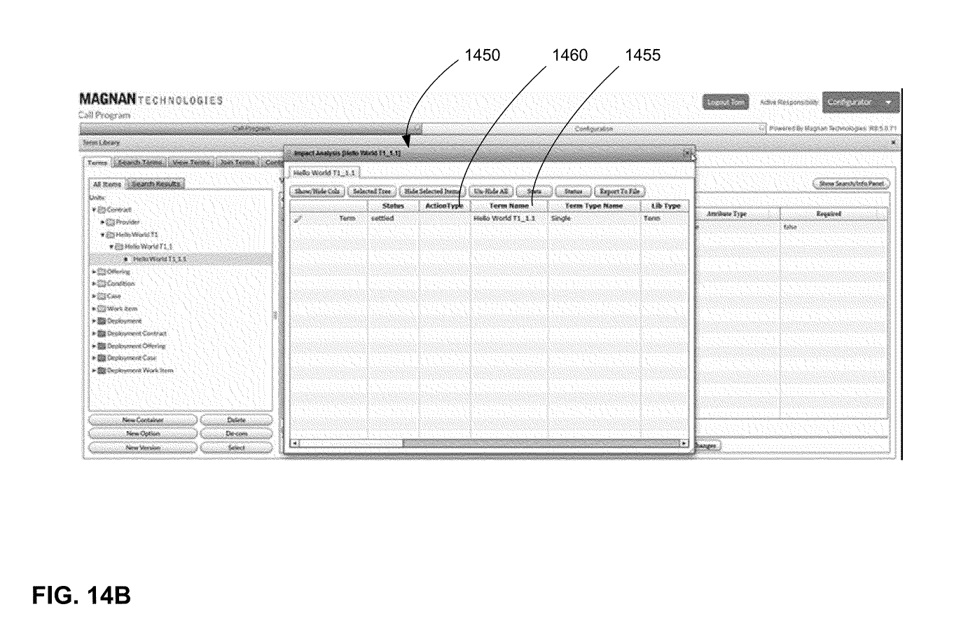

FIG. 14A shows an illustrative display formatting section 1405 of the display 1200 shown in FIG. 12, in accordance with some embodiments. The display formatting section 1405 may allow an application designer to specify how an application user may be prompted to provide a value for the attribute being defined. For example, the display formatting section 1405 may include a text box for entering a prompt to be rendered to the application user (e.g., visually and/or audibly).

In some embodiments, the display 1200 may prompt an application designer to indicate a source for the attribute being defined. For example, as shown in FIG. 14A, the display 1200 includes one or more option buttons 1410. The application designer may indicate that the attribute is a value to be entered by an application user (e.g., by selecting the Base option), or a value derived from some other data (e.g., by selecting the Derived option).

In some embodiments, the display 1200 may prompt an application designer to enter a length for the attribute being defined (e.g., the length of an alphanumeric string), for example, via a Length field 1415 as shown in FIG. 14A.

In some embodiments, the display 1200 may prompt an application designer to enter a precision for the attribute being defined (e.g., the number of decimals of a real number), for example, via a Precision field 1420 as shown in FIG. 14A.

In some embodiments, the display 1200 may prompt an application designer to indicate whether the attribute being defined is to have fixed or variable length, for example, via one or more option buttons 1425 as shown in FIG. 14A.

In some embodiments, the display 1200 may prompt an application designer to indicate whether an application user is required to provide a value for the attribute being defined, for example, via one or more option buttons 1430 as shown in FIG. 14A.

In some embodiments, the display 1200 may prompt an application designer to provide a default value for the attribute being defined, for example, via a Default Value field 1435 as shown in FIG. 14A. Such a default value may be used if an application user does not provide a value for the attribute.

FIG. 14B shows an illustrative impact analysis display 1450, in accordance with some embodiments. The illustrative impact analysis display 1450 may be presented to an application designer when the application designer makes a modification to a term (e.g., by changing the definition of an attribute in the term). The display 1450 may identify (e.g., at column 1455) one or more terms that reference the modified term, and/or indicate (e.g., at column 1460) how data in the modified term is used in the one or more referencing terms. In some embodiments, the impact analysis display may identify every contract, offering, case, work item, screen, transaction, and/or rule that use the data to be modified. In this manner, the application designer may be prompted to review and consider the potential impact of a change prior to making the change. In some embodiments, an impact analysis may be presented whenever the application designer attempts to make a change to any aspect of an application, including, but not limited to, organizational arrangement data structure, process structure, screen, transaction, and/or rule. This information may allow the application designer to consider whether the modification would cause any inconsistency elsewhere in the software application. However, it should be appreciated that aspects of the present disclosure are not limited to the display of information regarding the potential impact of a proposed modification.

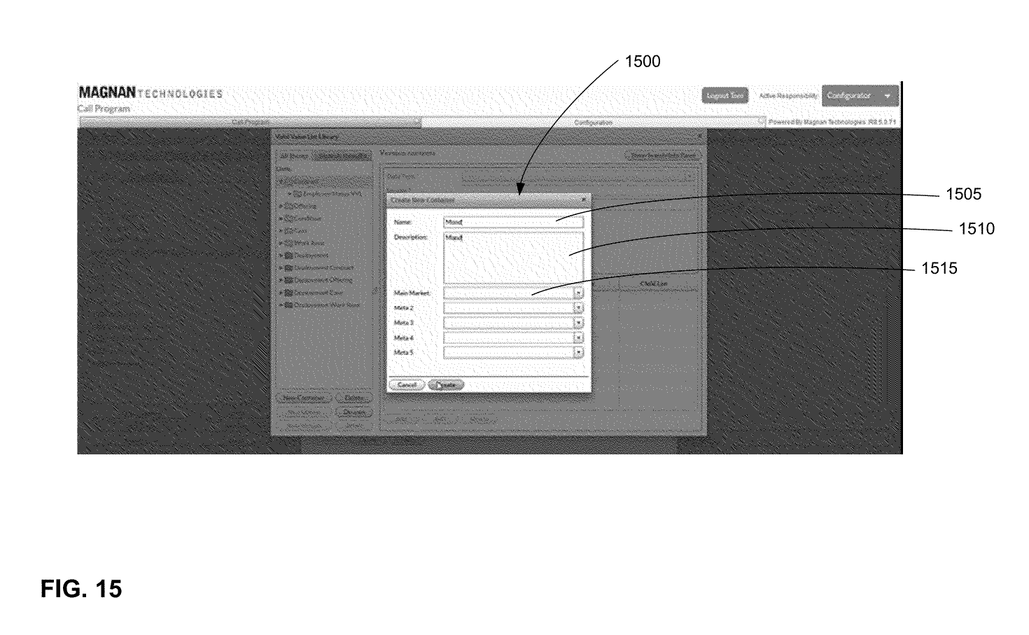

FIG. 15 shows an illustrative display 1500 that may be used to prompt an application designer to provide information regarding a custom-defined data type, in accordance with some embodiments. For example, the display 1500 may be presented to the application designer in response to the application designer selecting a Valid Value List option 1440 from the display 1200 and requesting to create a new valid value list.

In the example of FIG. 15, the display 1500 may include prompts 1505 and 1510 to prompt the application designer to enter a name and description for the custom-defined data type, respectively. In some embodiments, the display 1500 may additionally include one or more menus 1515 to allow the application designer to select one or more tags to be associated with the custom-defined data type. These tags may facilitate searching of existing custom-defined data types, for example, when an application designer wishes to find an existing custom-defined data type that can be used as is or with minor modifications.

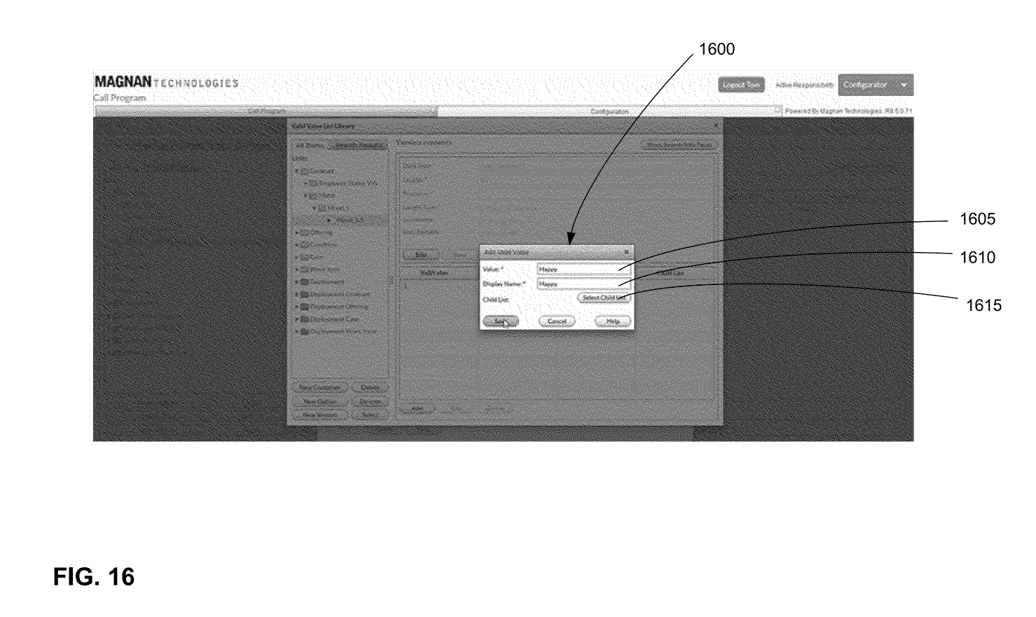

FIG. 16 shows an illustrative display 1600 that may be used to prompt an application designer to define a valid value for a custom-defined data type, in accordance with some embodiments. For example, the display 1600 may include prompts 1605 and 1610 to prompt the application designer to enter a value and display name, respectively. The value and display name may be the same or different. For example, a valid value for a data type Mood may be the number 0, Boolean value “true,” letter “A,” or the like, while the display name may be “Happy.” In some embodiments, the display 1600 may additionally include a Select button 1615 for selecting a child list. For example, a custom-defined data type Vehicle Type may include a parent list including multiple vehicle manufacturers (e.g., Ford, GM, Toyota, etc.), where a value in the parent list may have a child list including multiple vehicle brands (e.g., Chevrolet, Buick, GMC, etc.). In some embodiments, a value in the child list may have a grandchild list including multiple vehicle models (e.g., Impala, Malibu, Volt, etc.). Such a nested pattern may repeat any suitable number of times.

As discussed above in connection with FIG. 2, an offering may be a grouping of one or more sub-commitments within an organizational arrangement. Furthermore, an offering term may represent one or more provisions that apply only to the offering and may have a corresponding database table for storing attributes that are individual data elements of the offering term. In some embodiments, one or more of the illustrative displays shown in FIGS. 10-16 may be used to define an offering and/or offering term. For example, one or more tags may be associated with the offering and/or offering term to facilitate searching and reuse.

Also as discussed above in connection with FIG. 2, an organizational process may include cases, which are units of work to be tracked over time, and a case may include one or more work items to be completed. A case term may represent data to be retrieved and/or recorded in connection with the case, including, but not limited to, data to be recorded for monitoring, measuring, and/or auditing purposes. Furthermore, a case term may have a corresponding database table for storing attributes that are individual data elements of the case term. Similarly, a work item term may represent data to be retrieved and/or recorded in connection with the work item, including, but not limited to, data to be recorded for monitoring, measuring, and/or auditing purposes. Furthermore, a work item term may have a corresponding database table for storing attributes that are individual data elements of the work item term. In some embodiments, one or more of the illustrative displays show in FIGS. 10-16 may be used to define a case, case term, work item, and/or work item term. For example, one or more tags may be associated with the case, case term, work item, and/or work item term to facilitate searching and reuse.

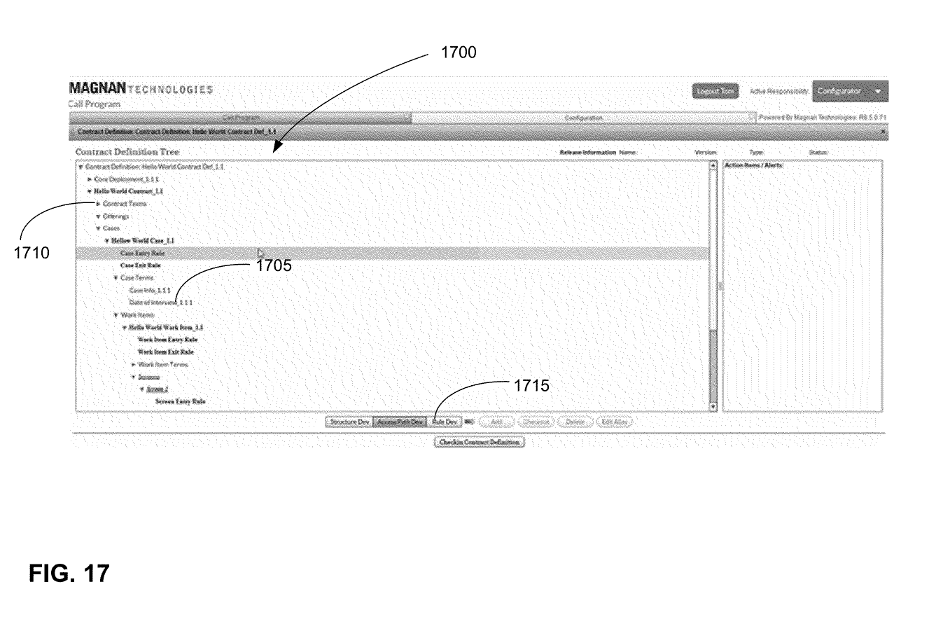

FIG. 17 shows an illustrative display 1700 of a contract definition tree, in accordance with some embodiments. The display 1700 may be used by an application designer to navigate through a contract definition and select one or more portions (e.g., contract terms, offerings, offering terms, cases, case terms, work items, work item terms, screens, etc.) for viewing and/or editing. For example, the illustrative contract definition shown in FIG. 17 includes a case term 1705, labeled “Date of Interview,” which may be used to capture a piece of data (e.g., a date on which an interview is conducted in connection with a case) that may not be related to a commitment under a contract but may be used for monitoring, measuring, and/or auditing purposes. By contrast, data relating to one or more commitments under the contract may be stored in one or more contract terms 1710.

In some embodiments, a case may include one or more rules to be executed, in addition to, or instead of, one or more work items. A rule may defined by an application designer to include one or more processing steps to be taken in connection with a case. For example, a case may include an on entry rule (e.g., On Entry rule 4.1 shown in FIG. 2) to be executed when a case is initiated. Alternatively, or additionally, a case may include an on exit rule (e.g., On Exit rule 4.2 shown in FIG. 2) to be executed when the case is completed. Likewise, in some embodiments, a work item may include one or more rules to be executed, such as an on entry rule (e.g., On Entry rule 4.3 shown in FIG. 2) and/or on exit rule (e.g., On Exit rule 4.4 shown in FIG. 2), and a screen or transaction may include one or more rules to be executed, such as an on entry rule (e.g., On Entry rule 4.5 shown in FIG. 2) and/or on exit rule (e.g., On Exit rule 4.6 shown in FIG. 2).

In some embodiments, a configuration system may provide one or more default rules for a case, work item, screen, or transaction. For example, an on entry and/or on exit rule may be presented in the display 1700, without being added to the contract structure explicitly by the application designer. Such a default rule may include one or more pre-defined processing steps. For instance, a case entry rule may add the case to a case queue (e.g., Case Queue 5.1 show in FIG. 2), while a case exit rule may remove the case from the case queue. Likewise, a work item entry rule may add the work item to a work item queue (e.g., Work Item Q 5.2 show in FIG. 2), while a work item exit rule may remove the case from the work item queue. In some embodiments, an application designer may not be able to alter or omit this default behavior, but may be able to add one or more processing steps. However, it should be appreciated that aspects of the present disclosure are not limited to the use of default rules. In some embodiments, no default rule may be provided, and application designer may define one or more custom rules. Alternatively, or additionally, one or more default rules may be provided, and the application designer may be able to edit or delete any default rule. In some embodiments, a superuser may configure a default rule, or any aspect of a default rule (e.g., one or more program elements within the rule), to be required, recommended, optional, etc.

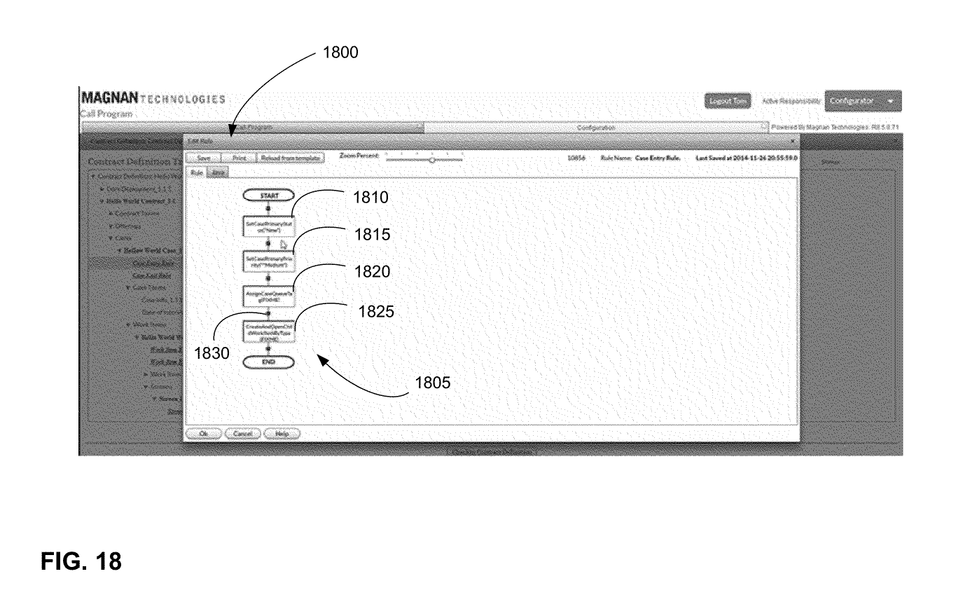

In some embodiments, an application designer may select a rule for editing by clicking on the rule from the display 1700 and then clicking on a Rule Development button 1720 to activate a rule editing interface. FIG. 18 shows an illustrative rule editing interface 1800, in accordance with some embodiments. The interface 1800 may be a graphical programming interface via which an application designer may program the behavior of a runtime system by manipulating one or more program elements visually. For example, the one or more program elements may include one or more shapes representing steps (e.g., rectangles for regular processing steps, diamonds for decision steps, etc.) and/or one or more connectors connecting the shapes to create a process flow (e.g., an ordered execution of steps). In this manner, the application designer may specify program logic by drawing a flowchart using the one or more program elements.

In some embodiments, a program element may be pre-defined and made available to the application designer (e.g., via menu options, libraries, etc.). Additionally, or alternatively, a program element may be defined by the application designer using one or more program routines available through the configuration system (e.g., via menu options, libraries, etc.). Such a custom-defined program element may be stored by the configuration system so that the same or a different application designer may reuse the program element in the future, with or without modification. A suitable indexing scheme may be used to facilitate searching of stored program elements.

In some embodiments, one or more rule templates may be pre-defined and made available to an application designer (e.g., via menu options, libraries, etc.). An illustrative template 1805 for a case entry rule is shown in FIG. 18. In this example, the template 1805 includes a flowchart having four program elements 1810, 1815, 1820, and 1825. Each program element may represent a high-level processing step to be executed when a new case is created. For example, the program element 1810 may represent a processing step to set a case status (e.g., to New), the program element 1815 may represent a processing step to set a priority of the new case (e.g., to Medium), the program element 1820 may represent a processing step to add the new case to a case queue (e.g., Case Queue 5.1 show in FIG. 2), and the program element 1825 may represent a processing step to create a work item for the new case.

The inventors have recognized and appreciated that the processing steps represented by the program elements 1810, 1815, 1820, and 1825 may be useful when a new case is created, regardless of the nature of the case (e.g., issuing a new auto insurance policy, filing an insurance claim, etc.). Therefore, providing these processing steps in a case entry rule template may reduce the time and effort needed for an application designer to program a case entry rule. However, it should be appreciated that these program elements are merely illustrative, as aspects of the present disclosure are not limited to the use of any particular program element or combination of program elements in a case entry rule. Moreover, the program elements need not be executed in the particular order shown in FIG. 18, as another ordering may also be suitable. Additionally, or alternatively, some of the program elements may be executed in parallel.

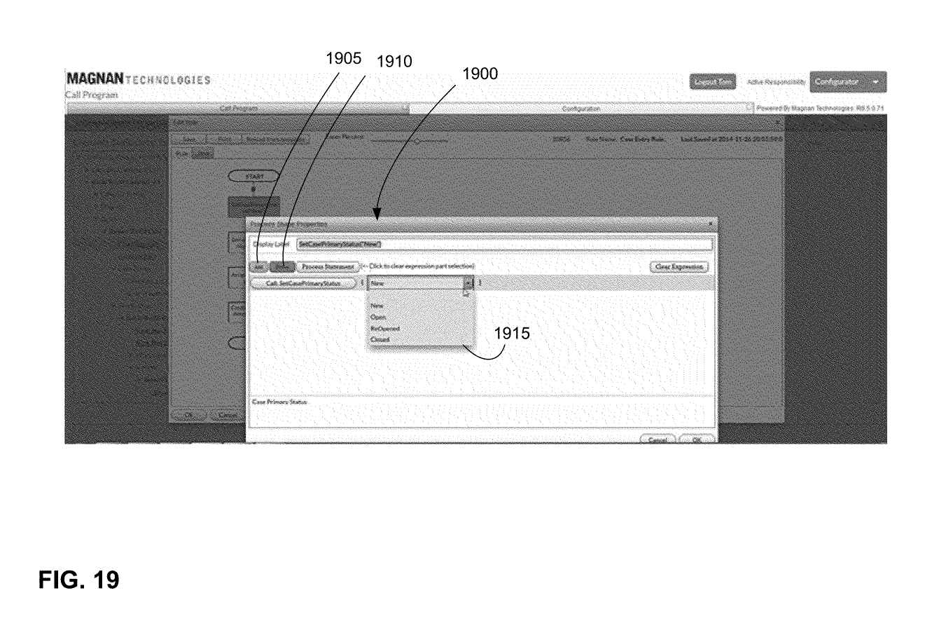

In some embodiments, a configuration system may allow an application designer to modify one or more program elements in a rule template. FIG. 19 shows an illustrative menu 1900 for defining and/or modifying a program element, in accordance with some embodiments. As one example, an application designer may add logic to a program element by clicking an Add button 1905, which may activate a menu of available routines. As another example, an application designer may delete logic from a program element by selecting a routine to be deleted and clicking a Delete button 1910. As yet another example, an application designer may select a parameter for a routine (e.g., a set case status routine) from a menu 1915 showing the available parameter values (e.g., New, Open, Reopened, and/or Closed). Alternatively, or additionally, the application designer may enter a parameter value using a text field (not shown).

The inventors have recognized and appreciated that the examples of status labels shown in FIG. 19 may be commonly used by application designers. Therefore, providing these status labels as default options may reduce the time and effort needed for an application designer to define a program element. However, it should be appreciated that aspects of the present disclosure are not limited to the examples of status labels shown in FIG. 19, as other status labels may also be used to track cases and/or work items. For example, in some embodiments, custom-defined status labels may be used in addition to, or instead of default statuses. Furthermore, although the illustrative program element shown in FIG. 19 includes only one routine, it should be appreciated that a program element may include any number of routines.

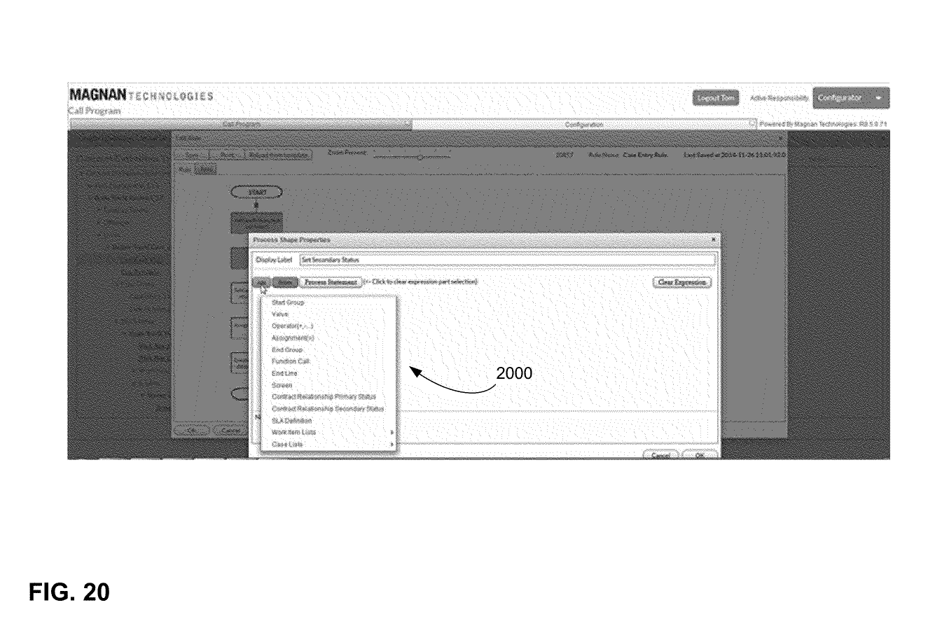

FIG. 20 shows an illustrative menu 2000 of routines that may be made available to an application designer, in accordance with some embodiments. One or more of these routines may be pre-defined and stored in one or more libraries managed by a configuration system. Alternatively, or additionally, one or more routines may be custom defined by an application designer and/or added to one or more libraries for future use (with or without modification).

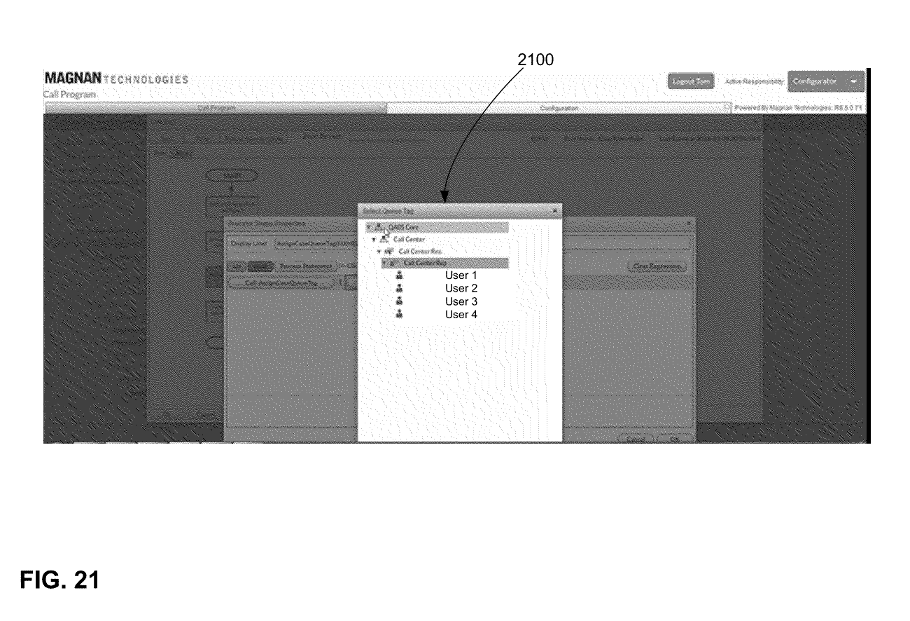

As discussed above in connection with FIG. 18, a case entry rule may, in some embodiments, include a processing step to add the new case to a case queue. FIG. 21 shows an illustrative menu 2100 for use by an application designer to configure access rights for a case in a case queue, in accordance with some embodiments. The menu 2100 may allow an application designer to drill down from a higher level to a lower level in an organizational hierarchy. For instance, in the example shown in FIG. 21, an application designer may start from the entire organization, then drill down to a particular division within the organization, then to a particular department within the division, and then to one or more individuals within the department. The further the application designer drills down, the more access restrictions may be placed on a case. As one example, if the application designer stays at the organization level, then everyone in the organization may have access to the case. As another example, if the application designer drills down to a particular division, then only those individuals in that division may have access to the case, and likewise at the department and individual levels.

It should be appreciated that the organizational hierarchy example shown in FIG. 21 is provided solely for illustrative purposes, as aspects of the present disclosure are not limited to the use of any particular form of access hierarchy, or any access hierarchy at all. In some embodiments, a permission list may be used instead of, or in addition to, an access hierarchy. Furthermore, in some embodiments, multiple branches within an access hierarchy may be given permission. For example, permission may be given to one division, as well as a department within a different division. Furthermore, the illustrative menu 2100 may be additionally, or alternatively, used to configure access rights for a work item in a work item queue.

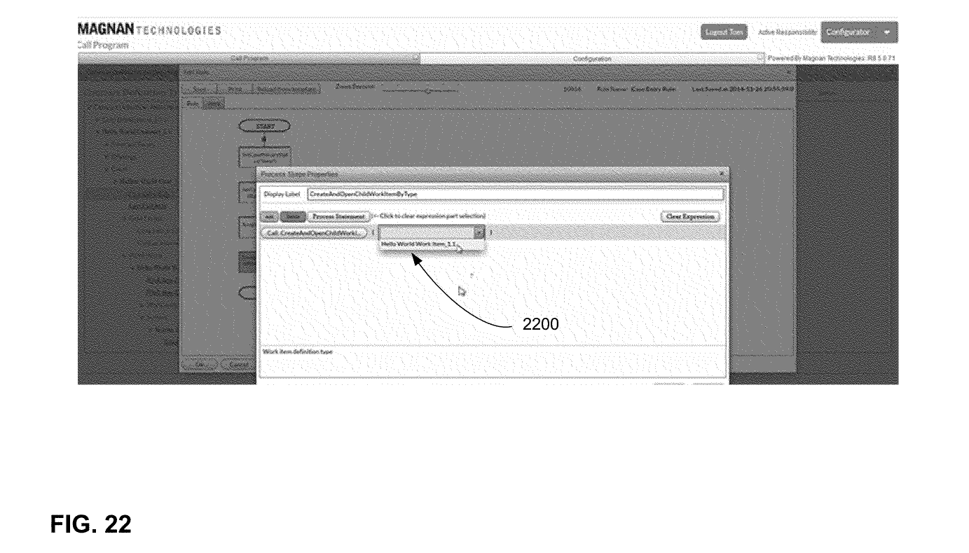

As discussed above in connection with FIG. 18, a case entry rule may, in some embodiments, include a processing step to create a work item. FIG. 22 shows an illustrative menu 2200 for use by an application designer to create a work item, in accordance with some embodiments. The configuration system may populate the menu 2200 with the names of one or more work item definitions that have been added to the relevant case definition. Such a work item definition may be selected from a library of existing work item definitions and/or specified by an application designer (e.g., by defining one or more work item terms, screens, and/or transactions). The application designer may select a work item name from the menu 2200, so that an instance of that work item definition may be created when the case entry rule is executed.

In some embodiments, a configuration system may allow an application designer to insert a program elements into a rule. For instance, in the example shown in FIG. 18, an application designer may click on a connector (e.g., connector 1830) to specify where in the rule the program element is to be inserted. This may activate an interface for defining the program element.

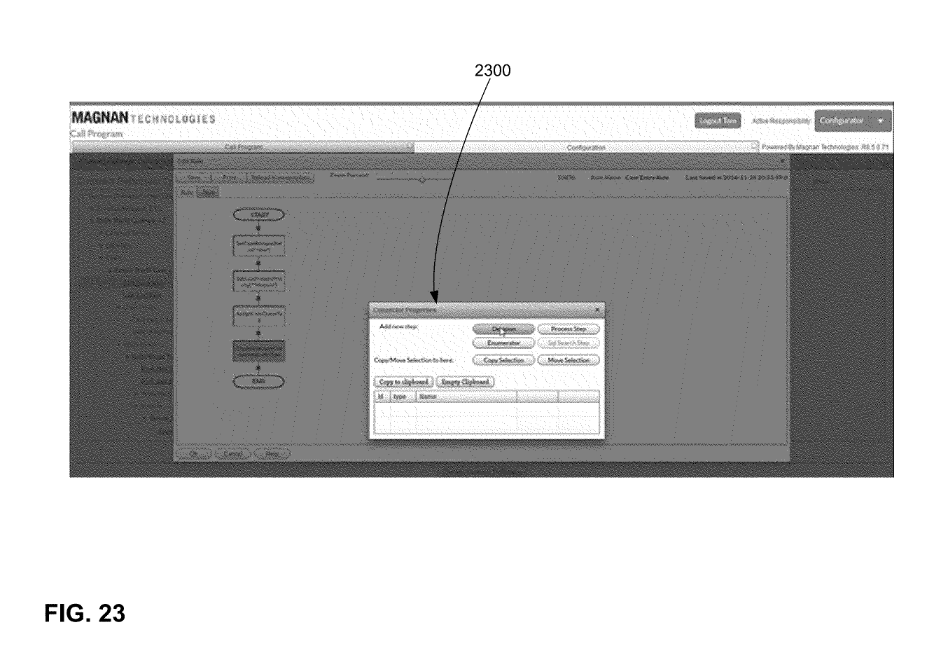

FIG. 23 shows an illustrative interface 2300 for defining a program element, in accordance with some embodiments. The interface 2300 may allow an application designer to select a type of program element to be inserted. Examples of program element types include, but are not limited to, decisions, process steps, loops, enumerators, and/or search steps.

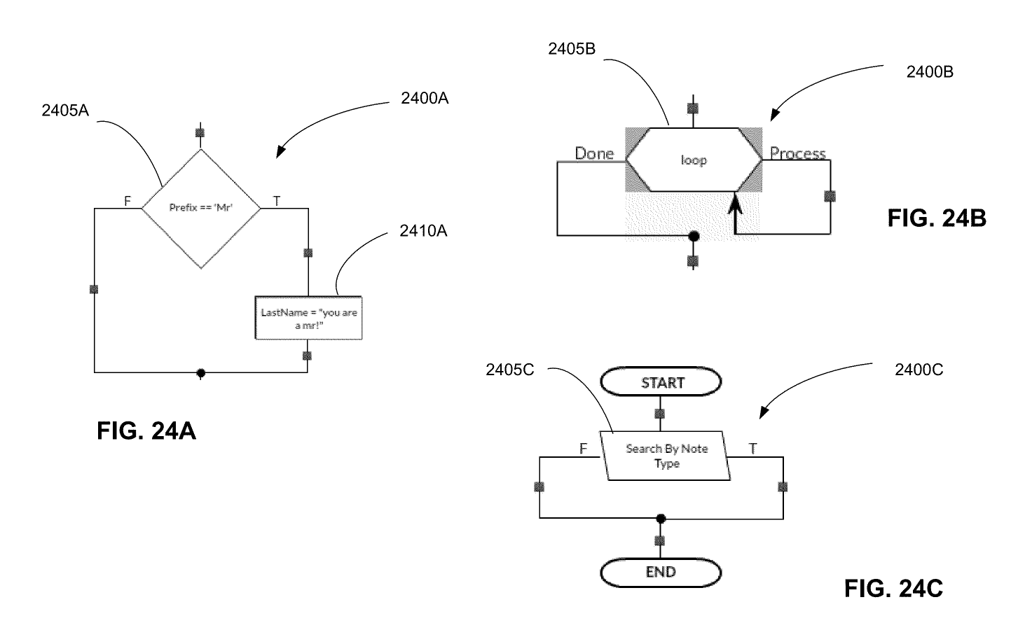

FIG. 24A shows an illustrative program element 2400A, in accordance with some embodiments. In this example, the program element 2400A includes a decision block 2405A having a condition (e.g., as specified by an application designer). If the condition evaluates to True, one or more processing steps on the T branch may be executed (e.g., the step 2410A); otherwise, one or more processing steps on the F branch may be executed. An application designer may specify any number of processing steps for either branch, including no processing step at all. For instance, in the example shown in FIG. 24A, no processing takes place if the condition evaluates to False.

It should be appreciated that the decision block 2405A and the processing step 2410A may be specified using any suitable combination of logical and/or arithmetic expressions (e.g., equality, inequality, addition, multiplication, etc.). Furthermore, in some embodiments, the condition in the block 2405A may be a combination of multiple constituent conditions using one or more logic operators (e.g., AND, OR, NOT, XOR, etc.). If multiple logic operators are used, the operators may be nested in any suitable fashion. Furthermore, the condition may evaluate to one of more than two values, and an application designer may specify more than two processing branches corresponding to the more than two possible values.

FIG. 24B shows an illustrative program element 2400B, in accordance with some embodiments. In this example, the program element 2400B includes a block 2405B having a looping condition. If the looping condition evaluates to True, one or more processing steps on the Process branch may be executed; otherwise, the loop may be exited. An application designer may specify any number of processing steps for the process branch, including no processing step at all. Furthermore, as with the condition in the block 2405A, the looping condition may be a combination of multiple conditions, with or without nested operators.

In some embodiments, a program element referred to as an enumerator may be provided to allow an application designer to compose rules that traverse complex structures to support calculations or searches. Rather than explicitly defining a loop (e.g., by specifying a complex looping condition), the application designer may simply specify one or more structures to be traversed. For example, an enumerator may be used to define a rule for renewing multiple auto insurance policies, where each policy may have any number of vehicles and any number of drivers. The enumerator may allow the rule to start at a first policy and traverse each auto and driver on the first policy to generate a premium. This may be repeated for every policy in an active policy database (e.g., on an annual basis).

FIG. 24C shows an illustrative program element 2400C, in accordance with some embodiments. In this example, the program element 2400C includes a block 2405C having search condition. The search condition may be used to search for matches in one or more database tables (e.g., a contract term, offering term, case term, work item term, etc.). For example, in some embodiments, the condition may be used in the WHERE clause of an SQL (Structured Query Language) statement to identify one or more rows in a database table that match the search condition. However, it should be appreciated that aspects of the present disclosure are not limited to the use of SQL, as another database language may also be suitable.

In some embodiments, if one or more matches are found at the block 2405C, one or more processing steps on the T branch may be executed (e.g., on some or all of the matches); otherwise, one or more processing steps on the F branch may be executed (e.g., to present a message to an application user that no match has been found). An application designer may specify any number of processing steps for either branch, including no processing step at all.

Although various types of program elements are shown in the figures and discussed herein, it should be appreciated that aspects of the present disclosure are not limited to the use of any particular program element type or combination of program element types. For instance, the inventors have recognized and appreciated that using program elements that each have a single entry and a single exit may simplify the generation of software code that implements a flowchart drawn by an application designer. However, aspects of the present disclosure are not limited to the use of such program elements.

Furthermore, it should be appreciated that any suitable combination of one or more of the techniques described herein may be used to build any rule within a process structure (e.g., the process structure 220 shown in FIG. 2), such as a case entry rule, case exit rule, work item entry rule, work item exit rule, screen entry rule, screen exit rule, transaction entry rule, transaction exit rule, etc. For example, any suitable combination of one or more of the techniques described herein may be used to specify one or more of the following types of logic.
Case entry:
   Pre Case Processing Contract Data manipulation
   Pre Case Processing Process Data manipulation
   Pre Case Processing orchestration logic
   Pre Case Processing flow exception logic
   Pre Work Item Processing flow exception logic
Case exit:
   Post Case Processing Contract Data manipulation
   Post Case Processing Process Data manipulation
   Post Case Processing orchestration logic
   Post Case Processing flow exception logic
   Post Work Item Processing flow exception logic
Work item entry
   Pre Work item Processing Contract Data manipulation
   Pre Work item Processing Process Data manipulation
   Pre Work item Processing orchestration logic
   Pre Screen Processing flow exception logic
   Pre Transaction Processing flow exception logic
Work item exit
   Post work item Processing Contract Data manipulation
   Post work item Processing Process Data manipulation
   Post work item Processing orchestration logic
   Post Screen Processing flow exception logic
   Post Transaction Processing flow exception logic
Screen entry
   Pre screen Processing Contract Data manipulation
   Pre screen Processing Process Data manipulation
   Pre screen Processing orchestration logic
   Pre screen Processing flow exception logic
   Pre Transaction Processing flow exception logic
Screen exit
   Post screen Processing Contract Data manipulation
   Post screen Processing Process Data manipulation
   Post screen Processing orchestration logic
   Post Screen Processing flow exception logic
   Post Transaction Processing flow exception logic
Transaction
   Transaction Processing Contract Data manipulation
   Transaction Processing Process Data manipulation
   Transaction Processing orchestration logic
   Transaction Processing flow exception logic
   Transaction Processing flow exception logic

It should be appreciated that the various types of logic listed above are provided solely for purposes of illustration, as aspects of the present disclosure do not require the implementation of any particular type of logic or combination of types of logic.

Furthermore, aspects of the present disclosure are not limited to the execution of logic upon entry or exit of a case, work item, or screen, as logic may be executed in any suitable situation. Any suitable logic may be defined by an application designer and executed at any point during execution of a case, work item, screen, or transaction. As one example, when an application user clicks on a multiple occurring term (MOT), a detail screen rule may be executed to bring up an interface that shows details of the multiple occurring term. As another example, when the application user clicks on a row in the multiple occurring term, an MOT select rule may be executed to perform certain processing defined by the application designer on the data in the selected row. As another example, when the application user clicks on a search button, a search term rule may be executed to bring up an interface for entering one or more search conditions and conduct a search based on the one or more search conditions. As another example, when the application user clicks on a search result, a search term select rule may be executed to perform certain processing defined by the application designer on the selected search result. As another example, a join result term select rule may be executed to allow the application user to join two database tables, for example, by matching one or more entries in a first database table (e.g., worst driver listed in an auto insurance policy) to one or more entries in a second database table (e.g., most expensive vehicle covered by the auto insurance policy). As another example, a contract relationship term join rule may be executed to allow the application user to define a relationship between contracts, offerings, cases, work items, etc.

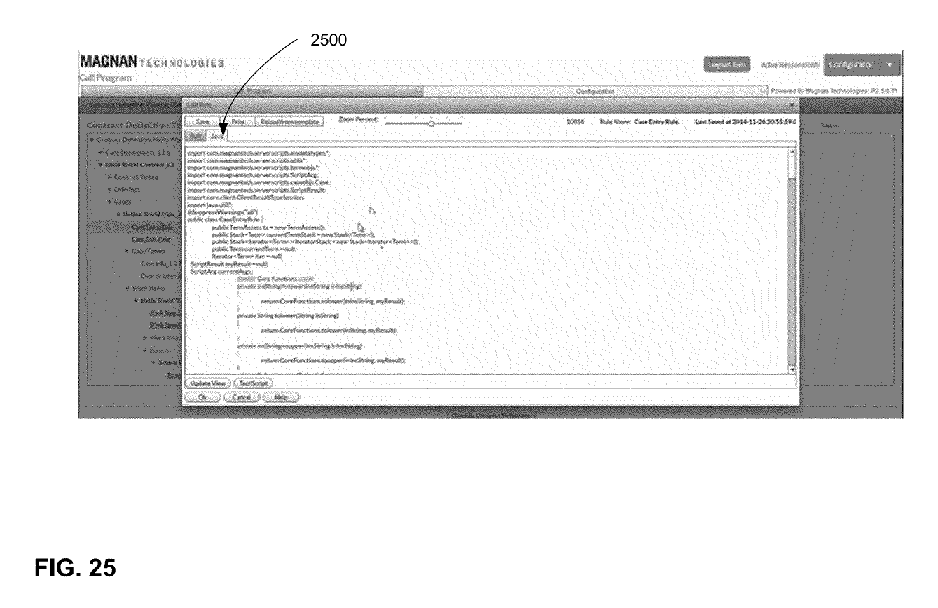

FIG. 25 shows an illustrative display 2500 of software code that may be generated by a configuration system based on a rule defined by an application designer (e.g., in the form of a flowchart such as the flowchart shown in FIG. 18), in accordance with some embodiments. For example, the configuration system may include a code template for each program element type and may be programmed to instantiate the code template into a code snippet for a program element based on one or more parameters provided by the application designer when defining the program element. The configuration system may further be programmed to assemble the code snippets into larger code modules based on the connections among the program elements as specified by the application designer.

In some embodiments, the configuration system may be programmed to traverse the process structure 220 shown in FIG. 2. For each case, work item, screen, and/or transaction defined by the application designer, the configuration system may generate software code for the respective entry and/or exit rules. Additionally, the configuration system may generate software code for any lose focus and/or other rules that the application designer has defined (e.g., Lose Focus & Other Rules 4.7 shown in FIG. 2). The traversal may be performed in any suitable manner, including, but not limited to, pre-order, in-order, post-order, level-order, etc.

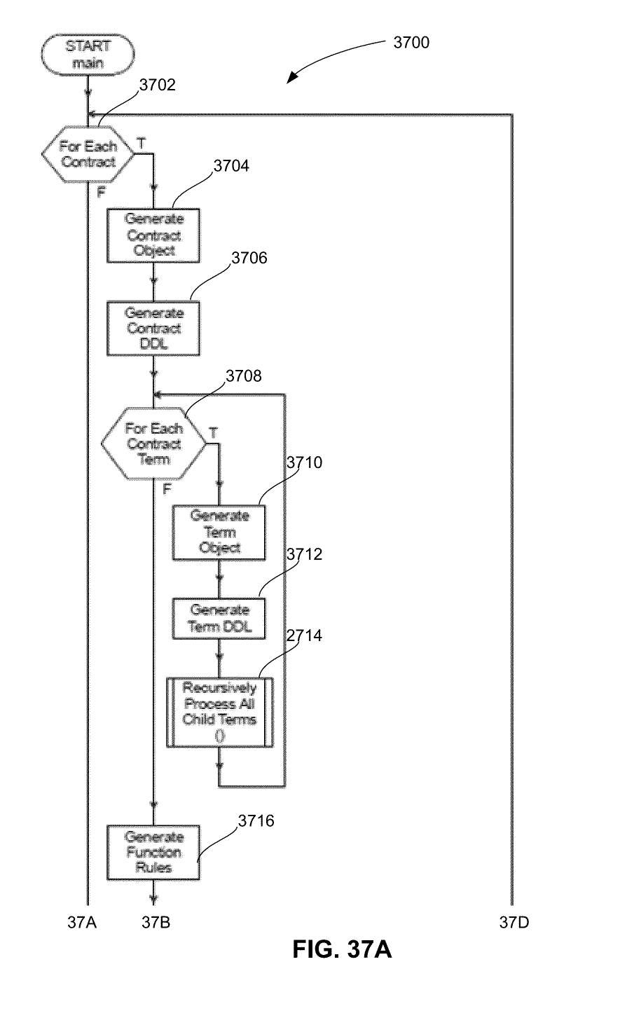

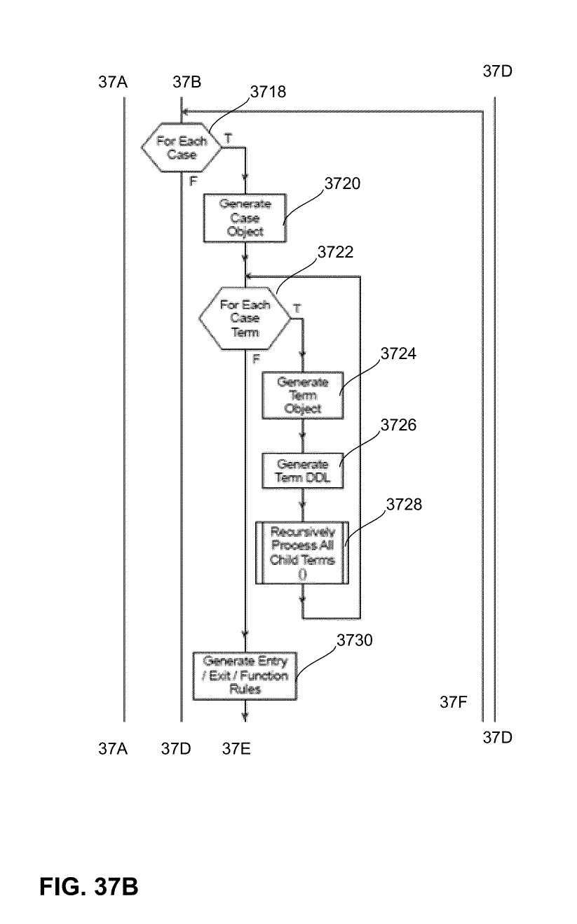

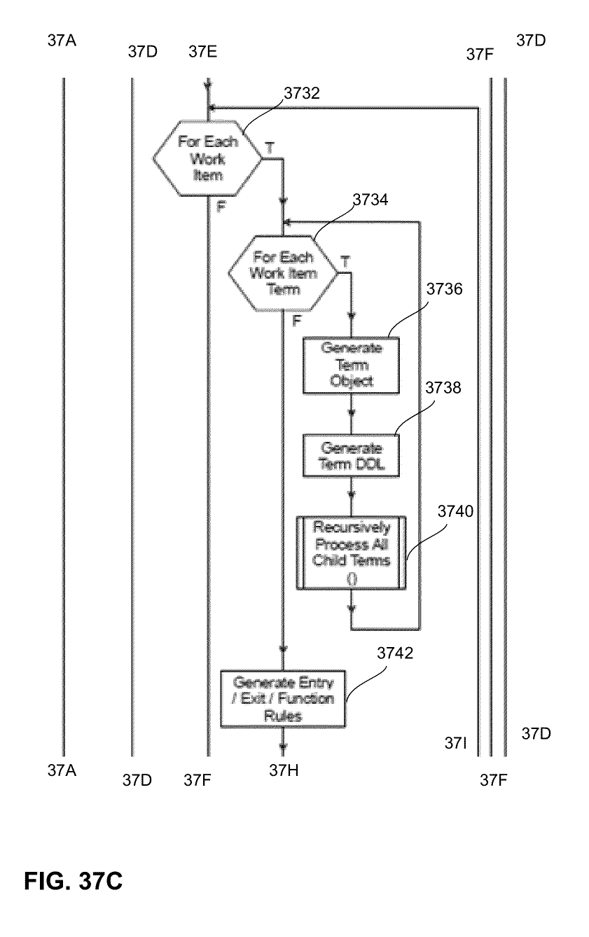

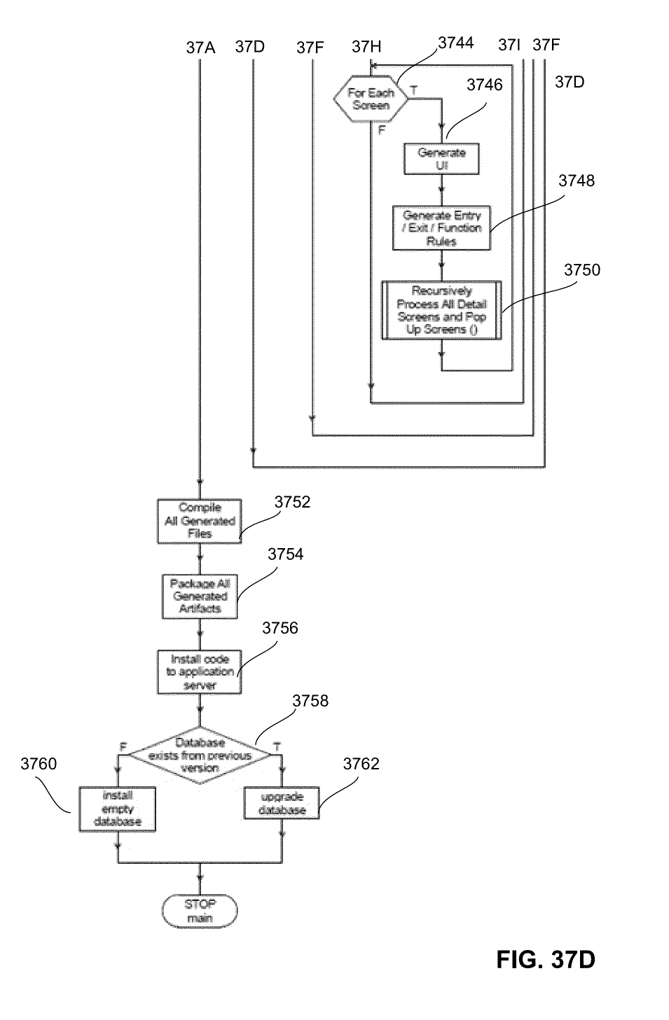

FIGS. 37A-D together show an illustrative process 3700 that may be performed by a configuration system, in accordance with some embodiments. For instance, the process 3700 may be performed by the illustrative configuration system 100 to generate the illustrative application software code 106, as shown in FIG. 1.

In some embodiments, the configuration system may load into memory a hierarchical structure defined by an application designer, for example, recursively based on the illustrative organizational arrangement data structure 210 and process data structure 220 shown in FIG. 2. The configuration system may traverse this structure from the top down and process the contract, offering, case, work item, screen, and/or transaction definitions encountered during the traversal. One or more artifacts may be generated as a result of processing these definitions.

At act 3702, the configuration system may determine if there is a contract definition to be processed. If it is determined that there is a contract definition to be processed, the configuration system may proceed to act 3704 to generate a contract object for that contract definition. In some embodiments, the contract object may be an object model in an object oriented programming language (e.g., Java, C++, etc.).

At act 3706, the configuration system may generate one or more data definition language (DDL) statements for defining, based on the contract definition, one or more data tables in a relational database. In some embodiments, the configuration system may generate a persistence layer to store in the relational database the object model generated at act 3704.

At act 3708, the configuration system may determine if there is a contract term definition to be processed. If it is determined that there is a contract term definition to be processed, the configuration system may proceed to act 3710 to generate a contract term object for that contract term definition. In some embodiments, the contract term object may be an object model in an object oriented programming language (e.g., Java, C++, etc.).

At act 3712, the configuration system may generate one or more DDL statements for defining, based on the contract term definition, one or more data tables in a relational database. In some embodiments, the configuration system may generate a persistence layer to store in the relational database the object model generated at act 3710.

At act 3714, the configuration system may recursively process any descendant terms, Then the configuration system may return to act 3708 to determine if there is another contract term definition in this contract definition. If it is determined that there is no other contract term definition in this contract definition, the configuration system may proceed to act 3716 to generate one or more rules in a suitable programming language,

Proceeding (via 37B) to act 3718 shown in FIG. 38B, the configuration system may determine if there is a case definition to be processed. If it is determined that there is a case definition to be processed, the configuration system may proceed to act 3720 to generate a case object for that case definition. In some embodiments, the case object may be an object model in an object oriented programming language (e.g., Java, C++, etc.).

At act 3722, the configuration system may determine if there is a case term definition to be processed. If it is determined that there is a case term definition to be processed, the configuration system may proceed to act 3724 to generate a case term object for that case term definition. In some embodiments, the case term object may be an object model in an object oriented programming language (e.g., Java, C++, etc.).

At act 3726, the configuration system may generate one or more DDL statements for defining, based on the case term definition, one or more data tables in a relational database. In some embodiments, the configuration system may generate a persistence layer to store the object model generated at act 3720 and/or the object model generated at act 3724 in the relational database.

At act 3728, the configuration system may recursively process any descendant terms, Then the configuration system may return to act 3722 to determine if there is another case term definition in this case definition. If it is determined that there is no other case term definition in this case definition, the configuration system may proceed to act 3730 to generate, for one or more entry, exit, and/or function rules, software code in a suitable programming language,

Proceeding (via 37E) to act 3732 shown in FIG. 38C, the configuration system may determine if there is a work item definition to be processed. If it is determined that there is a work item definition to be processed, the configuration system may proceed to act 3734 to determine if there is a work item term definition to be processed. If it is determined that there is a work item term definition to be processed, the configuration system may proceed to act 3736 to generate a work item term object for that work item term definition. In some embodiments, the work item term object may be an object model in an object oriented programming language (e.g., Java, C++, etc.).

At act 3738, the configuration system may generate one or more DDL statements for defining, based on the work item term definition, one or more data tables in a relational database. In some embodiments, the configuration system may generate a persistence layer to store the object model generated at act 3736 in the relational database.

At act 3740, the configuration system may recursively process any descendant terms, Then the configuration system may return to act 3734 to determine if there is another work item term definition in this work item definition. If it is determined that there is no other work item term definition in this work item definition, the configuration system may proceed to act 3742 to generate, for one or more entry, exit, and/or function rules, software code in a suitable programming language,

Proceeding (via 37H) to act 3744 shown in FIG. 38D, the configuration system may determine if there is a screen definition to be processed. If it is determined that there is a screen screen definition to be processed, the configuration system may proceed to act 3746 to generate, based on the screen definition, software code for a runtime user interface. At act 3748, the configuration system may generate, for one or more entry, exit, and/or function rules, software code in a suitable programming language. At act 3750, the configuration system may recursively process any descendant screens, Then the configuration system may return to act 3744 to determine if there is another screen definition in this work item definition. If it is determined that there is no other screen definition in this work item definition, the configuration system may return (via 37I) to act 3732 to determine if there is another work item definition to be processed.

If it is determined at act 3732 that there is no other work item definition in this case definition, the configurations system may return (via 37F) to act 3718 to determine if there is another case definition to be processed. If it is determined at act 3718 that there is no other case definition in this contract definition, the configurations system may return (via 37D) to act 3702 to determine if there is another contract definition to be processed.

If it is determined at act 3702 that there is no other contract definition in this structure, the configurations system may proceed (via 37A) to act 3752 to compile all generated files (e.g., from source code to object code in an assembly language or a machine language). At act 3754, the configuration system may package all artifacts generated at act 3752. At act 3756, the configuration system may install the packaged code to an application server.

At act 3758, the configuration system may determine if a database already exists from a previous version of a runtime system. If so, the configuration system may proceed to act 3762 to upgrade the existing database based on the new installation. Otherwise, the configuration system may proceed to act 3760 to install an empty database.

It should be appreciated that the process 3700 shown in FIGS. 37A-D and described above are provided solely for purposes of illustration, as aspects of the present disclosure are not limited to any particular way of traversing the illustrative organizational arrangement data structure 210 and process data structure 220 shown in FIG. 2. For example, in some embodiments, an interpreted programming language may be used, and act 3752 may be omitted.

In some embodiments, the configuration system may be programmed to organize the generated software code into one or more libraries based on the process structure 220 shown in FIG. 2. For instance, the generated software code may be organized into a hierarchy that corresponds to the process structure 220 (e.g., by case, work item, screen, transaction, etc.). However, it should be appreciated that aspects of the present disclosure are not limited to any particular manner for organizing generated software code.

In some embodiments, a location at which a rule is defined in the process structure 220 may determine the scope of data that is available to the rule. As one example, all rules may have access to data in any contract or offering term. As another example, a rule associated with a case may have access to data in any case term for that case, but may not have access to data in a case term for another case. Similarly, a rule associated with a work item may have access to data in any work item term for that work item, but may not have access to data in a work item term for another work item. However, it should be appreciated that aspects of the present disclosure are not limited to any particular type of data access restriction, nor to the use of any data access restriction at all. For example, in some embodiments, all data may be made available to all rules.

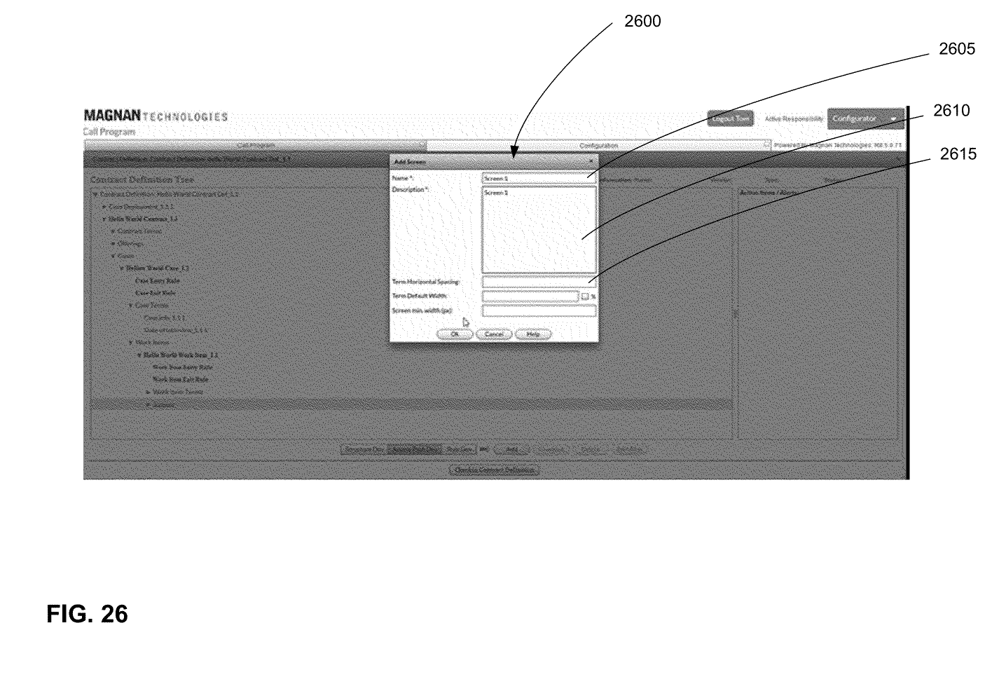

FIG. 26 shows an illustrative display 2600 that may be used to prompt an application designer to provide information regarding a new screen definition, in accordance with some embodiments. For example, the display 2600 may include prompts 2605 and 2610 to prompt the application designer to enter a name and description for the new contract definition, respectively. In some embodiments, the display 2600 may additionally include one or more prompts 2615 to prompt the application designer to provide information regarding the layout of the screen.

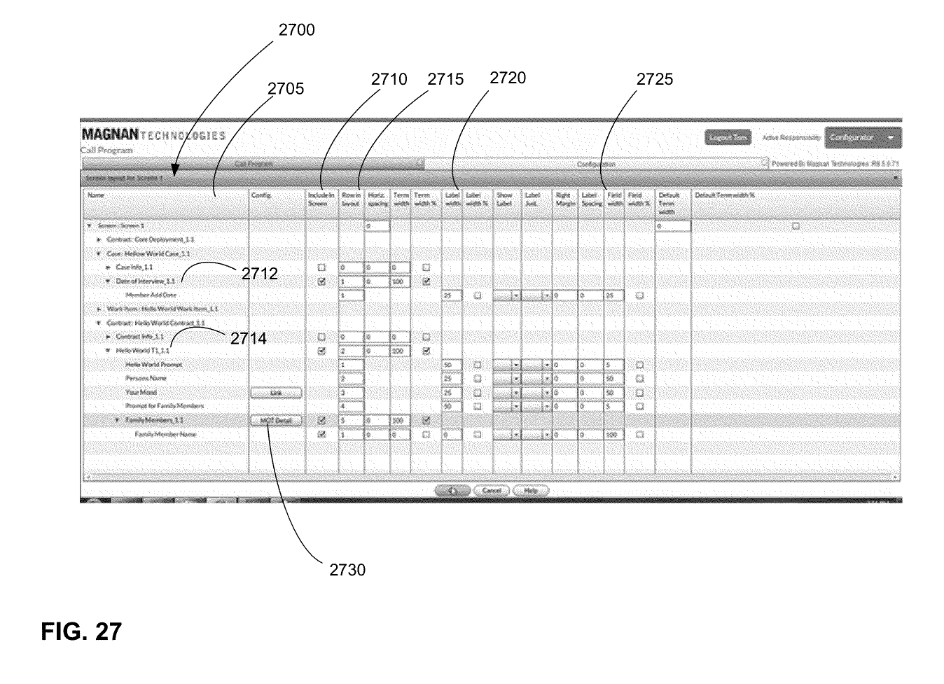

FIG. 27 shows an illustrative interface 2700 that may be used by an application designer to configure the visual layout of a particular screen, in accordance with some embodiments. In this example, the interface 2700 includes a column 2705 that allows the application designer to drill down to various levels in a contract definition to view what has been defined (e.g., contract terms, offering terms, case terms, work item terms, attributes, rules, etc.). In some embodiments, the interface 2700 may include a column 2710 to allow the application designer to indicate what should be included in the particular screen (e.g., by clicking on one or more corresponding checkboxes) and/or a column 2715 to allow the application designer to indicate on which row of the particular screen a selected item should appear. Additionally, or alternatively, the interface 2700 may include columns 2720 and 2725 to allow the application designer to indicate, respectively, the widths of a label and a field for each prompt to be presented to an application user.

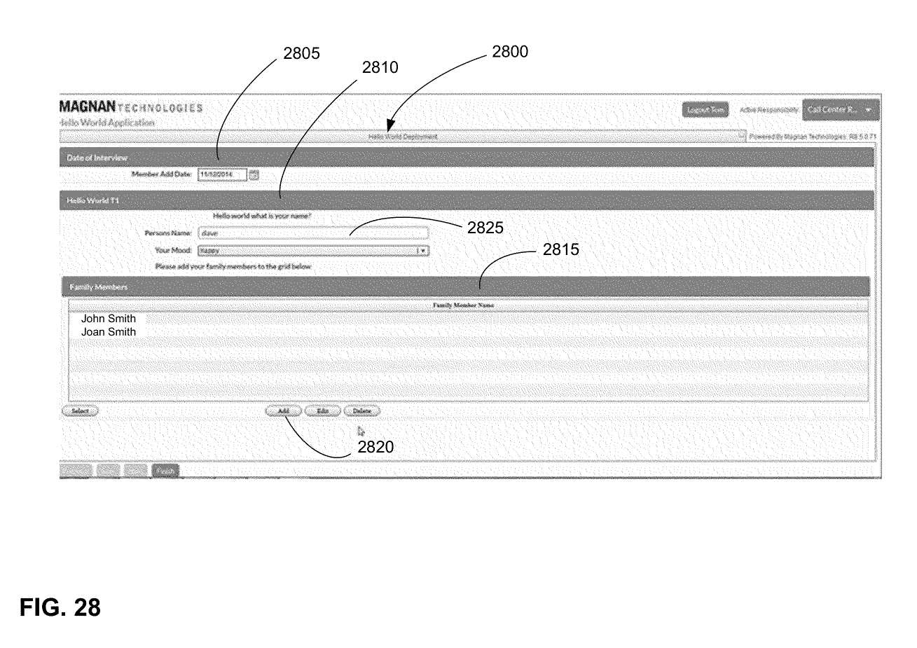

In some embodiments, one or more rows may be organized hierarchically. For instance, in the example of FIG. 27, there are two top-level rows (e.g., Date of Interview 2712 and Hello World 2714), where each top-level row may have one or more second-level rows thereunder (e.g., five second-level rows under the Hello World row). Such a hierarchical arrangement can have any suitable number of levels. Moreover, as shown in FIG. 28, a row may be indented according to the level at which the row is located, for example, to provide a visual cue to an application user as to the logical organization of the screen. However, it should be appreciated that aspects of the present disclosure are not limited to the use of hierarchically organized rows.

FIG. 28 shows an illustrative screen 2800 that may be presented to an application user by a user interface of a runtime system, in accordance with some embodiments. For instance, the screen 2800 may be presented to the application user 152 by the user interface 156 of the runtime system 150 shown in FIG. 2. In some embodiments, the screen 2800 may be configured using the illustrative interface 2700 shown in FIG. 27. The configuration may be performed by an application designer in an iterative fashion. For example, the application designer may enter one set of configuration parameters, view the resulting screen, and then adjust the configuration parameters. This may be repeated until the application designer is satisfied with the look-and-feel of the screen.

In the example shown in FIG. 28, the screen 2800 includes a Date of Interview row 2805, under which a Member Add Date field is provided to prompt an application user to enter a date. The screen 2800 may also include a Hello World row 2810, under which the application user is prompted to enter a name and/or select a mood (e.g., from a drop down menu). In some embodiments, possible values for the user's mood may be defined using a valid value list, for example, as discussed above in connection with FIG. 16.

In some embodiments, the screen 2800 may also include a Family Members row 2815, under which a table may be displayed listing one or more names. Because there may be multiple entries, such a table may sometimes be referred to as a “multiple occurring term,” or MOT. Although not shown, a multiple occurring term may, in some embodiments, have multiple columns (e.g., to display the name, gender, age, address, etc. of a family member).

In some embodiments, an application user may add an entry in the multiple occurring term by clicking an Add button 2820, which may activate a separate MOT display that prompts the application user to provide information for the additional entry (e.g., the name of an additional family member). Such a separate display may be configured by clicking on an MOT Detail button 2730 from the interface 2700, which may activate a separate interface for configuring the MOT display. However, it should be appreciated that aspects of the present disclosure are not limited to the use of a separate interface for configuring the MOT display, or to the use of a separate MOT display.

In some embodiments, one or more lose focus rules may be executed by a runtime system as an application user enters data via a screen. For example, an application designer may define a lose focus rule in association with an input (e.g., the text field 2825 shown in FIG. 28). As an application user enters data into the text field, the runtime system may execute the lose focus rule on the data entered (e.g., to check whether the data has an expected format or otherwise comply with one or more requirements). The inventors have recognized and appreciated that such real time feedback may help to identify errors early, when the application user may still have ready access to one or more data sources. For example, the application user may be a call center representative who enters information provided by a customer over the phone, and it may be desirable to identify and correct any error while the call center representative still has the customer on the phone. However, it should be appreciated that aspects of the present disclosure are not limited to the use of lose focus rules or any real time feedback.

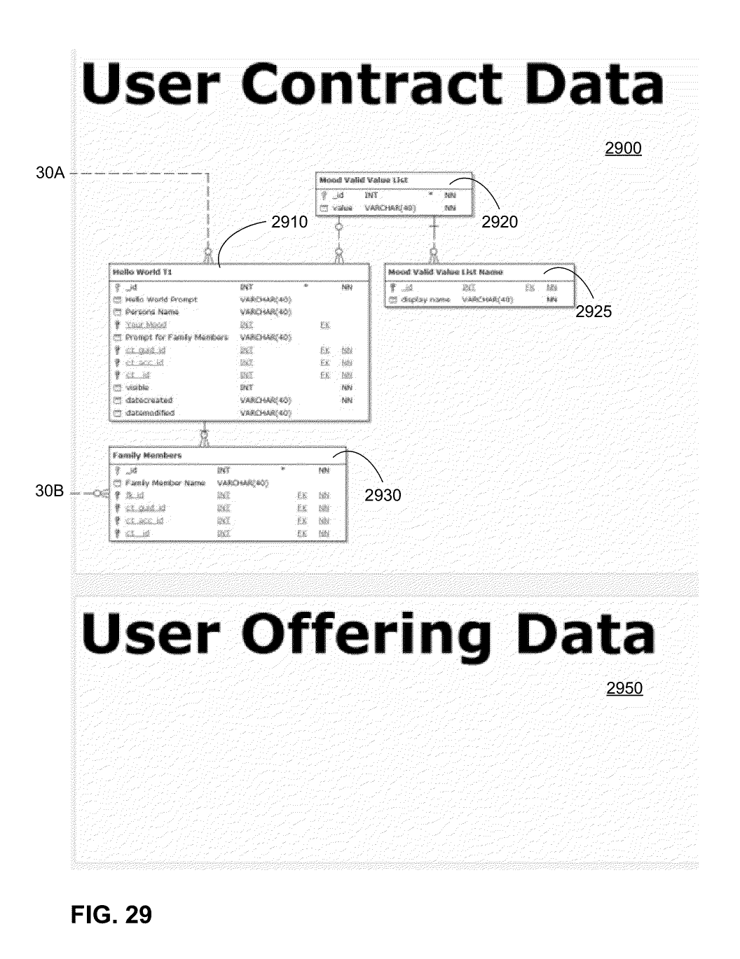

FIGS. 29-32 together show an illustrative database schema, in accordance with some embodiments. For instance, the illustrative database schema may represent database tables generated by the database generation component 114 of the configuration system 100 and/or accessed by the data processing component 158 of the runtime system 150, as shown in FIG. 2.

In the example shown in FIG. 29, the illustrative database schema includes two areas, user contract area 2900 and user offering area 2950. The user contract area 2900 may include one or more contract terms defined by an application designer (e.g., C Term 2.2 shown in FIG. 2). Although not shown in FIG. 29, the user offering area 2950 may include one or more offering terms (e.g., O Term 2.5 shown in FIG. 2), which may be similarly structured as the one or more contract terms in the user contract area 2900.

In the example shown in FIG. 29, the user contract area 2900 includes a contract term 2910 having one or more attributes defined by an application designer (e.g., Hello World Prompt, Person's Name, etc.) and/or one or more attributes added by a configuration system (e.g., visible, date created, date modified, etc.). The contract term 2910 may also include one or more keys, one of which may be designated as a primary key. In some embodiments, the primary key may be generated by the configuration system, as opposed to being generated by a database management system (DBMS) used by the configuration system. In this manner, key generation may be performed consistently even if a different DBMS is used. The inventors have further recognized and appreciated that the configuration system may manage primary key generation to provide more fine grained control of data migration and/or data purging over time. In some embodiments, an AMS may be implemented in conformance with a database query language standard (e.g., an SQL-92 standard), or one or more portions thereof. The inventors have recognized and appreciated that relational database management systems provided by different vendors may have strengths and weaknesses based on cost and performance. Therefore, it may be desirable to limit exposure to vendor-specific features to ease any potential migration in the future. Moreover, the inventors have recognized and appreciated that, in some embodiments, an AMS may advantageously allow applications to be designed to support multi-tenancy. In such an embodiment, an application-controlled primary key scheme may improve data security across different customers in the same database.

However, it should be appreciated that aspects of the present disclosure are not limited to the generation of primary keys by the configuration system, as primary keys may be obtained in other ways. For example, primary keys may be generated by a DBMS, or natural keys (e.g., name and/or address of a person) may be used as primary keys.

In some embodiments, the contract term 2910 may include one or more foreign keys, which may be primary keys of one or more other database tables. For example, the contract term 2910 may include a foreign key, Your Mood, which may be a primary key of a table 2920. The table 2920 may be generated by the configuration system based on a valid value list created by the application designer. For example, the table 2920 may include a value attribute for storing one or more values defined by the application designer (e.g., Happy, Sad, etc.). In some embodiments, another table 2925 may be generated by the configuration system and linked to the table 2920. The table 2925 may have a name attribute for storing one or more display names corresponding respectively to the values in the table 2920. The inventors have recognized and appreciated various advantages of storing values and display names separately. As one example, in some embodiments, a valid value list may be used to store available options (e.g., a list of states or countries) for an application user's selection. Each option may be associated with display text in different languages (e.g., the English, Spanish, and Chinese names for the same state or country). The inventors have recognized and appreciated that externalizing display text from the values may facilitate preservation of integrity in the database. As another example, the inventors have recognized and appreciated that improved performance may be obtained by using an integer-based value as an underlying key, as opposed to using a text-based value. For instance, more efficient indexing strategies may be available for integer-based values. As another example, in some embodiments, a valid value list may be defined based on a large data set (e.g., medical procedure codes, medical billing codes, part numbers, etc.). In such an embodiment, externalizing display text from the values may allow an impact analysis process to determine which rules leverage which specific values. However, it should be appreciated that aspects of the present disclosure are not limited to the use of two separate tables for storing the values and display names of a valid value list, as in some embodiments the value and display name attributes may be stored in the same table.

In some embodiments, the user contract area 2900 may include multiple contract terms. For example, as shown in FIG. 29, the user contract area 2900 further includes a contract term 2930, which may be generated by the configuration system based on a multiple occurring term defined by the application designer. For example, the contract term 2930 may include a family member name attribute for storing the names of one or more family members of a person who appears in the contract term 2910. Thus, an entry in the contract term 2930 may point back to an entry in the contract term 2910.

The inventors have recognized and appreciated that creating a separate table for a multiple occurring term may reduce duplication of data. For example, John Smith may be the spouse of Joan Smith and a son of Jack Smith. Rather than storing John's name twice, once as the spouse of Joan and once as the son of Jack, John's name may be stored only once in a separate table. However, it should be appreciated that aspects of the present disclosure are not limited the use of a separate table for a multiple occurring term, as in some embodiments a single table may be used. For example, the rows in the contract term 2910 may be duplicated so that there is one row for each family member.

In some embodiments, the contract terms 2910 and/or 2930 may be linked to one or more other tables, such as a table generated by the configuration system for keeping track of organizational arrangement data. For example, the contract terms 2910 and 2930 may be linked to a contract container table via the links 30A and 30B, respectively.

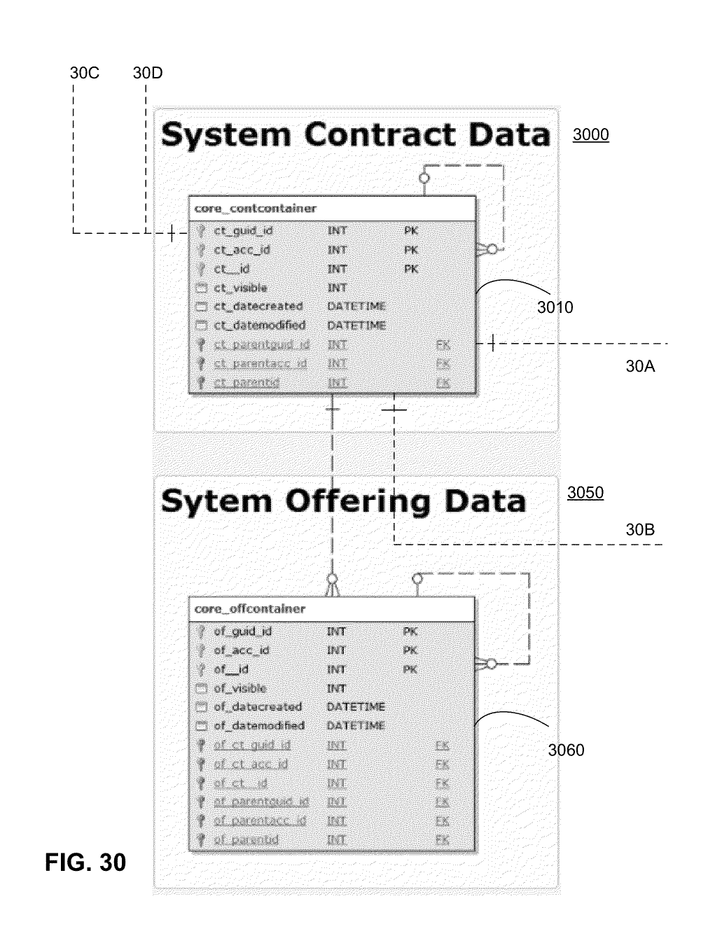

FIG. 30 shows a system contract area 3000 and a system offering area 3050 of the illustrative database schema, in accordance with some embodiments. The system contract area 3000 may include a contract container table 3010, to which the contract terms 2910 and 2930 may be linked. For example, an entry in the contract container table 3010 may correspond to a contract according to a contract definition specified by the application designer, and an entry in the contract term 2910 or 2930 may point back to an entry in the contract container table 3010.

As discussed above in connection with FIG. 2, a contract may, in some embodiments, include one or more sub-contracts. Accordingly, an entry in the contract container table 3010 (e.g., a child contract) may point to another entry the contract container table 3010 (e.g., a parent contract). However, it should be appreciated that aspects of the present disclosure are not limited to the use of sub-contracts.

In some embodiments, the system offering area 3050 may include an offering container table 3060, which may be linked to the contract container table 3010. For example, an entry in the offering container table 3060 may correspond to an offering according to an offering definition specified by the application designer, and may point back to the contract to which the offering belongs. Moreover, although not shown in FIG. 30, an offering term may exist in the user offering area 2950, and an entry in the offering term may point back to an entry in the offering container table 3060.

As discussed above in connection with FIG. 2, an offering may, in some embodiments, include one or more sub-offerings. For example, a sub-offering of an offering may represent an exception to one or more provisions associated with the offering. Accordingly, an entry in the offering container table 3060 (e.g., a child offering) may point to another entry in the offering container table 3060 (e.g., a parent offering). However, it should be appreciated that aspects of the present disclosure are not limited to the use of sub-offerings to represent exceptions, or to the use of sub-offerings at all.

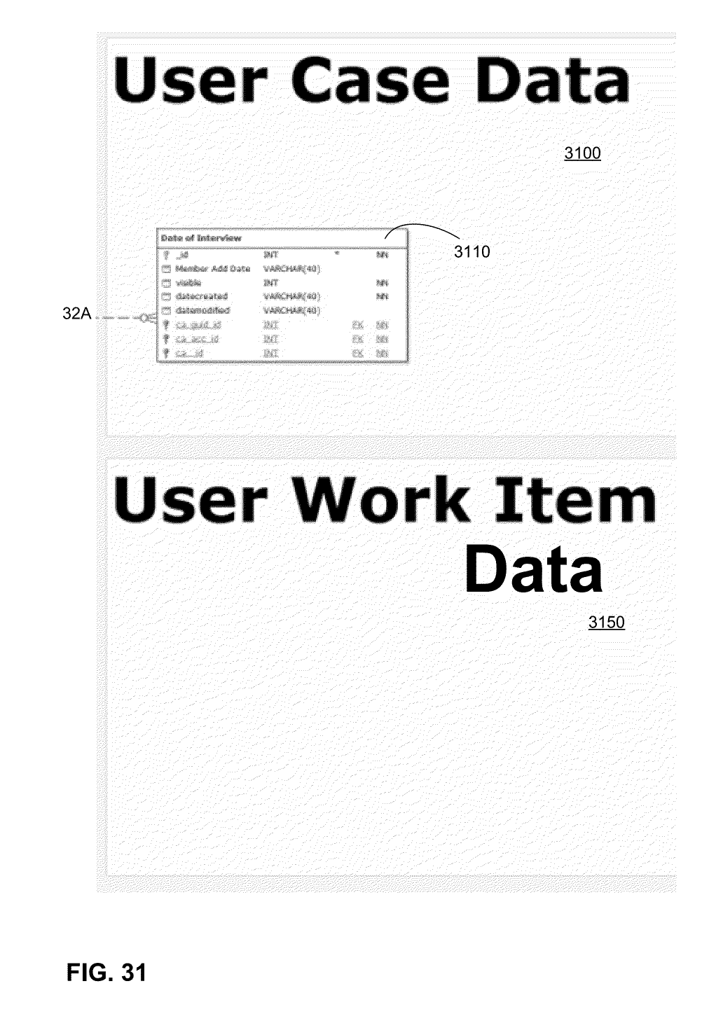

FIG. 31 shows a user case data area 3100 and a user work item data area 3150 of the illustrative database schema, in accordance with some embodiments. In this example, the user case data area 3100 includes a case term 3110 having one or more attributes defined by an application designer (e.g., member add date, etc.) and/or one or more attributes added by a configuration system (e.g., visible, date created, date modified, etc.). The case term 3110 may also include one or more keys, such as a primary key and one or more foreign keys. For example, the case term 3110 may include one or more foreign keys that link the case term 3110 to one or more other tables (e.g., via the link 32A), such as a table generated by the configuration system for keeping track of case data.

Although only one case term is shown in FIG. 31, it should be appreciated that aspects of the present disclosure are not so limited, as multiple case terms may be used. Furthermore, although not shown in FIG. 31, the user work item data area 3150 may include one or more work item terms (e.g., WkIt Term 2.12 shown in FIG. 2), which may be similarly structured as the case term 3110, and may be linked to one or more other tables, such as a table generated by the configuration system for keeping track of work item data.

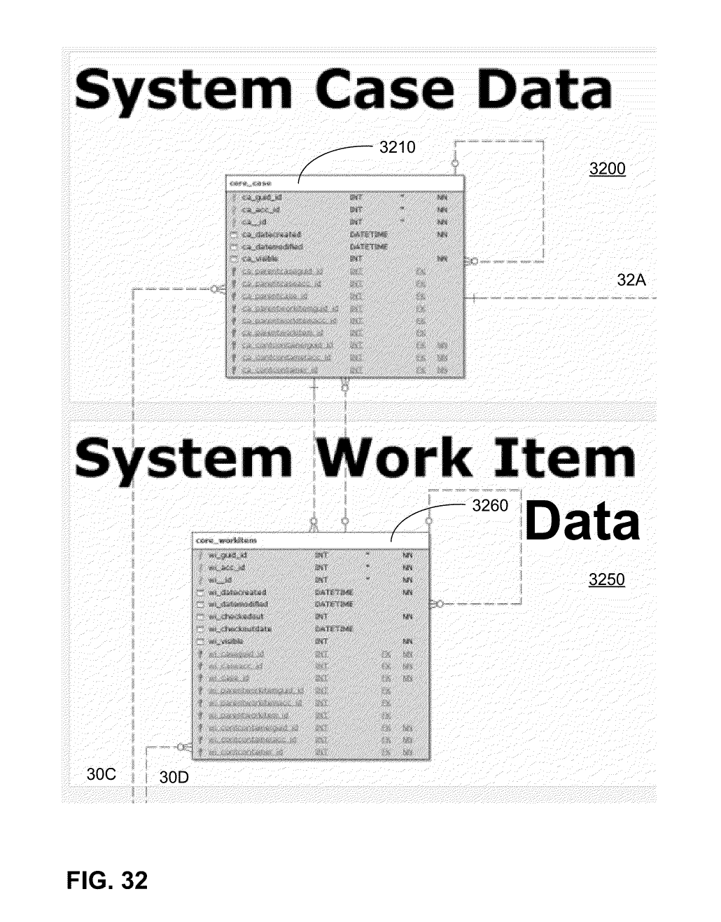

FIG. 32 shows a system case data area 3200 and a system work item data area 3250, in accordance with some embodiments. The system case data area 3200 may include a case table 3210, to which the case term 3110 may be linked. For example, an entry in the case table 3210 may correspond to a case according to a case definition specified by the application designer, and an entry in the case term 3110 may point back to an entry in the case table 3210.

In some embodiments, the system work item area 3250 may include a work item table 3260, which may be linked to the case table 3210. For example, an entry in the work item table 3260 may correspond to a work item according to a work item definition specified by the application designer, and may point back to the case to which the work item belongs. Furthermore, although not shown in FIG. 31, a work item term may exist in the user work item area 3150, and an entry in the work item term may point back to an entry in the work item table 3260. Further still, an entry in the case table 3210 (respectively, the work item table 3260) may point back to an entry in the contract container table 3010, for example, via the link 30C (respectively, 30D).

As discussed above in connection with FIG. 2, a case (respectively, work item) may, in some embodiments, have one or more child cases (respectively, child work items). Accordingly, an entry in the case table 3210 (e.g., a child case) may point to another entry the case table 3210 (e.g., a parent case), and/or an entry in the work item table 3260 (e.g., a child work item) may point to another entry the work item table 3260 (e.g., a parent work item). However, it should be appreciated that aspects of the present disclosure are not limited to the use of child cases or child work items.

It should also be appreciated that the database schema shown in FIGS. 29-32 is merely illustrative, as aspects of the present disclosure are not limited to the use of any particular schema. For example, aspects of the present disclosure are not limited to the use of a multiple occurrence terms or valid value list in connection with a contract term, as one or more multiple occurrence terms and/or valid value lists may alternatively or additionally be used in connection with an offering term, case term, and/or work item term.

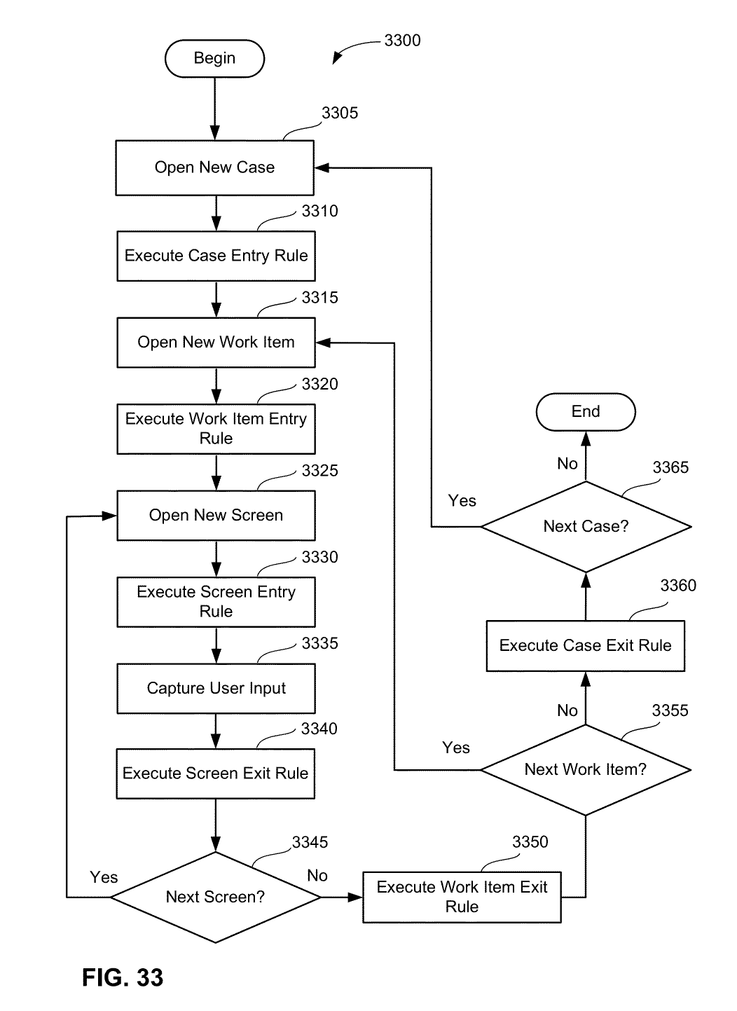

FIG. 33 shows an illustrative process 3300 that may be performed by a runtime system, in accordance with some embodiments. For example, the illustrative process 3300 may be performed by the illustrative runtime system 150 to interact with the application user 152 and/or one or more external sources 154, as shown in FIG. 1.

At act 3305, the runtime system may open a new case, for example, in response to a request received from an application user or external source. In some embodiments, opening a new case may include creating a new entry in a case container table (e.g., the illustrative table 3210 shown in FIG. 32), setting the new entry in the case container table to point to an entry in a contract container table (e.g., the illustrative table 3010 shown in FIG. 30) corresponding to the contract under which the new case is being opened, creating a new entry in a case term (e.g., the illustrative case term 3110 shown in FIG. 31) according to the case definition for the new case, etc. However, it should be appreciated that aspects of the present disclosure are not limited to the execution of these particular steps, as fewer, more, and/or different steps may be executed by the runtime system for opening a new case.

In some embodiments, opening a new case may include creating a new entry in a contract container table, and then setting the new entry in the case container table to point to the new entry in the contract container table. For instance, the new case may be a create case (e.g., based on the illustrative New Business case template 3.4 shown in FIG. 2) via which a new contract may be established. Additionally, or alternatively, a new offering under the contract may be established via the new case. Accordingly, a new entry may be created in an offering container table (e.g., the illustrative table 3060 shown in FIG. 30) and may be set to point the entry in the contract container table. At act 3310, the runtime system may execute one or more case entry rules (e.g., as discussed above in connection with FIGS. 18-25). As a result, the runtime system may, at act 3315, open a new work item that is part of the new case according to the case definition. In some embodiments, opening a new work item may include creating a new entry in a work item container table (e.g., the illustrative table 3260 shown in FIG. 32), setting the new entry in the work item container table to point to the entry in the case container table (e.g., the illustrative table 3210 shown in FIG. 32) corresponding to the new case, setting the new entry in the work item container table to point to the entry in the contract container table (e.g., the illustrative table 3010 shown in FIG. 30) corresponding to the contract under which the new case is being opened, creating a new entry in a work item term according to the work item definition for the new work item, etc. However, it should be appreciated that aspects of the present disclosure are not limited to the execution of these particular steps, as fewer, more, and/or different steps may be executed by the runtime system for opening a new work item.

At act 3320, the runtime system may execute one or more work item entry rules. As a result, the runtime system may, at act 3325, open a new screen that is part of the new work item according to the work item definition. At act 3330, the runtime system may execute one or more screen entry rules, which may cause the new screen to be presented to the application user, for example, to display data and/or prompt the application user to enter data (e.g., as shown in FIG. 28 and discussed above). At act 3335, the runtime system may capture input from the application user via the new screen and may execute one or more rules on the input data (e.g., a lose focus rule to verify whether the input data is valid).

At act 3340, the runtime system may execute one or more screen exit rules, for example, in response to receiving an indication that the application user has finished interacting with the screen. For example, the application user may click a Previous button to return to a previous screen, a Next button to proceed to a next screen, a Save button to postpone working on the screen, or a Finish button to indicate completion of the work item. However, it should be appreciated that aspects of the present disclosure are not limited to the use of these buttons, as fewer, more, and/or different buttons may be used, and/or some other type of indication may be received from the application user.

At act 3345, the runtime system may determine whether another screen is to be presented to the application user. If a next screen is to be presented, the runtime system may return to act 3325 to open the next screen. If no other screen is to be presented, the runtime system may proceed to act 3350 to execute one or more work item exit rules. Then, at act 3355, the runtime system may determine whether another work item is to be executed according to the case definition. For example, in some instances, the completion of a work item (e.g., an auto insurance customer agreeing to be bound by a policy) may trigger the opening of another work item (e.g., issuing the policy to the customer). If a next work item is to be executed, the runtime system may return to act 3315 to open the next work item. If no other work item is to be executed, the runtime system may proceed to act 3360 to execute one or more case exit rules.

Then, at act 3365, the runtime system may determine whether another case is to be executed according to a contract definition of the contract under which the case is opened. If a next case is to be executed, the runtime system may return to act 3305 to open the next case. If no other case is to be executed, the process 3300 may end.

In some embodiments, the runtime system may select the next case, work item, and/or screen dynamically, for example, based on the data entered by the application user and/or any other suitable information, including, but not limited to, data provided by one or more external sources, state of the runtime system, one or more conditions within an environment in which the runtime system is executing, etc.

It should be appreciated that the process 3300 is shown in FIG. 33 and discussed above solely for purposes of illustration, as aspects of the present disclosure are not limited to the execution of any particular steps in any particular order by a runtime system. As one example, one or more transactions may be executed in addition to, or instead of, one or more screens. As another example, although cases and work items are executed in sequence in the example of FIG. 33, aspects of the present disclosure are not so limited. In some embodiments, multiple cases and/or work items may be executed in parallel.

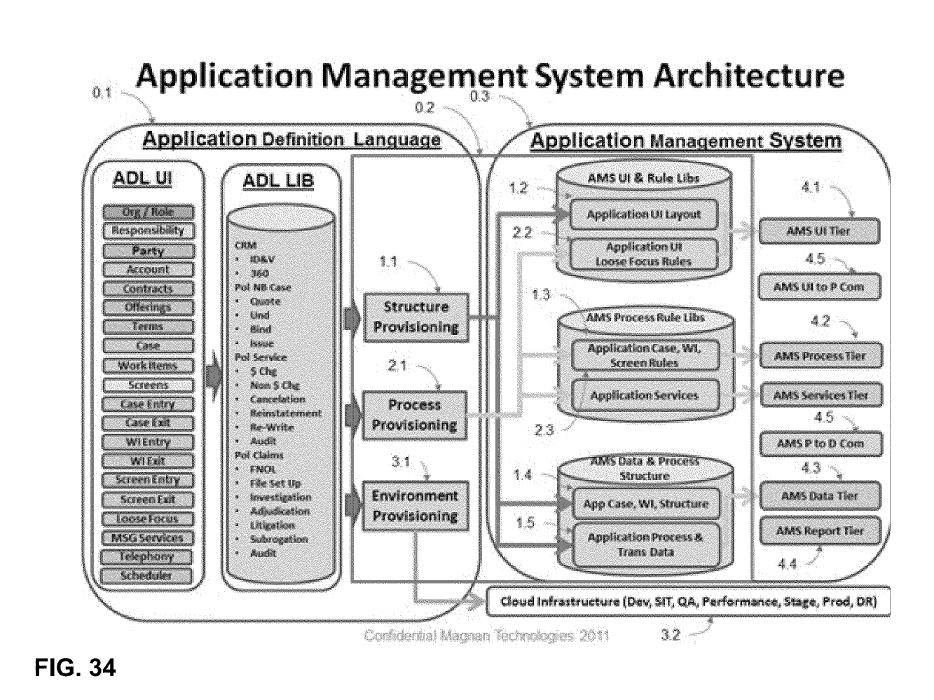

FIG. 34 shows an illustrative architecture 3400 for an application management system (AMS), in accordance with some embodiments. In this example, the architecture 3400 includes a component 0.3 which may implement a common structure shared by many organizational arrangements (e.g., the illustrative fractal structure 200 shown in FIG. 2) and a component 0.1 which may be used to capture contextual information that gives meaning to various elements of the common structure in the context of a particular organization arrangement. The component 0.3 may be referred to as an Application Definitional Language (ADL) component.

In some embodiments, the components 0.1 and 0.3 may be coupled via a system 0.2. For example, the system 0.2 may provision an environment, build an application, and/or deploy the application in the environment. In some embodiments, the system 0.2 may query one or more database tables in the ADL component to build a runtime user interface, process data structures, organizational arrangement data structures, rules, access paths, etc. The database tables and/or software code generated by the system 0.2 may be made available to a runtime system via one or more libraries.

In some embodiments, an AMS may include one or more subject database areas for storing configuration data. Some examples of subject database areas are discussed below. However, it should be appreciated that aspects of the present disclosure is not limited to the use of any particular database area or combination of database areas.

In some embodiments, the AMS may include a system subject database area. The system subject database area may include a primary key index, which may be used by the AMS to manage primary key generation. Additionally, or alternatively, the system subject database area may include a language index to support localization. For example, in some embodiments, all textual data entered by an application designer (e.g., textual prompts, display names of values, etc.) may be associated with a particular language, so that the textual data may be readily replaced by equivalent text in another language.

In some embodiments, the AMS may include an account subject database area. The account subject database area may include one or more database tables for storing account profiles. As discussed above, the AMS may be delivered under a SaaS model, and an account may be established for each customer organization to support multi-tenancy. For example, configuration data provided by an application designer for an application may be associated with the account of a customer organization for which the application is being developed. In this manner, resources may be shared across different customer organizations (e.g., to reduce cost and/or improve scalability). Furthermore, value-added features may be developed and selectively provided to customer organizations (e.g., based on different subscription tiers).

In some embodiments, the AMS may include a scheduling subject database area. The inventors have recognized and appreciated that some applications may perform scheduled and/or batched jobs. Accordingly, in some embodiments, a scheduler may be used by a runtime system to periodically look for jobs to execute (e.g., every second, . . . , every 5 seconds, . . . , every minute, . . . , every 20 minutes, . . . , every hour, . . . ). The scheduling subject database area may include one or more database tables storing a working calendar defined by an application designer (e.g., Monday through Friday from 8:00 am to 6:00 pm EST, except Independence Day, Thanksgiving, and Christmas).

In some embodiments, the AMS may include a versioning subject database area. The versioning subject database area may include one or more database tables for tracking changes made to an application over time.

In some embodiments, the AMS may include a storage server subject database area. The inventors have recognized and appreciated that some applications may be designed to support attachment and/or storage of files (e.g., a file received from, or to be sent to, an external source). The storage server subject database area may include one or more database tables for storing storage server data. Additionally, or alternatively, the storage server subject database area may include one or more database tables for storing storage server set data. The AMS may allow an application designer to specify a storage location (e.g., an FTP or SFTP server, cloud-based storage such as Amazon S3, etc.) and store that information in the storage server subject database area for use by a runtime system.

In some embodiments, the AMS may include a deployment term subject database area. The deployment term subject database area may include one or more database tables for storing information used by a runtime kernel, for example, to route workflow and/or handle security. In some embodiments, such information may be included as configuration data for an application, but may be provided by the AMS (as opposed to being configured by an application designer).

In some embodiments, the AMS may include a rule template subject database area. The rule template subject database area may include one or more database tables for storing templates for various types of rules, including, but not limited to, entry, exit, and/or function rules for cases, work items, screens, and/or transactions, attribute lose focus rules, MOT select rules, search result select rules, search rules, view result select rules, etc. The rule template subject database area may include a rule template library in which a rule version may be referenced and/or joined to a rule type. Additionally, or alternatively, the rule template subject database area may include a template logic subject database area, which may in turn include one or more database tables for storing template shape data and/or template expression part data (e.g., as discussed above in connection with FIGS. 19-24).

In some embodiments, the AMS may include a deployment logic subject database area. The deployment logic subject database area may include one or more database tables for storing deployment shape data and/or deployment expression part data (e.g., as discussed above in connection with FIGS. 19-24). The deployment shape data and/or deployment expression part data may be organized in a similar fashion as the template shape data and/or template expression part data stored in the template logic subject database area, but may be defined by an application designer (as opposed to being provided by the AMS).

In some embodiments, the AMS may include a term subject database area (also referred to as a term library). The term subject database area may include one or more database tables for storing data provided by an application designer. For example, the AMS may allow the application designer to define a data entity and specify the cardinality of the data entity, which may be zero-to-one, one-to-one, zero-to-many, one-to-many, or many-to-many. Additionally, the AMS may allow the application designer to define one or more attributes of the data entity (e.g., a valid value list or a set of related valid value lists).

In some embodiments, the term subject database area may store different types of terms. As one example, the term subject database area may store terms that represent data to be collected from an application user (e.g., single or multiple occurring pieces of data). As another example, the term subject database area may store composite terms, such as a join table representing a many-to-many relationship between two data entities. As another example, the term subject database area may store user interface terms. In some embodiments, an application user may be allowed to view and/or search data using a user interface term, but may not be allowed to modify the data. Such a view or search term may be logical. The term subject database area may store additional information that specifies how a composite or user interface term may be created and/or accessed.

In some embodiments, the AMS may include a valid value subject database area (also referred to as a valid value library). The valid value subject database area may include one or more database tables for storing valid value lists defined by an application designer (e.g., a gender list including three values, male, female, and other, a list of U.S. states and territories, etc.). A valid value list may be defined once and used in multiple terms, including terms in different applications.

In some embodiments, the AMS may include a structure subject database area (also referred to as a structure library). When an application designer defines a contract, offering, case, or work item (e.g., via a configuration interface provided by the AMS), a version of the contract, offering, case, or work item definition may be stored by the AMS as a contract, offering, case, or work item type. The structure subject database area may include one or more join tables joining one or more terms from the term library to the contract, offering, case, or work item type, where the one or more terms correspond to one or more attributes and/or valid value lists based on which the contract, offering, case, or work item type is defined.

In some embodiments, the AMS may include a contract subject database area (also referred to as a contract definition content pane). As discussed above, the inventors have recognized and appreciated that many organizational arrangements and/or processes are structurally similar and therefore can be modeled using one or more common structures (e.g., the illustrative organizational arrangement data structure 210 and the illustrative process data structure 220 shown in FIG. 2). The contract subject database area may include one or more database tables that represent the one or more common structures. For example, the database tables in the contract subject database area may join one or more structures from the structure library in a way that corresponds to the one or more common structures, while the structures from the structure library may represent data structures that are specific to a particular contract.

In some embodiments, the contract subject database area may include one or more database tables for storing information regarding contract screen layout. Such information may be provided by an application designer (e.g., as discussed above in connection with FIGS. 26-28).

In some embodiments, the AMS may include an environment subject database area (also referred to as an environment content pane). The environment subject database area may include one or more database tables for storing information regarding hardware and/or system software on which an application is run. The hardware may be physical and/or virtualized. The environment subject database area may also store information for tracking additions and/or removals of applications from an environment.

In some embodiments, the AMS may include an application subject database area (also referred to as an application content pane). The application subject database area may be used to provide a logical grouping of deployable applications (e.g., as web applications).

In some embodiments, the AMS may include a deployment subject database area (also referred to as an deployment content pane). A deployment may be a deployable application (e.g., a deployable web application in the form of a war file). In some embodiments, a deployment may include a default case, which may be created when an application user opens the deployment (e.g., in a web browser). In some embodiments, a deployment may include a list of one or more supported languages, as well as appropriate texts for each supported language (e.g., texts for labels, prompts, etc.). In some embodiments, a deployment may include one or more contract definitions that are created within the deployment. For example, a personal lines insurance policy administration system may include three contract definitions: a customer contract definition (e.g., according to a standard operating procedure for customer relationship management), an automobile contract definition (e.g., according to an auto insurance policy), and a home owner contract definition (e.g., according to a home owner's insurance policy). All contract definitions within the same deployment may be part of the same code base, share the same name space, and/or be run in the same virtual machine (e.g., a Java virtual machine).

In some embodiments, the AMS may include a deployment definition subject database area, which may be used to add contract definitions from the contract definition subject database area to a deployment. The added contract definitions may be specialized for the particular deployment. For example, final screen mockups may be made, final rules may be created, etc. prior to the deployment being installed on a server.

In some embodiments, two or more deployments may be bundled into one application and installed into a physical environment. This may be done, for example, when multiple deployments represent a set of desired functionalities. The deployments, although bundled, may have separate databases and/or web components.

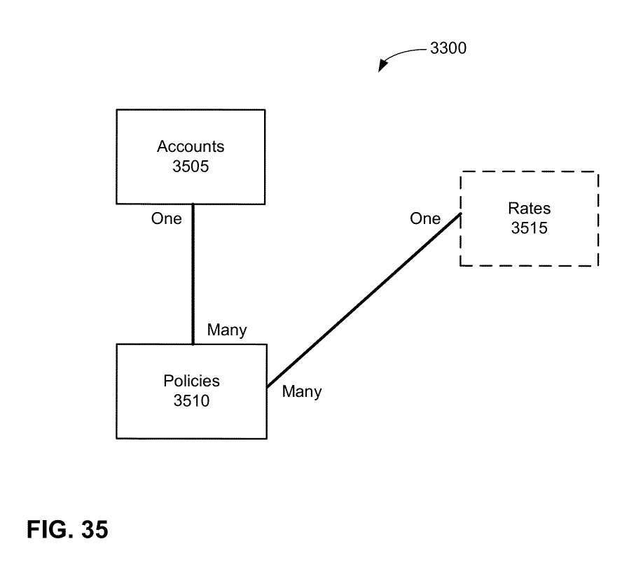

FIG. 35 shows an illustrative database 3500 having a data table for reference contracts, in accordance with some embodiments. In this example, the database 3500 includes three data tables: an accounts table 3505 in which each entry may correspond to a contract representing a customer account at an insurance company, a policies table 3510 in which each entry may correspond to a contract representing a policy issued by the insurance company, and a rates table 3515 in which each entry may correspond to a contract representing a rate for a particular type of policy. Each account in the accounts table 3505 may have multiple policies (e.g., home owner's, auto, life, etc.), so there may be a one-to-many relationship between the accounts table 3505 and the policies table 3510. Similarly, each rate in the rates table 3515 may be applicable to multiple policies (e.g., different customers holding the same type of policy), so there may be a one-to-many relationship between the rates table 3515 and the policies table 3510.

The inventors have recognized and appreciated that volatile data such as insurance rates may be used throughout an organization, but only a small number of individuals within an organization may be authorized to modified the volatile data. In some embodiments, to avoid unauthorized modification of volatile data, a local copy may be created whenever the volatile data is needed by an instance of a process. For example, whenever a customer service representative opens a case for creating a new policy, up-to-date rate data may be retrieved from a read-only repository and a new contract may be created to temporarily store the retrieved rate data.

The inventors have recognized and appreciated some disadvantages of the above-described approach. For instance, local copies of volatile data may need to be updated frequently, either by periodically checking for changes and retrieving any updated data, or by pushing updated data out whenever changes are made. These update operations may consume significant resources such as processor cycles, memory accesses, network bandwidth, etc., especially when a large number of instances of the process are running simultaneously (e.g., multiple customer service representatives creating new policies). Moreover, the local copies may take up a significant amount of memory space.

Accordingly, in some embodiments, volatile data may be stored in a contract designated as having a “reference” type. Data stored in such a contract may be modified via a designated process (e.g., by opening a maintenance case). For instance, in the example shown in FIG. 35, contracts in the rates table 3515 may be reference contracts. A case opened for a policy (e.g., creating or maintaining the policy) may be permitted to access the reference contracts in the rates table 3515, but may not be permitted to make any modification. By contrast, a case opened for a policy may be permitted to modify a corresponding account in the accounts table 350. For instance, a customer service representative creating a new policy for an existing customer may discover that the customer has a new home address and may update the home address in the customer's account.

In some embodiments, a reference contract may be accessed by multiple instances of a process, thereby eliminating the need to store multiple local copies. Moreover, accessing a reference contract may be more efficient than accessing a read-only repository. For example, the latter may involve an application programming interface (API) call to the repository, whereas the former may involve simply looking up an entry in a data table.

In some embodiments, a “dirty” bit may be stored for a reference contract to indicate whether the reference contract is up-to-date. For instance, whenever a change is made in a read-only repository, a dirty bit for a corresponding reference contract may be set. Before using the reference contract, the dirty bit may be checked. If the dirty bit is set, then an update may be performed by accessing the read-only repository. Otherwise, it may be safe to use the reference contract. In this manner, the reference contact may be updated only as needed, thereby conserving resources such as processor cycles, memory accesses, network bandwidth, etc.

It should be appreciated that aspects of the present disclosure are not limited to the use of reference contracts in any particular context, or at all. For instance, in some embodiments, reference contracts may be used to store volatile data such as rates for mobile phone plans.

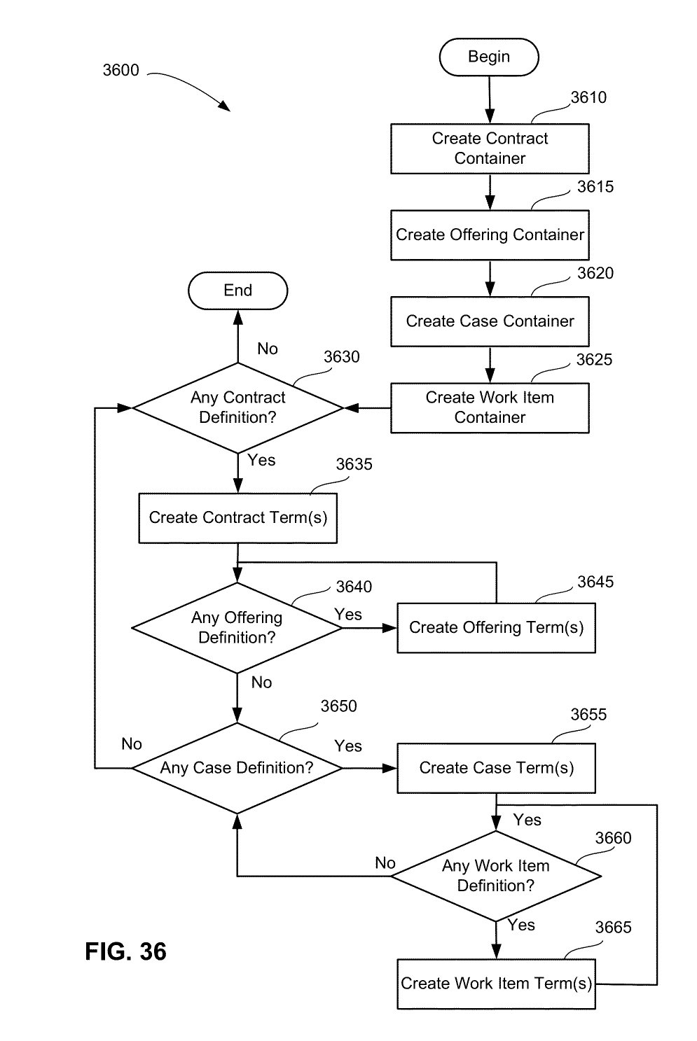

FIG. 36 shows an illustrative process 3600 that may be performed by a configuration system, in accordance with some embodiments. For instance, the process 3600 may be performed by the illustrative configuration system 100 to generate the one or more application databases 104, as shown in FIG. 1.

At act 3610, the configuration system may create a contract container table (e.g., the illustrative table 3010 shown in FIG. 30). An entry in the contract container table may correspond to a contract according to a contract definition specified by an application designer. In some embodiments, a contract in the contract container table may be a sub-contract of (or otherwise related to) another contract in the contract container table. Accordingly, the contract container table may be configured to allow one entry to refer to another entry.

At act 3615, the configuration system may create an offering container table (e.g., the illustrative table 3060 shown in FIG. 30). An entry in the offering container table may correspond to an offering according to an offering definition specified by an application designer and may point to a contract in the contract container table created at act 3610. In some embodiments, an offering in the offering container table may be a sub-offering of (or otherwise related to) another offering in the offering container table. Accordingly, the offering container table may be configured to allow one entry to refer to another entry.

At act 3620, the configuration system may create a case container table (e.g., the illustrative table 3210 shown in FIG. 32). An entry in the case container table may correspond to a case according to a case definition specified by an application designer and may point to a contract in the contract container table created at act 3610. In some embodiments, a case in the case container table may be a sub-case of (or otherwise related to) another case in the case container table. Accordingly, the case container table may be configured to allow one entry to refer to another entry.

At act 3625, the configuration system may create a work item container table (e.g., the illustrative table 3260 shown in FIG. 32). An entry in the work item container table may correspond to a work item according to a work item definition specified by an application designer and may point to a case in the case container table created at act 3615 and a contract in the contract container table created at act 3610. In some embodiments, a work item in the work item container table may be a sub-work item of (or otherwise related to) another work item in the work item container table. Accordingly, the work item container table may be configured to allow one entry to refer to another entry.

At act 3630, the configuration system may determine if there is a contract definition to be processed. If the configuration system determines that there is at least one contract definition to be processed, the configuration system may select a contract definition to be processed and proceed to act 3635 to create one or more contract terms (e.g., the illustrative contract term 2910 shown in FIG. 29) according to the selected contract definition. An entry in such a contract term may point to a contract in the contract container table created at act 3610 (e.g., via the illustrative link 30A shown in FIGS. 29-30).

At act 3640, the configuration system may determine if the selected contract definition includes any offering definition. If the configuration system determines that the selected contract definition includes at least one offering definition, the configuration system may select an offering definition and proceed to act 3645 to create one or more offering terms according to the selected offering definition. An entry in such an offering term may point to an offering in the offering container table created at act 3615.

Upon completing act 3645, the configuration system may return to act 3640 to determine if there is another offering definition to be processed. For instance, the selected contract definition may include another offering definition, or the selected offering definition may include a sub-offering definition. Acts 3640 and 3645 may be repeated until all offering definitions of the selected contract definition are processed, and then the configuration system may proceed to act 3650.

At act 3650, the configuration system may determine if the selected contract definition includes any case definition. If the configuration system determines that the selected contract definition includes at least one case definition, the configuration system may select a case definition and proceed to act 3655 to create one or more case terms (e.g., the illustrative case term 3110 shown in FIG. 31) according to the selected case definition. An entry in such a case term may point to a case in the case container table created at act 3620 (e.g., via the illustrative link 32A shown in FIGS. 31-32).

At act 3660, the configuration system may determine if the selected case definition includes any work item definition. If the configuration system determines that the selected case definition includes at least one work item definition, the configuration system may select a work item definition and proceed to act 3665 to create one or more work item terms according to the selected work item definition. An entry in such a work item term may point to a work item in the work item container table created at act 3625.

Upon completing act 3665, the configuration system may return to act 3660 to determine if there is another work item definition to be processed. For instance, the selected case definition may include another work item definition, or the selected work item definition may include a sub-work item definition. Acts 3660 and 3665 may be repeated until all work item definitions of the selected case definition are processed, and then the configuration system may return to act 3650 to determine if there is another case definition to be processed. For instance, the selected contract definition may include another case definition, or the selected case definition may include a sub-case definition. Acts 3650, 3655, 3660, and/or 3665 may be repeated until all case definitions of the selected contract definition are processed, and then the configuration system may return to act 3630.

At act 3630, the configuration system may determine if there is another contract definition to be processed. For instance, the application designer may have specified another contract definition, or the selected contract definition may include a sub-contract definition. Acts 3630, 3635, 3640, 3645, 3650, 3655, 3660, and/or 3665 may be repeated until all contract definitions specified by the application designer are processed, and then the process 3600 may end.

It should be appreciated that the process 3600 shown in FIG. 36 and described above are provided solely for purposes of illustration, as aspects of the present disclosure are not limited to any particular way of traversing the illustrative organizational arrangement data structure 210 and process data structure 220 shown in FIG. 2. For instance, in some embodiments, all contract terms may be created first, then all offering terms, then all case terms, and finally all work item terms.

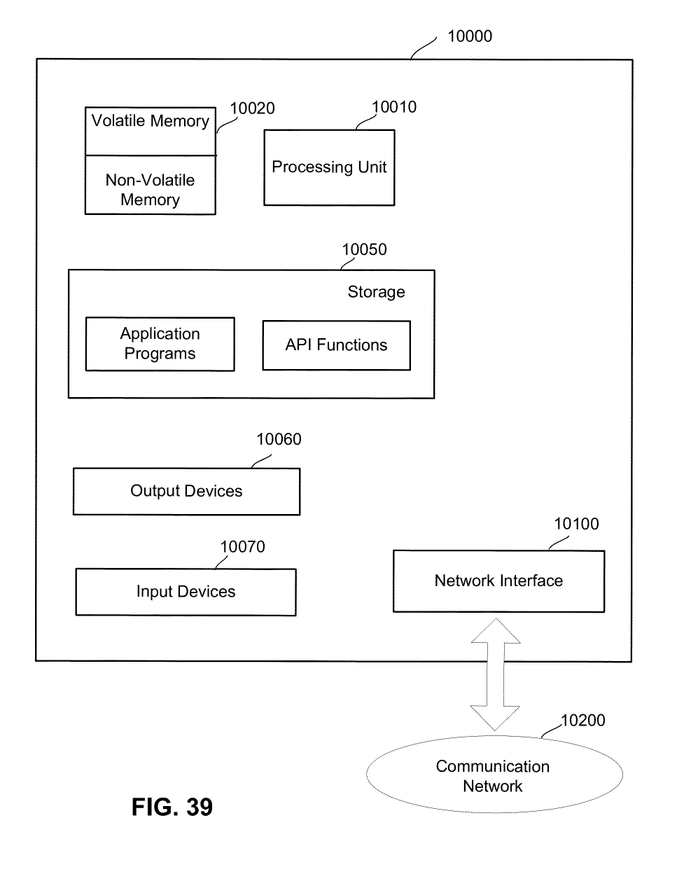

FIG. 39 shows, schematically, an illustrative computer 10000 on which any aspect of the present disclosure may be implemented. For example, the computer 10000 may be a client device from which an application designer or application user may access an AMS. The computer 10000 may also be used in implementing a server via which an AMS is delivered.

In the embodiment shown in FIG. 39, the computer 10000 includes a processing unit 10010 having one or more processors and a non-transitory computer-readable storage medium 10020 that may include, for example, volatile and/or non-volatile memory. The memory 10020 may store one or more instructions to program the processing unit 10010 to perform any of the functions described herein. The computer 10000 may also include other types of non-transitory computer-readable medium, such as storage 10050 (e.g., one or more disk drives) in addition to the system memory 10020. The storage 10050 may also store one or more application programs and/or resources used by application programs (e.g., software libraries), which may be loaded into the memory 10020.

The computer 10000 may have one or more input devices and/or output devices, such as devices 10060 and 10070 illustrated in FIG. 39. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards and pointing devices, such as mice, touch pads, and digitizing tablets. As another example, the input devices 10070 may include a microphone for capturing audio signals, and the output devices 10060 may include a display screen for visually rendering, and/or a speaker for audibly rendering, recognized text.

As shown in FIG. 39, the computer 10000 may also comprise one or more network interfaces (e.g., the network interface 10100) to enable communication via various networks (e.g., the network 10200). Examples of networks include a local area network or a wide area network, such as an enterprise network or the Internet. Such networks may be based on any suitable technology and may operate according to any suitable protocol and may include wireless networks, wired networks or fiber optic networks.

Having thus described several aspects of at least one embodiment, it is to be appreciated that various alterations, modifications, and improvements will readily occur to those skilled in the art. Such alterations, modifications, and improvements are intended to be within the spirit and scope of the present disclosure. Accordingly, the foregoing description and drawings are by way of example only.

The above-described embodiments of the present disclosure can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the concepts disclosed herein may be embodied as a non-transitory computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the present disclosure discussed above. The computer readable medium or media can be transportable, such that the program or programs stored thereon can be loaded onto one or more different computers or other processors to implement various aspects of the present disclosure as discussed above.

The terms “program” or “software” are used herein in a generic sense to refer to any type of computer code or set of computer-executable instructions that can be employed to program a computer or other processor to implement various aspects of the present disclosure as discussed above. Additionally, it should be appreciated that according to one aspect of this embodiment, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various features and aspects of the present disclosure may be used alone, in any combination of two or more, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the concepts disclosed herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

Some aspects of the present disclosure may be summarized as follows:

Aspect 1:

A method for generating a software application, the method comprising:
prompting a user to provide organizational arrangement data relating to a contract, wherein the organizational arrangement data comprises at least one first and at least one second contract term attribute for a contract term associated with the contract;
prompting the user to provide process data relating to a contract operation to be performed pursuant to the contract, the prompting comprising establishing a hierarchical structure, the hierarchical structure comprising [FIG. 3]:

a) at least one contract node (310), the contract node being associated with the provided organization arrangement data;

b) at least one first attribute node [cf. “b1”, “b2”], the at least one first attribute node being a child node of the contract node (310) and specifying the at least one first contract term attribute;

c) at least one second attribute node, the at least one second attribute node being a child node of the contract node (310) and specifying the at least one second contract term attribute;
automatically generating at least one database configured to store the organizational arrangement data provided by the user and a value to be captured for the contract term attributes, wherein the step of generating at least one database comprises [FIG. 3B]:

a) generating at least one contract table (355), the contract table having at least one column providing a unique identifier for each dataset stored in the contract table (355);

b) generating at least one first term table (380), the first term table having at least one column providing a unique identifier for each dataset stored in the first term table (380) and at least one attribute column for storing the first contract term attribute;

c) generating at least one second term table (385), the second term table having at least one column providing a unique identifier for each dataset stored in the second term table (385), at least one column for storing the second contract term attribute, and at least one column for storing a reference to a dataset of the first term table; and
automatically generating code for software to facilitate performance of the contract operation.

Aspect 2:

The method of aspect 1, wherein the first and the second term tables (380, 385) each comprise at least one column for storing a reference to a dataset of the contract table (355), the first and the second term tables being generated such that a foreign key can be stored therein.

Aspect 3:

The method of aspects 1 or 2, wherein the prompting comprises displaying a tree [FIG. 3], the tree having the nodes and being modified in response to the user's input.

Aspect 4:

The method of one of the proceeding aspects, wherein the at least one first and at least one second term tables (385) comprise at least one column for storing a reference to a dataset of the contract table (355).

Aspect 5:

The method of one of the proceeding aspects, wherein the user is prompted for a plurality of first and second contract term attributes, wherein for each first or second contract term attribute a separate term table (380, 385), in particular a separate first or second contract tem table (380, 385), is generated.

Aspect 6:

The method of one of the proceeding aspects, wherein the process data comprises:
a case definition specifying a case workflow for a case under the contract, the case workflow comprising at least one work item to be completed; and/or
a work item definition for the at least one work item to be completed, the work item definition specifying a manner in which a value is to be captured for the one contract term attributes.

Aspect 7:

The method of one of the proceeding aspects, in particular according to aspect 6, wherein
at least one case definition node (330), the case definition node being a child node of the contract node; and
at least one work item definition node (332), the work item definition node being a child node of the contract node

are added to the hierarchical structure in response to the user's input.

Aspect 8:

The method of one of the proceeding aspects, wherein the step of generating at least one database comprises [FIG. 3B, p. 18]:
generating at least one case table (365), the at least one case table (365) having at least one column providing a unique identifier for each dataset stored in the case table (365) and at least one column for storing a reference to a dataset of the contract table (355); and optionally
generating at least one work item table (370), the work item table (370) having at least one column providing a unique identifier for each dataset stored in the work item table (370) and at least one column for storing a reference to a dataset of the case table (365).

Aspect 9:

The method of one of the proceeding aspects, in particular according to aspect 8, wherein at least one generated table, in particular the contract table (355), the case table (365) and/or the work item table (370), comprise at least one column for storing a reference to a dataset of that table to allow self-referencing.

Aspect 10:

A method for generating a software application the method comprising:
prompting a user to provide contract data relating to a contract, wherein the contract data comprises at least one contract term attribute for a contract term associated with the contract;
prompting the user to provide process data relating to a contract operation to be performed pursuant to the contract, wherein the process data comprises:

a case definition specifying a case workflow for a case under the contract, the case workflow comprising at least one work item to be completed; and

a work item definition for the at least one work item to be completed, the work item definition specifying a manner in which a value is to be captured for the at least one contract term attribute;
automatically generating at least one database configured to store the contract data provided by the user and a value to be captured for the at least one contract term attribute, wherein the step of generating at least one database comprises [FIG. 3B]:

a) generating at least one contract table (355), the contract table having at least one column providing a unique identifier for each dataset stored in the contract table (385);

b) generating at least one case table (365), the at least one case table (365) having at least one column providing a unique identifier for each dataset stored in the case table (365) and at least one column for storing a reference to a dataset of the contract table (355); and optionally

c) generating at least one work item table (370), the work item table (370) having at least one column providing a unique identifier for each dataset stored in the work item table (370) and at least one column for storing a reference to a dataset of the case table (365),

wherein at least one generated table, in particular the contract table (355), comprise at least one column for storing a reference to a dataset of that table to allow self-referencing/self-linking.

Aspect 11:

The method of aspect 10, wherein an interface is displayed to the user providing a hierarchical structure, the hierarchical structure comprising [FIG. 3;]:
at least one contract node (310), the contract node being associated with the provided organization arrangement data; and/or
at least one case definition node (330), the case definition node being a child node of the contract node; and/or
at least one work item definition node (332), the work item definition node (332) being a child node of the contract node (310).

Aspect 12:

The method of aspect 11, wherein the interface allows the user to
provide contract data by adding at least one first contract node (310) as child node of at least one second contract node (310); and/or
specify the case workflow for the case under the contract by adding at least one first case node (330) as child node of at least one second case node (330); and/or
specify the case workflow for the case under the contract by adding at least one first work item definition node (332) as child node of at least one second work item definition node (332).

Aspect 13:

The method of aspect 12, wherein
to capture values for the at least one first and second contract nodes (310) one single contract table (355) is generated; and/or
to capture values for the at least one first and second case node (330) one single case table (365) is generated; and/or
to capture values for the least one first and second work item definition node (332) one single work item table (370) is generated.

Aspect 14:

At least one computer-readable medium having encoded thereon executable instructions that, when executed by at least one processor, cause the at least one processor to perform a method according to any of aspects 1-13.

Aspect 15:

A system comprising at least one processor and at least one computer-readable medium having encoded thereon executable instructions that, when executed by the at least one processor, cause the at least one processor to perform a method according to any of aspects 1-13.

What is claimed is:

1. A method for generating a software application, the method comprising:
prompting a first user to provide organizational arrangement data relating to a contract, wherein the organizational arrangement data comprises at least one contract term attribute for a contract term associated with the contract;
prompting the first user to provide process data relating to a contract operation to be performed pursuant to the contract, wherein the process data comprises:
a case definition specifying a case workflow for a case under the contract, the case workflow comprising at least one work item to be completed; and
a work item definition for the at least one work item to be completed, the work item definition specifying a manner in which a value is to be captured for the at least one contract term attribute;
automatically generating at least one database configured to store the organizational arrangement data provided by the first user and a value to be captured for the at least one contract term attribute; and
automatically generating code for software to facilitate performance of the contract operation, the software being adapted to:
present a user interface for the case workflow specified by the case definition, wherein the user interface is adapted to prompt a second user to provide a value for the at least one contract term attribute;
receive, via the user interface, a value for the at least one contract term attribute; and
store the value for the at least one contract term attribute in the at least one database.

2. The method of claim 1, wherein the user interface comprises a plurality of screens associated with the at least one work item, the plurality of screens comprising a first screen adapted to prompt the second user to provide a value for the at least one contract term attribute.

3. The method of claim 1, wherein the contract operation is selected from a group consisting of: a contract creation operation, a contract maintenance operation, and a contract fulfillment operation.

4. The method of claim 3, wherein the contract operation is a contract creation operation, and wherein the at least one work item is selected from a group consisting of: a quote work item, a risk assessment work item, a legal binding work item, and a contract issuing work item.

5. The method of claim 3, wherein the contract operation is a contract maintenance operation, and wherein the at least one work item is selected from a group consisting of: a monetary change work item, a non-monetary change work item, a cancellation work item, a reinstatement work item, a renewal work item, and an audit work item.

6. The method of claim 3, wherein the contract operation is a contract fulfillment operation, and wherein the at least one work item is selected from a group consisting of: a first notification work item, a file setup work item, an investigation work item, an adjudication work item, a dispute management work item, a subrogation work item, and an audit work item.

7. The method of claim 1, wherein the case definition further specifies at least one case entry rule, and wherein the software is further adapted to apply the at least one case entry rule upon creation of the case.

8. The method of claim 1, wherein the case definition further specifies at least one case on-exit rule, and wherein the software is further adapted to apply the at least one case exit rule upon completion of the case.

9. The method of claim 1, wherein the work item definition further specifies at least one work item entry rule, and wherein the software is further adapted to apply the at least one work item entry rule upon creation of the at least one work item.

10. The method of claim 1, wherein the case definition further specifies at least one work item exit rule, and wherein the software is further adapted to apply the at least one work item exit rule upon completion of the at least one work item.

11. The method of claim 1, wherein the contract comprises at least one offering, and wherein the organizational arrangement data comprises at least one offering term attribute for an offering term associated with the at least one offering.

12. The method of claim 1, wherein the case definition further comprises at least one case term and at least one case term attribute associated with the at least one case term.

13. The method of claim 1, wherein the case definition further comprises at least one work item term and at least one work item term attribute associated with the at least one work item term.

14. A method for generating a software application, the method comprising:
automatically generating at least one database configured to store organizational arrangement data relating to a contract, wherein the organizational arrangement data comprises at least one contract term attribute for a contract term associated with the contract, and wherein the at least one database is further configured to store a value to be obtained for the at least one contract term attribute; and
automatically generating code for software to facilitate performance of a contract operation pursuant to the contract, the software being adapted to:
present an application programming interface (API) for a case workflow, wherein:
the case workflow is specified by a case definition for a case under the contract; and
the case workflow comprises at least one work item to be completed;
engage in at least one transaction to obtain a value for the at least one contract term attribute, the at least one transaction being specified by a work item definition for the at least one work item;
receive, via the API, a value for the at least one contract term attribute; and
store the value for the at least one contract term attribute in the at least one database.

15. The method of claim 14, wherein the at least one transaction comprises an initial transaction adapted to execute one or more subsequent transactions to obtain a value for the at least one contract term attribute.

16. A method for generating a software application, the method comprising:
prompting, via a configuration user interface, an application designer to provide input according to a fractal structure, wherein the fractal structure comprises an organizational arrangement data structure and a process data structure, the organizational arrangement data structure comprising an organizational arrangement level, the process data structure comprising a case level, a work item level below the work item level, and a screen level below the work item level, and wherein the configuration user interface is programmed to prompt the application designer to define:
an organizational arrangement to be administered;
at least one organizational arrangement data table for storing data relating to the organizational arrangement;
at least one organizational arrangement attribute to be stored in the at least one organizational arrangement data table;
a case to be processed under the organizational arrangement;
at least one case data table for storing data relating to the;
at least one case attribute to be stored in the at least one case data table;
at least one case rule to be executed in association with the case;
at least one work item data table for storing data relating to a work item to be completed in association with the case;
at least one work item attribute to be stored in the at least one work item data table;
at least one work item rule to be executed in association with the work item;
at least one screen to be presented in association with the work item;
at least one screen rule to be executed in association with the screen; and
at least one access path for accessing, in association with the screen, the at least one organizational arrangement data table, the at least one case data table, or the at least one work item data table; and
in response to input received from the application designer via the configuration user interface, automatically generating:
at least one database for use by the software application, the at least one database comprising the at least one organizational arrangement data table, the at least one case data table, and the at least one work item data table;
code for the software application to support administration of the organizational arrangement, the software application being programmed to:
execute the at least one case rule, the at least one work item rule, and the at least one screen rule;
present the at least one screen to an application user;
capture at least one value from the application via the at least one screen; and
use the at least one access path to store the at least one value in the at least one organizational arrangement data table, the at least one case data table, or the at least one work item data table.

17. The method of claim 16, wherein:
the organizational arrangement is a first organizational arrangement;
the input received from the application designer comprises first input relating to a first organizational arrangement, the first input being provided by the application designer according to the fractal structure;
the input received from the application designer further comprises second input relating to a second organizational arrangement, the second input being provided by the application designer according to the same fractal structure; and
the method further comprises linking the second organizational arrangement to the first organizational arrangement, wherein the second organizational arrangement is linked as a child of the first organizational arrangement.

18. The method of claim 16, wherein:
the organizational arrangement data structure further comprises an offering level below the organizational arrangement level;
the configuration user interface is further programmed to prompt the application designer to define:
an offering within the organizational arrangement;
at least one offering data table for storing data relating to the offering; and
at least one offering attribute to be stored in the at least one offering data table;
the at least one database automatically generated for use by the software application comprises the at least one offering data table; and
the least one access path comprises an access path for accessing the at least one offering data table.
